(19) United States
(12) Patent Application Publication
(10) Pub. No.: US 2014/0060056 A1
(43) Pub. Date: Mar. 6, 2014

(54) Rotational Engine

(71) Applicant: JVF ENERGY LIBERATOR 3 LLC, Washington, MI (US)

(72) Inventor: Joseph Vincent Furnari, Washington, MI (US)

(73) Assignee: JVF ENERGY LIBERATOR 3 LLC, Washington, MI (US)

(21) Appl. No.: 13/631,615

(22) Filed: Sep. 28, 2012

Related U.S. Application Data
(63) Continuation-in-part of application No. PCT/US12/53712, filed on Sep. 4, 2012.

(51) Int. Cl. F02C 1/00

(52) U.S. Cl. 60/722

(57) ABSTRACT

The rotational engine assembly includes a housing defining a rotor interior. The housing defining an inlet and an outlet extending into the rotor interior. The housing further defining a vane cavity between the inlet and the outlet. A vane movably mounted to the housing to move into and out of the vane cavity. A crankshaft extending through the rotor interior. A rotor radially fixed to the crankshaft in the rotor interior. The rotor defining a working chamber in the rotor interior between the rotor and the housing. The rotor includes at least one thruster extending from the rotor surface transverse to the crankshaft and dividing the working chamber. A compressor in fluid communication with the inlet for supplying compressed air to be mixed with the fuel. An ignition source mounted to the housing and having access to the working chamber for igniting the compressed air fuel charge.

### FIELD OF INVENTION

The present invention relates to rotational engine for a vehicle.

### BACKGROUND

Various rotational engines are known in the industry for converting energy stored in fuel directly into rotational movement of the crankshaft. A high efficiency engine is preferred to convert the maximum energy in the fuel to rotational movement as possible. Reciprocating piston engines have a lower efficiency because the energy from the fuel must be transferred through two pivot points to be converted to useful rotation motion of the output crankshaft. As the cost of fuels rises, the demand for converting the maximum amount of energy stored in fuel increases. Therefore, there remains an opportunity to develop a rotational engine assembly with a design comprising multiple components which optimize the operation of the rotational engine assembly to convert energy stored in fuel into rotational movement of the output crankshaft.

### SUMMARY OF THE INVENTION AND ADVANTAGES

The present invention provides for a rotational engine for converting energy in fuel into movement. The rotational engine includes a housing having a housing wall defining a rotor interior, an inlet in fluid communication with the rotor interior, an outlet in fluid communication with the rotor interior and spaced from the inlet, and a vane cavity extending into the rotor interior between the inlet and the outlet. The rotational engine includes a vane movably mounted to the housing to selectively move into and out of the vane cavity. The rotational engine includes a crankshaft disposed in the housing and extending through the rotor interior with the crankshaft defining a central axis. The rotational engine includes a rotor radially fixed to the crankshaft in the rotor interior and having a rotor surface with the rotor and the crankshaft being rotatable as a unit about the central axis. The rotor defining a working chamber in the rotor interior between the rotor surface and the housing wall. The rotational engine includes at least one thruster extending from the rotor transverse to the central axis with the thruster dividing the working chamber. The rotational engine includes a compressor in fluid communication with the inlet for supplying compressed air to be mixed with the fuel. The rotational engine includes an ignition source mounted to the housing and having access to the working chamber for igniting the compressed air fuel charge. The rotational engine includes a thruster valve movably mounted to the thruster to selectively move between a first position abutting the housing wall for lubricating the housing wall and a second position spaced from the housing wall.

Another embodiment of the rotational engine includes at least one vane valve movably mounted to the vane to selectively move between an open position abutting the rotor surface for lubricating the rotor surface and a closed position spaced from the rotor surface. It is to be appreciated that there can be more than one ignition source extending into the working chamber for igniting the compressed air fuel charge.

Another embodiment of the rotational engine includes a hydraulic lock at least partially mounted to the housing with the hydraulic lock including a piston chamber and a piston with the piston disposed in the piston chamber and movable between a locked position with the vane retained in the vane cavity relative to the rotor and an unlocked position with the vane movable into and out of the vane cavity.

Another embodiment of the rotational engine includes a thruster seal having a first seal portion movably mounted to the thruster and a second seal portion movably mounted to the thruster and interfacing with the first seal portion, with the first seal portion and the second seal portion configured to move relative to each other to abut the housing wall 166 and divide the working chamber.

Another embodiment of the rotational engine includes a vane compression seal having a primary seal portion movably mounted to the vane and a secondary seal portion movably mounted to the vane and interfacing with the primary seal portion, with the primary seal portion and the secondary seal portion configured to move relative to each other to abut the rotor surface and divide the working chamber.

Another embodiment of the rotational engine includes a rotor seal having an upper seal portion movably mounted to the housing and a lower seal portion movably mounted to the housing and interfacing with the upper seal portion, with the upper seal portion and the lower seal portion configured to move relative to each other to abut the rotor and seal between the housing wall and the rotor.

### BRIEF DESCRIPTION OF THE DRAWINGS

Advantages of the present disclosure will be readily appreciated, as the same becomes better understood by reference to the following detailed description when considered in connection with the accompanying drawings:

FIG. 1 is a fragmented perspective view of a rotational engine assembly.

FIG. 2 is a fragmented top view of the rotational engine assembly.

FIG. 3 is a fragmented view of the housing illustrating a transfer channel.

FIG. 4 is another fragmented view of the housing illustrating the transfer channel.

FIG. 5 is a cross-sectional view of the housing.

FIG. 6 is a perspective view of an upper housing.

FIG. 7 is a planar view of a lower housing.

FIG. 8 is a fragmented view of the housing illustrating a rotor.

FIG. 9 is a perspective view of a bearing block.

FIG. 10 is another perspective view of the bearing block.

FIG. 11 is a fragmented perspective view of the bearing block mounted to the housing.

FIG. 12 is another fragmented perspective view of the bearing block mounted to the housing.

FIG. 13 is a fragmented view of the housing illustrating rotor seals.

FIG. 14 is a fragmented perspective view of the rotor seals mounted within the housing.

FIG. 15 is a fragmented view of a thruster.

FIGS. 16-19 are a fragmented partially cross-sectional views a thruster valve.

FIG. 20 is a fragmented perspective view of two thrusters.

FIG. 21 is a fragmented view of the thrusters.

FIG. 22 is a fragmented partially cross-sectional view of thruster compression seals.

FIG. 23 is another fragmented partially cross-sectional view of thruster compression seals.

FIG. 24-26 are a fragmented views of the thruster compression seals abutting a housing wall.

FIG. 27 is a fragmented view of the thruster compression seal.

FIG. 28 is a fragmented cross-sectional view of the thruster compression seal.

FIG. 29 is a fragmented view of the thruster.

FIG. 30 is a fragmented perspective view of the thruster compression seal chamber.

FIG. 31 is a plan view of the thruster lubricant seals.

FIG. 32 is a fragmented view of the thruster lubricant seals.

FIG. 33 is a fragmented cross-sectional view of the thruster lubricant seals illustrating grooves.

FIG. 34 is a fragmented cross-sectional view of the thruster lubricant seals illustrating channels.

FIG. 35 is a fragmented view of the thruster lubricant seal.

FIG. 36 is a fragmented cross-sectional view of the thruster lubricant seal.

FIG. 37 is a fragmented perspective view of the thruster lubricant seal chamber.

FIGS. 38-39 are a fragmented views of the housing illustrating a vane chamber.

FIG. 40 is a fragmented view illustrating compression seals.

FIG. 41 is a perspective view illustrating the compressions seals.

FIG. 42 is a fragmented view of a guide pin chamber of the housing.

FIG. 43 is a perspective view of a lubricant seal.

FIGS. 44-45 are fragmented views of the housing illustrating bearing assemblies.

FIG. 46 is a perspective view of the vane.

FIGS. 47-48 are fragmented views of a camshaft lifter movably mounted to the housing.

FIG. 49 is a partially cross-sectional plan view of the vane.

FIG. 50 is a fragmented view of the vane illustrating vane lubricant supply channels.

FIGS. 51-52 are fragmented views of a hydraulic lock.

FIGS. 53-54 are fragmented partially cross-sectional views of the housing defining a piston chamber wall.

FIG. 55 is a perspective view of a cover plate.

FIGS. 56-57 are cross-sectional views of the cover plate.

FIG. 58 is a fragmented view of the vane having a vane compression seal.

FIG. 59 is a plan view of the vane and the vane compression seal.

FIG. 60 is another view of the vane and vane compression seal.

FIG. 61 is a perspective view of the primary seal portion of the vane compression seal.

FIG. 62 is a fragmented perspective view of the secondary seal portion of the vane compression seal.

FIG. 63 is a fragmented partially cross-sectional view of a trailing seal in the vane compression seal chamber.

FIG. 64 is a bottom view of the vane compression seal and the trailing seal.

FIG. 65 is another view of the trailing seal.

FIG. 66 is a fragmented perspective view of the vane compression seal abutting the rotor.

FIG. 67 is a fragmented partially cross-sectional view of the vane compression seal.

FIG. 68 is a plan view of the vane lubricant seal.

FIG. 69 is a perspective view of the vane compression seal.

FIG. 70 is a partially cross-sectional view of the vane illustrating valve chambers.

FIG. 71 is a partially cross-sectional view of a vane valve.

FIG. 72 is an enlarged end portion of the vane valve.

FIG. 73 is a partially cross-sectional view of the vane valve in a closed position.

FIG. 74 is a cross-sectional view of the vane valve.

FIG. 75 is a fragmented partially cross-sectional view of the vane with lubricant pressure regulators.

FIG. 76 is a fragmented view of the vane.

FIG. 77 is a fragmented view of the vane lubricant seal.

FIG. 78 is a partially cross-sectional view of the vane exhaust seal.

FIG. 79 is a plan view of the vane exhaust seal.

FIG. 80 is a perspective view of the vane exhaust seal.

FIG. 81 is a fragmented partially cross-sectional view of a rotor seal.

FIG. 82 is a plan view of the rotor seal.

FIGS. 83-84 are an enlarged portions of the rotor seal.

FIG. 85 is another plan view of the rotor seal.

FIG. 86 is a side view of a rail pad.

FIG. 87 is a perspective view of the rail pad.

FIG. 88 is a partially cross-sectional view of the vane chamber.

FIGS. 89-91 are fragmented views of a portion of the rotor seals.

FIG. 92 is a fragmented perspective view illustrating a pair of rotor seals.

FIG. 93 is a fragmented partially cross-sectional view of the housing illustrating rotor seal guide pins.

FIG. 94 is a fragmented view of rotor seal lock dampers.

FIG. 95 is a partially cross-sectional view of the rotor seal lock dampers.

FIG. 96 is a fragmented view of the housing.

FIG. 97 is a partially cross-sectional view of inner lubricant seals.

FIG. 98 is a perspective view of the inner lubricant seal.

FIG. 99 is an enlarged view of a portion of the inner lubricant seal.

FIG. 100 is a plan view of the inner lubricant seal.

FIGS. 101-102 are enlarged views of a portion of the inner lubricant seal illustrating a retention structure,

FIGS. 103-104 are partially cross-sectional perspective views of the housing having slots for engagement with retention structures.

FIG. 105 is a fragmented partially cross-sectional view of the housing and rotor.

FIG. 106 is a fragmented partially cross-sectional view of the housing, rotor, thruster valve and vane valve.

### DETAILED DESCRIPTION OF THE INVENTION

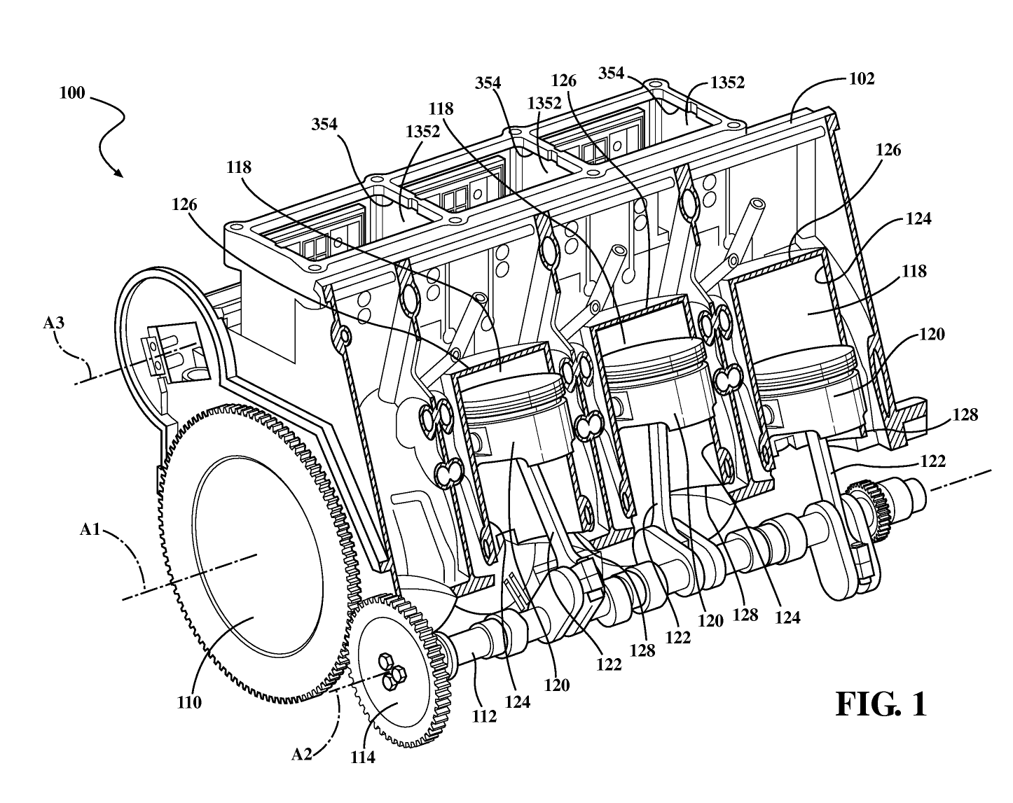

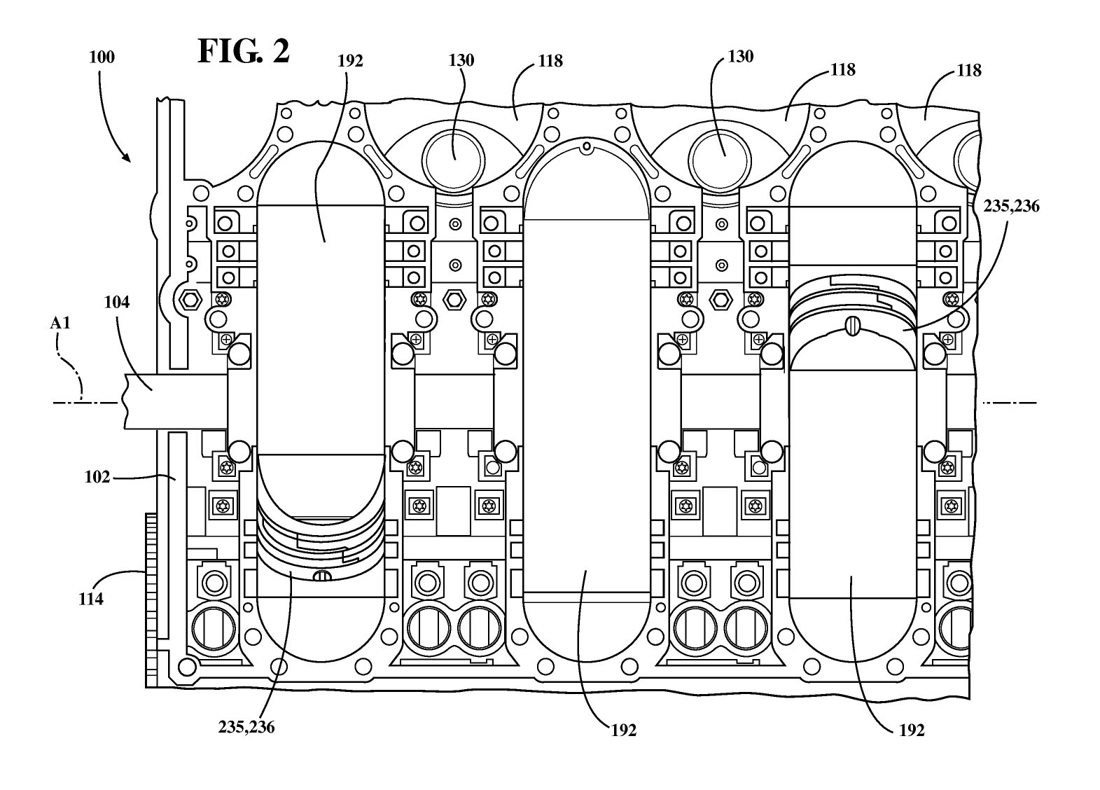

Referring to the Figures wherein like numerals indicate like or corresponding parts throughout the several views, a rotational engine assembly 100 for converting energy in fuel into rotational movement as generally shown in FIGS. 1-2. The rotational engine assembly 100 includes a housing 102 and a crankshaft 104. The housing 102 defines a plurality of housing lubricant supply channels (not shown) and a plurality of housing lubricant drain channels (not shown) in fluid communication with various components of the rotational engine assembly. The crankshaft 104 is disposed in and extends through the housing 102 with the crankshaft 104 defining a central axis A1. The crankshaft 104 has a main gear 110 radially fixed to the crankshaft 104 about the central axis A1.

The rotational engine assembly 100 includes a compressor crankshaft 112 disposed in the housing 102 and defining a compressor axis A2. The compressor crankshaft 112 has a compressor gear 114 radially fixed to the compressor crankshaft 112 about the compressor axis A2. The teeth of the compressor gear 114 are disposed in and abut the teeth of the main gear 110. The rotational engine assembly 100 further includes a camshaft 116 disposed in the housing 102 and defining a camshaft axis A3. The camshaft 116 has a camshaft gear (not shown) radially fixed to the camshaft 116 about the camshaft axis A3. The teeth of the camshaft gear are disposed in and abut the teeth of the main gear 110.

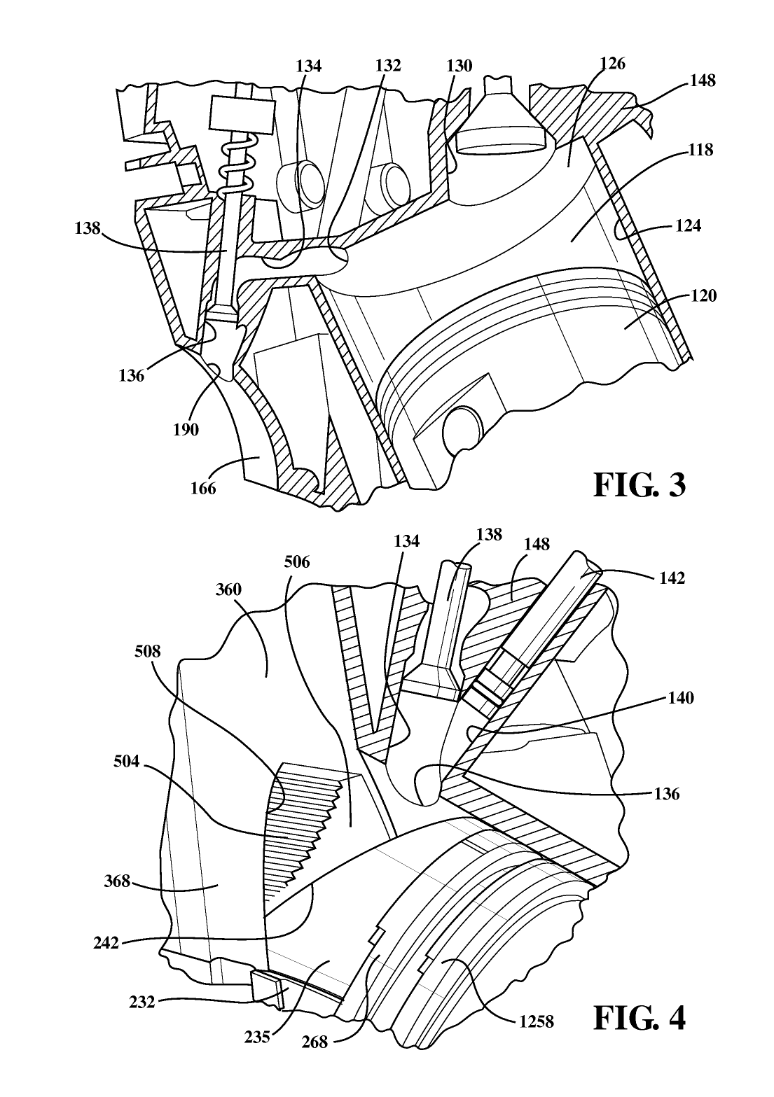

The rotational engine assembly 100 includes a compressor 118 having a compressor piston 120 and a compressor pushrod 122. The housing 102 defines a compressor cylinder 124 with a top end 126 and a bottom end 128. Turning to FIG. 3, the housing 102 further defines a compressor inlet 130 and a compressor outlet 132 both in fluid communication with the compressor cylinder 124. The compressor pushrod 122 is pivotably coupled to the compressor piston 120 and the compressor crankshaft 112. The compressor piston 120 is movably disposed in the compressor cylinder 124 being capable to move between the top end 126 and the bottom end 128. However, it is to be appreciated that the compressor 118 may be of any suitable type for compressing a fluid such as, but not limited to, other reciprocating types, rotary screw types, and rotary centrifugal types.

As best shown in FIGS. 3-4, the housing 102 defines a transfer channel 134 in fluid communication with the compressor outlet 132. The housing 102 further defines a transfer outlet 136. The rotational engine assembly 100 includes a transfer valve 138 disposed in the transfer outlet 188 and movably mounted to the housing 102. The transfer valve 138 is capable of moving into and from the transfer outlet 136 to open and close the transfer outlet 136.

The housing 102 defines an injector channel 140 extending into the transfer channel 134 and in fluid communication with the transfer channel 134. The rotational engine assembly 100 includes an injector 142 disposed in the injector channel 140 and mounted to the housing 102. It is to be appreciated that the injector 142 maybe any suitable type compatible with any suitable fuel type to be used in the rotational engine assembly 100.

The housing 102 further defines an ignition source channel 144. The rotational engine assembly 100 includes an ignition source disposed in the ignition source channel 144 and mounted to the housing 102. It is to be appreciated that the ignition source may be of any suitable type compatible with any suitable fuel type to be used in the rotational engine assembly. However, it is to be appreciated that there can be more than one ignition source extending into the working chamber for igniting the compressed air fuel charge.

Referring to FIGS. 1-4, as the rotational engine assembly 100 operates, the crankshaft 104 facilitates rotation of the main gear 110. The main gear 110 facilitates rotation of the compressor gear 114 and the camshaft gear. The compressor gear 114 facilitates rotation of the compressor crankshaft 112 about the compressor axis A2. The compressor crankshaft 112 facilitates movement of the compressor piston 120 along the compressor cylinder 124 between the top end 126 and the bottom end 128. As the compressor piston 120 moves from the top end 126 to the bottom end 128, the compressor inlet 130 is opened and air is drawn into the compressor cylinder 124. As the compressor piston 120 moves from the bottom end 128 to the top end 126, the compressor inlet 130 is closed and the air is compressed in the compressor cylinder 124 and the transfer channel 134. As the compressor piston 120 approaches the top end 126 of the compressor cylinder 124, the compressed air remains in the compressor cylinder 124 and transfer channel 134. As the transfer valve 138 is opened, the compressed air flows through the transfer valve 138 and the injector 142 sprays fuel into the compressed air to create a fuel/air mixture. However, it is to be appreciated that the fuel source may be of any suitable type for converting energy into rotational movement such as but not limited to gasoline, diesel, bio-diesel, or ethanol.

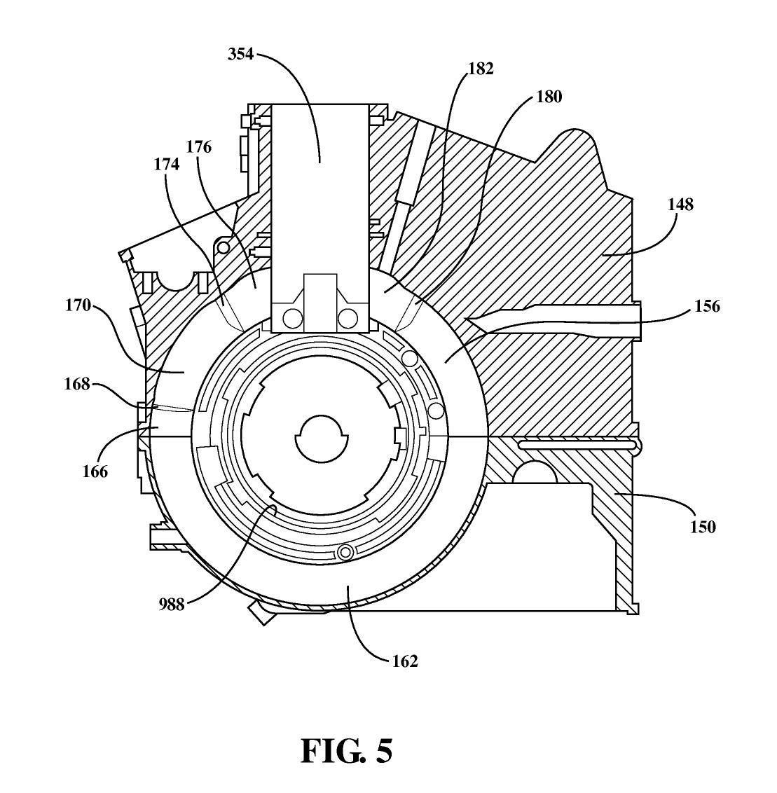

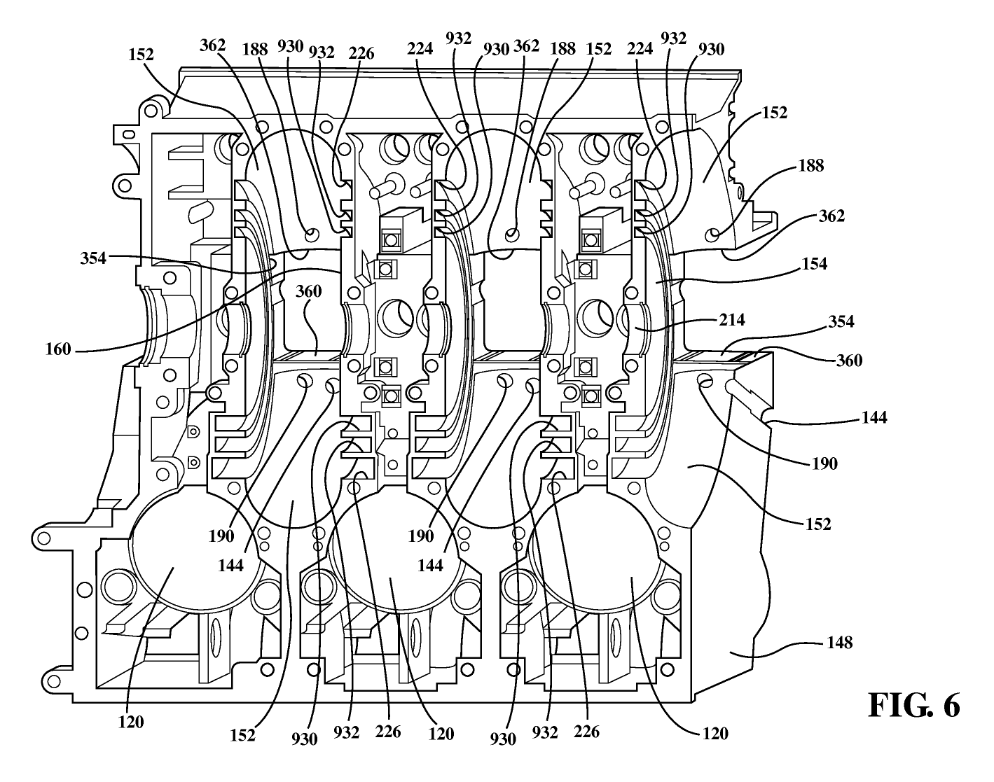

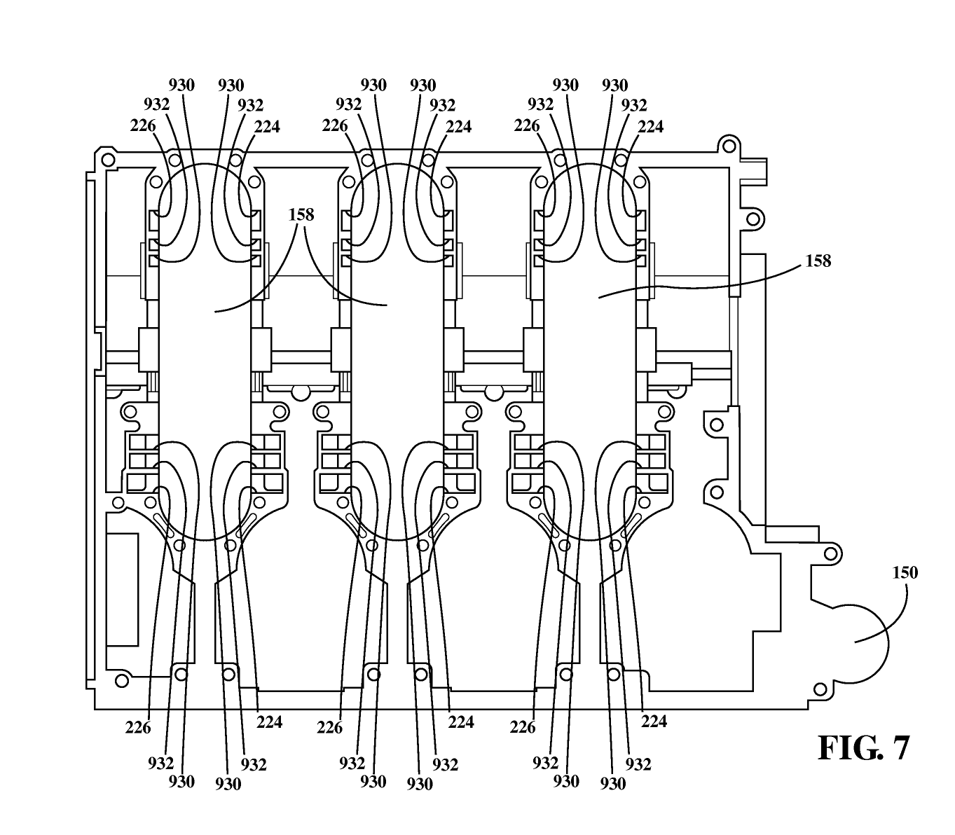

As best shown in FIG. 5, the housing 102 includes an upper housing 148 and a lower housing 150. Turning to FIG. 6, the upper housing 148 has an upper groove surface 152 and a first housing surface 154 defining an upper cavity 156. Referring further to FIG. 7, the lower housing 150 has a lower groove surface 158 and a second housing surface 160 defining a lower cavity 162. Turning back to FIG. 5, as the upper housing 148 abuts the lower housing 150, the upper cavity 156 aligns with the lower cavity 162 and defines a rotor interior 164. The upper groove surface 152 and the lower groove surface 158 align to form a housing wall 166.

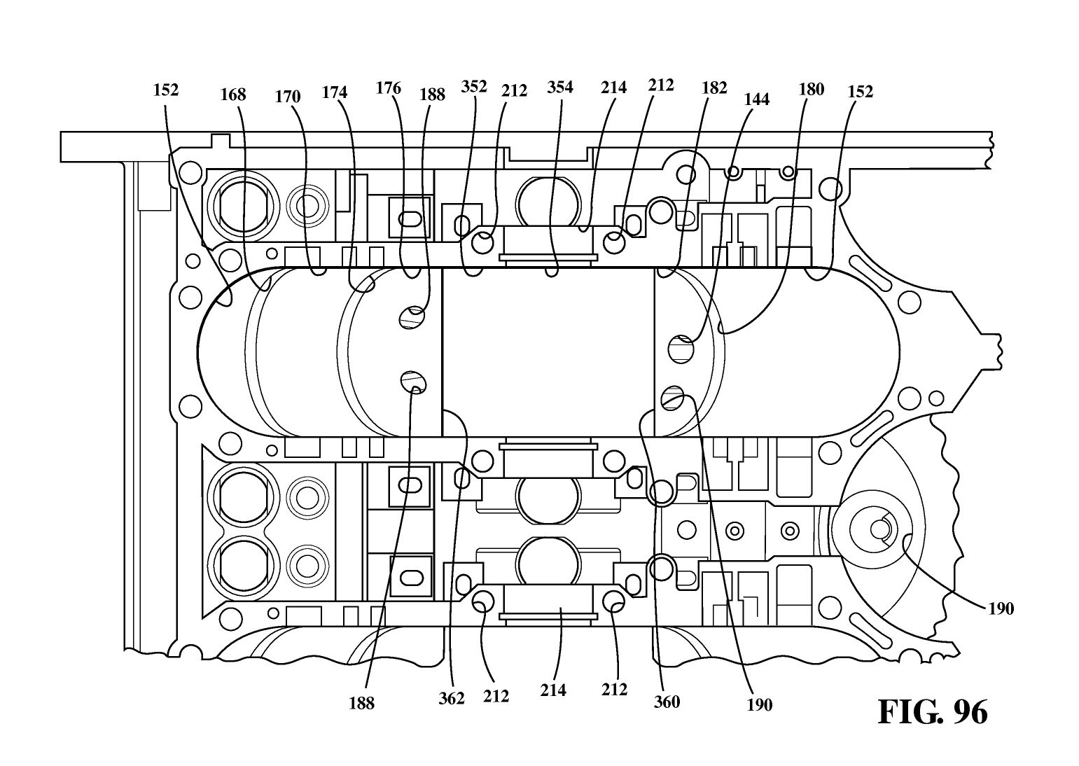

As best shown in FIGS. 5 and 96, the upper housing 148 includes a first incline surface 168 and a lubricant wipe surface 170 defining a first depression 172 extending through the housing wall 166 and into the rotor interior 164. The first incline surface 168 is disposed between the housing wall 166 and the lubricant wipe surface 170. The lubricant wipe surface 170 is spaced further from the central axis A1 than the housing wall 166.

The upper housing 148 includes a second incline surface 174 and an exhaust surface 176 defining a second depression 178 extending through the housing wall 166 and into the rotor interior 164. The second incline surface 174 is disposed between the lubricant wipe surface 170 and the exhaust surface 176. The exhaust surface 176 is spaced further from the central axis A1 than the housing wall 166 and the lubricant wipe surface 170.

The upper housing 148 includes a decline surface 180 and a combustion surface 182 defining a third depression 184 extending through the housing wall 166 and into the rotor interior 164. The decline surface 180 is disposed between the combustion surface 182 and the housing wall 166. The combustion surface 182 is spaced further from the central axis A1 than the housing wall 166. The upper housing 148 is concentric such that the second depression 178 mirrors the third depression 184. The upper housing 148 further defines a vane cavity 186 between the exhaust surface 176 and the combustion surface 182.

As best shown in FIG. 6, the upper housing 148 defines an outlet 188 extending through the exhaust surface 176 in fluid communication with the rotor interior 164. The upper housing 148 additionally defines an inlet 200 extending through the combustion surface 182 in fluid communication with the rotor interior 164. The inlet 200 is further in fluid communication with the transfer channel 134.

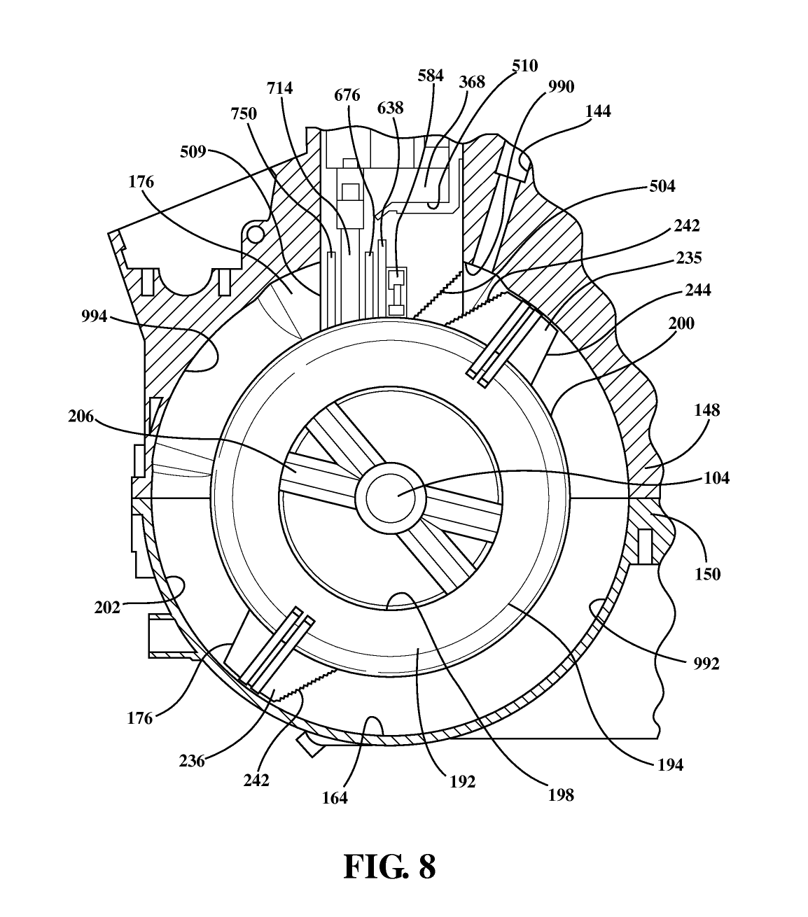

As best shown in FIG. 8, the rotational engine assembly 100 includes a rotor 192 movably disposed in the rotor interior 164. The rotor 192 has a primary surface 194 aligned with the first housing surface 154 of the housing 102 and a secondary surface (not shown) aligned with the second housing surface 160 of the housing 102. The rotor 192 further has an interior surface 196 defining a crank chamber 198. The rotor 192 additionally has a rotor surface 200 defining a working chamber 202 in the rotor interior 164 between the rotor surface 200 and the housing wall 166. The rotor 192 also defines a plurality of rotor lubricant channels for facilitating lubricant distribution to different features of the rotor 192.

The crankshaft 104 has an exterior surface and four connecting arms 206 extending from the exterior surface. The crankshaft 104 is disposed in the crank chamber 198 of the rotor 192 with the four connecting arms 206 of the crankshaft 104 fixed to the interior surface 196 of the rotor 192. The crankshaft 104 defines a plurality of crankshaft channels (not shown) along the crankshaft 104 and the four connecting arms 206. The rotor 192 and the crankshaft 104 rotate in the rotor interior 164 about the central axis A1 as a unit. However, it is to be appreciated that the crankshaft 104 may have any number of connecting arms 206 fixed to the rotor 192.

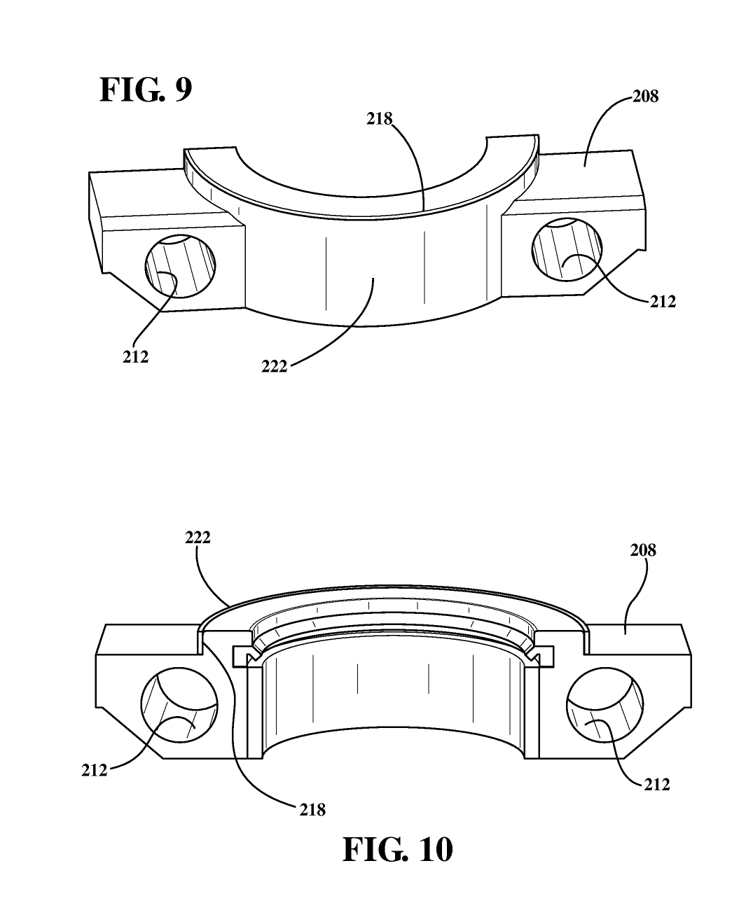

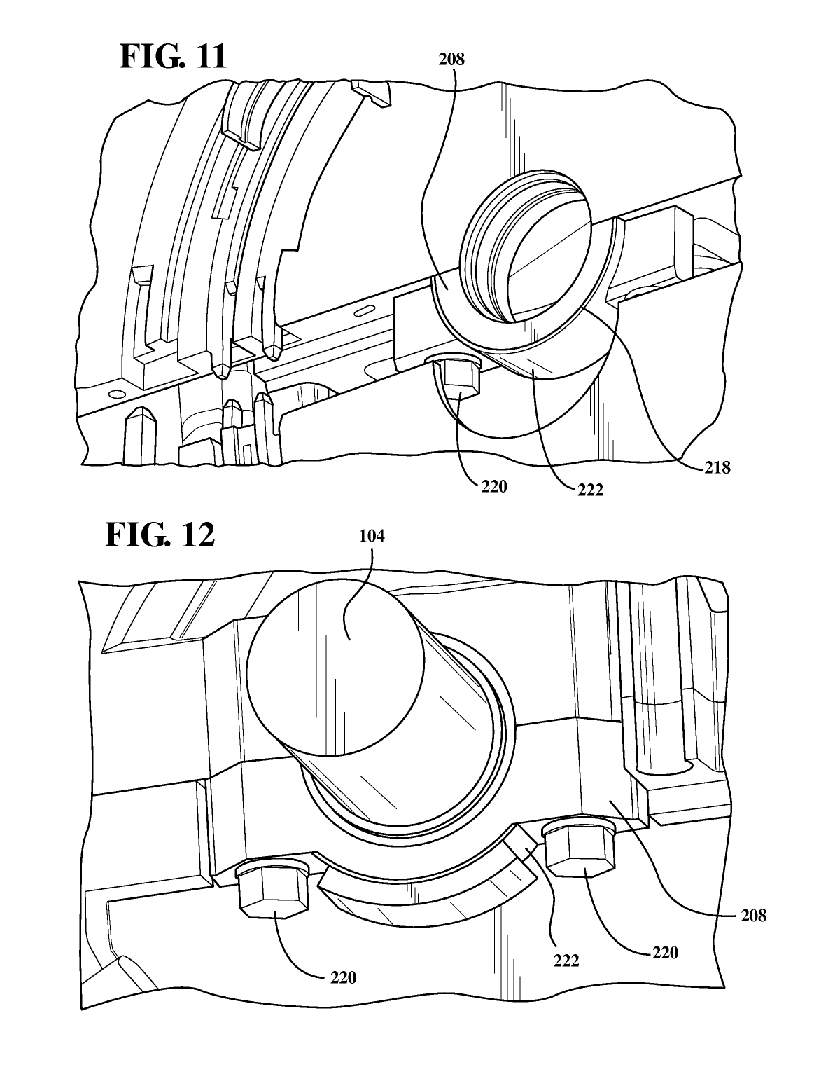

As best shown FIGS. 9-10, the rotational engine assembly 100 includes a bearing block 208 having an interior surface and defining two bolt holes 212. Turning to FIG. 6, the upper housing 148 defines a crankshaft channel 214 extending through the housing 102. The housing 102 further defines two threaded holes 216. Referring further to FIGS. 11-12, the crankshaft 104 is disposed in the crankshaft channel 214 such that a portion of the crankshaft 104 extends out of the crankshaft channel 214. A bearing block 208 is disposed over the portion crankshaft 104 extending out of the crankshaft channel 214. The two bolt holes 212 of the bearing block 208 are aligned with the two threaded holes 216 of the upper housing 148. The bearing block 208 is fastened to the upper housing 148 by two bolts 220 through the two bolt holes 212 of the bearing block 208 and the two threaded holes 216 of the housing 102. The interior surface of the bearing block 208 abuts the crankshaft 104 and facilitates rotational movement of the crankshaft 104 in the housing 102.

The bearing block 208 has an exterior surface 218. The bearing block 208 further has a metal mesh pad 222 and a foil layer with the foil layer disposed around the metal mesh pad 222. The metal mesh pad 222 and the foil layer are mounted to the exterior surface 218 of the bearing block. As the lower housing 150 is mated to the upper housing 148, the crankshaft channel 214 of the lower housing 150 abuts the metal mesh pad 222 and the foil layer (not shown) of the bearing block 208. The metal mesh pad 222 and foil layer of the bearing block 208 are compressed to form a seal between the lower housing 150 and the bearing block 208.

As best shown in FIGS. 5-6, the first housing surface 154 defines a first rotor seal chamber 224 and the second housing surface 160 defines a second rotor seal chamber 226. The first rotor seal chamber 224 and the second rotor seal chamber 226 oppose each other. The first rotor seal chamber 224 and the second rotor seal chamber 226 have a top surface 238 and a bottom surface 230.

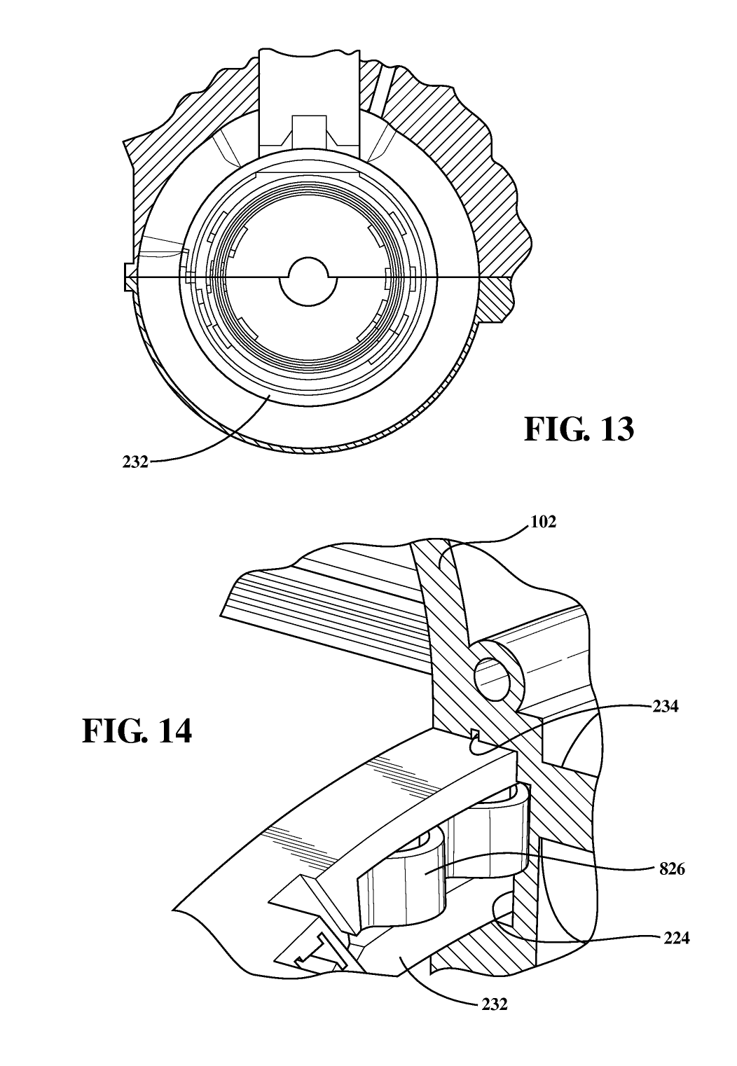

As best shown in FIG. 13-14, the rotational engine assembly 100 includes two rotor seals 232 with one of the rotor seals 232 disposed in the first rotor seal chamber 224 and the other of the rotor seals 232 disposed in the second rotor seal chamber 226. It should be appreciated that the rotor seals 232 will be discussed in further detail later in the detailed description of the invention.

Referring specifically to FIG. 14, the housing 102 defines a rotor seal lubricant channel 234 extending through the top surfaces 238 of the first rotor seal chamber 224 and the second rotor seal chamber 226. The rotor seal lubricant channels 234 are in fluid communication with one of the plurality of housing lubricant supply channels. The lubricant flows along the rotor seal lubricant channels 234 of the first rotor seal chamber 224 and the second rotor seal chamber 226 to lubricant the rotor seals 232.

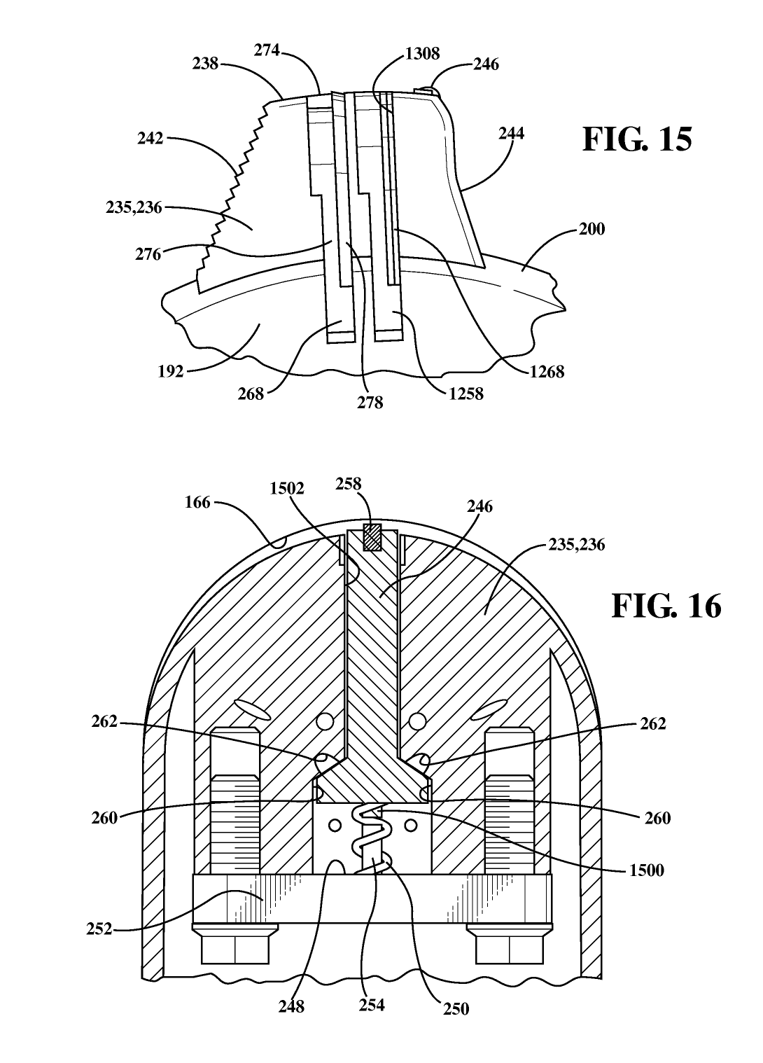

As best shown in FIGS. 8 and 15, the rotor 192 has a first thruster 235 and a second thruster 236 extending from the rotor surface 200 transverse to the central axis A1 and dividing the working chamber 202. The two thrusters 235, 236 have a top surface 238 with a corresponding configuration with the housing wall 166. A gap 240 is defined between the top surface 238 of the two thrusters 235, 236 and the housing wall 166 of the rotor interior 164.

The two thrusters 235, 236 further have a combustion surface 242 with a step configuration for creating turbulent air flow to improve the mixing of air and fuel. The two thrusters 235, 236 additionally have an exhaust surface 244 opposed from the combustion surface 242 and having an angled configuration. However, it is to be appreciated that the rotor 192 may have one thruster or any number of thrusters extending from the rotor surface 200.

Referring specifically to FIG. 15, the two thrusters 235, 236 define a rod chamber 1502 and have a thruster valve 246 disposed in the rod chamber 1502 and movably mounted to the two thrusters 235, 236 relative to the combustion surfaces 242 of the two thrusters 235, 236. The thruster valves 246 facilitate or prevent lubricant flow through the two thrusters 235, 236.

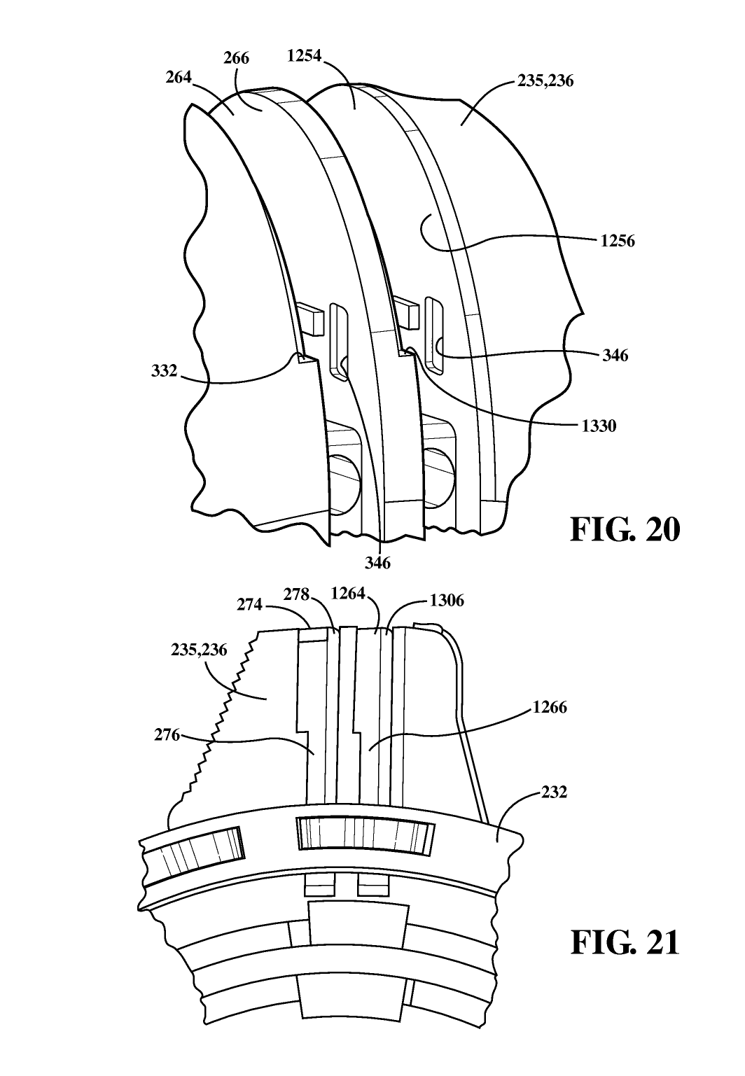

As shown in FIG. 20, the two thrusters 235, 236 have two thruster lubricant seal chamber surfaces 1254 defining a thruster lubricant seal chamber 256. Turning to FIG. 21, the two thrusters 235, 236 further have a thruster lubricant seal 1258 disposed in the thruster lubricant seal chambers 1256 and movably mounted to the two thrusters 235, 236 relative to the thruster valves 246.

As best shown in FIGS. 16-19, the two thrusters 235,236 define a rod cavity 248. The valve chamber 1502 and the thruster valve 246 extend into the rod cavity 248. The two thrusters 235, 236 further have a valve plate 252 and a valve rod 254 extending from the valve plate 252 into the rod cavity 248. The thruster valve 246 has a valve guide rod 1500 extending into the rod cavity 248 opposing the valve rod 254. The two thrusters additionally have a valve biasing member 250 disposed around the valve rod 254 and the valve guide rod 1500 in the rod cavity 248 to position the valve biasing member 250 in the rod cavity 248. The valve biasing member 250 abuts the valve plate 252 and the thruster valve 246 such that the thruster valve 246 is resiliently movable between a first position abutting the housing wall 166 and a second position spaced from the housing wall 166.

The two thrusters 235, 236 have a plurality angled surfaces partially defining the rod cavity 248. The thruster valve 246 has a base with two valve surfaces relative to the plurality angled surfaces of the rod cavity 248.

As best shown in FIG. 15, a plurality of thruster lubricant grooves 1308 are partially defined between the thruster 235, 236 and the thruster lubricant seal 1258. Turning to FIG. 32, the thruster lubricant seals 1258 have a lubricant surface 1306. The plurality of thruster lubricant grooves 1308 are further partially defined between the lubricant surface 1306 of the thruster lubricant seal 1258, the two thrusters 235, 236, the housing wall 166, and the rotor seals 232 as the thruster lubricant seals 1258 abut the housing wall 166 and the rotor seals 232. The plurality of thruster lubricant grooves 1308 extend about the peripheral cross-section of the thruster 235, 236 and rotor 192. The thruster lubricant grooves 1308 supply and remove lubricant to and from the thrusters 235, 236 and the rotor 192 relative to the surrounding housing wall 166 and rotor seal 232.

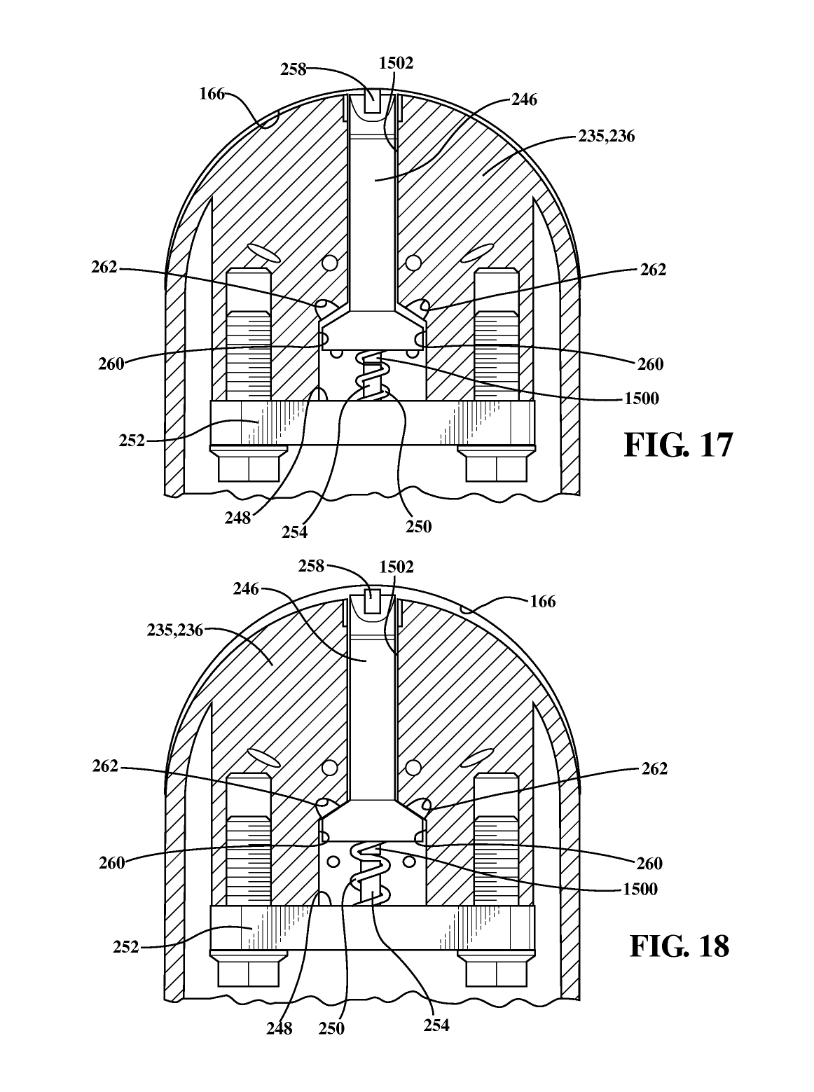

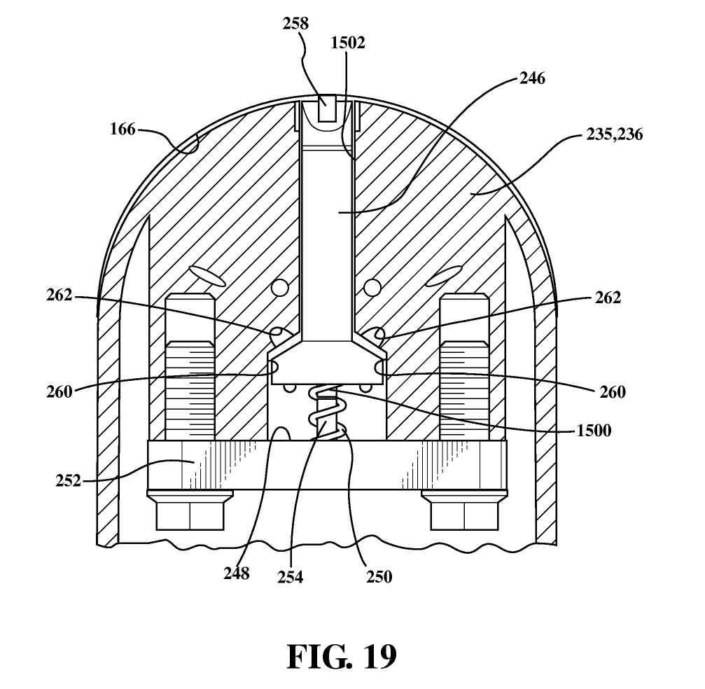

Turning to FIGS. 17 and 19, the thruster valve 246 is in the first position abutting the housing wall. The thruster valve 246 further has wall end a roller 258 movably mounted to the wall end. The roller 258 abuts and moves along the housing wall 166 as the thruster valve 246 is in the first position. The two thrusters 235, 236 define a plurality of thruster channels 260 and a plurality of valve passageways 262. More specifically, two thruster channels 260 are defined between the thrusters 235, 236 and the thruster valve 246 in the rod cavity 248 as the thruster valve 246 is in the first position. Moreover, the plurality of valve passageways 262 extend into the rod cavity 248 through the plurality of the angled surfaces. The two thruster channels 260 and the plurality of valve passageways 262 are capable of aligning in fluid communication as the thruster valves 246 are in the first position abutting the housing wall 166. The plurality of the valve passageways 262 are in further fluid communication with the plurality of thruster lubricant grooves 1308. The rod cavity 248 is in fluid communication with the plurality of thruster lubricant grooves 1308 through the two thruster channels 260 and the plurality of valve passageways 262. As the thruster valves 246 are abutting the housing wall 166, lubricant flows from the rod cavity 248 through the thruster channels 260 to the plurality valve passageways 262. The lubricant is dispersed about the two thrusters 235, 236 through the valve passageways 262 to the plurality of lubricant groove 1308.

As shown in FIGS. 16 and 18, the thruster valve 246 is in the second position spaced from the housing wall 166. The two valve surfaces of the thruster valve 246 abut the plurality angled surfaces of the thruster 235, 236, and block the plurality if valve passageways 262. The two thruster channels 260 and the plurality of valve passageways 262 are not aligned and the lubricant will not flow from the rod cavity 248 through the thruster channels 260 to the plurality valve passageways 262 and the plurality of thruster lubricant grooves 1308.

The thruster valves 246 abut the housing wall in the first position. The thruster valves 246 are initially in the first position and abut the first incline surface 168 as two thrusters 235, 236 rotate about the central axis A1 through the first depression 172. The first incline surface 168 angles away from the central axis A1 to the lubricant wipe surface 170. The thruster valves 246 are spaced from the lubricant wipe surface 170 and in the second position. The thruster valves 246 do not facilitate lubricant flow to the valve passageways 262 and the plurality of thruster lubricant grooves 1308 as the two thrusters 235, 236 rotate through the remainder of the first depression 172. The thruster valves 246 and the plurality of thruster lubricant grooves 1308 are in the second position and spaced from the second incline surface 174 and the exhaust surface 176 of the housing 102 as the two thrusters 235, 236 rotate about the central axis A1 through the second depression 178. The thruster valves 246 do not facilitate lubricant flow to the valve passageways 262 the plurality of thruster lubricant grooves 1308 to prevent lubricant from entering or accumulating in the outlet 188.

The thruster valves 246 remain in the second position as the two thrusters 235, 236 rotate about the central axis A1 through the vane cavity 186 and into the third depression 184. The thruster valves 246 are spaced from the combustion surface 182 of the housing 102 as the two thrusters 235, 236 rotate about the central axis A1 through the third depression 184. The thruster valves 246 do not facilitate lubricant flow to the valve passageways 262 and the plurality of thruster lubricant grooves 1308 to prevent lubricant from entering or accumulating in the transfer channel 134 or the ignition source channel 144.

The decline surface 180 angles towards the central axis A1 to the housing wall 166 to a point at which the thruster valves 246 abut the decline surface 180. The thruster valve 246 moves from the second position to the first position and facilitate lubricant flow to the valve passageways 262 and the plurality of thruster lubricant grooves 1308 as the two thrusters 235, 236 rotate along the housing wall 166.

As best shown in FIGS. 20-21, the two thrusters 235, 236 have two thruster compression seal chamber surfaces 264 defining a thruster compression seal chamber 266. The two thrusters 235, 236 further have a thruster compression seals 268 disposed in the thruster compression seal chambers 266 and movably mounted to the two thrusters 235, 236 relative to the thruster valve 246.

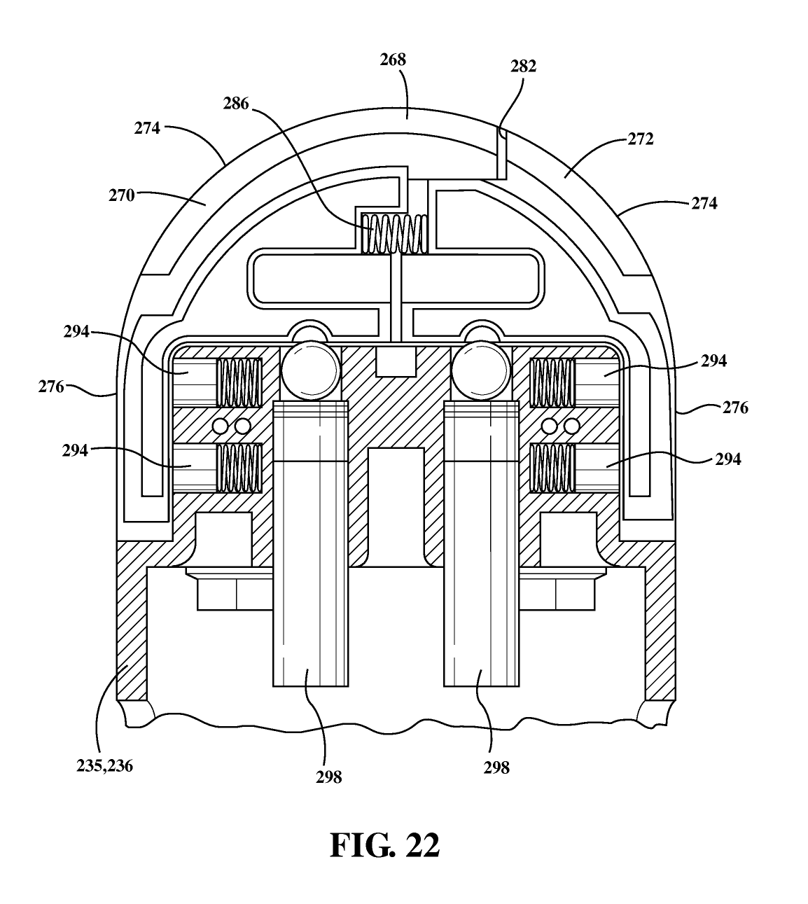

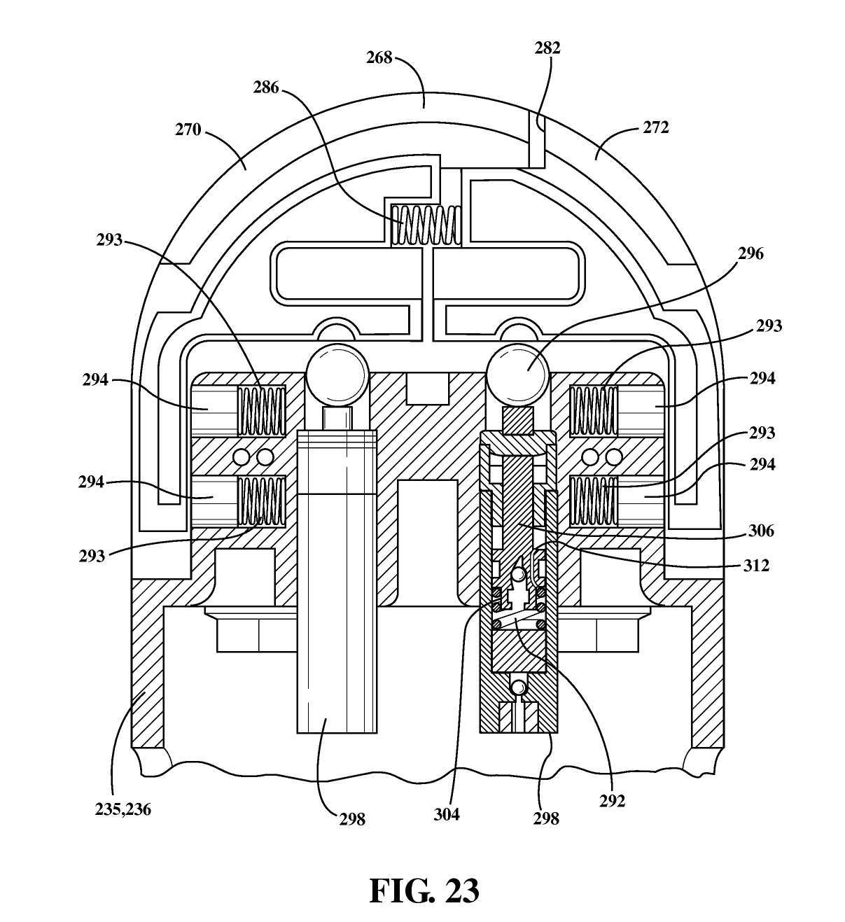

As best shown in FIGS. 22-23, the thruster compression seals 268 have a first seal portion 270 movably mounted to the two thrusters 235, 236 and a second seal portion 272 movably mounted to the two thrusters 235, 236 and interfacing with the first seal portion 270. The first seal portions 270 and the second seal portions 272 form a top surface 274 and two side surfaces 276. The top surfaces 274 and the two side surfaces 276 of the thruster compression seals 268 form a configuration corresponding with the housing wall 166. The top surfaces 274 and the two side surfaces 276 of the thruster compression seals 268 abut the housing wall 166 and the rotor seals 232 to form a continuous seal. Referring back to FIG. 21, the thruster compression seals 268 further have a tapered surface 278 corresponding with the decline surface 180 of housing 102. The tapered surfaces 278 of the thruster compression seals 268 abut the decline surface 180 as the two thruster thrusters 236 rotate along the decline surface 180 to form a continuous seal. The thruster compression seals 268 abut the housing wall 166 and the rotor seals 232 to prevent high pressure gases from bypassing the two thrusters 235, 236.

As best shown in FIG. 24, the thruster compression seals 268 abut the housing wall 166. The thruster compression seals 268 initially abut the first incline surface 168 and the lubricant wipe surface 170 as the two thrusters 235, 236 rotate about the central axis A1 through the first depression 172. The thruster compression seals 268 initially abut the second incline surface 174 as the two thrusters 235, 236 rotate about the central axis A1 through the second depression 178. The second incline surface 174 angles away from the central axis A1 to a point at which the top surfaces 274 of the thruster compression seals 268 are spaced from the second incline surface 174. As best shown in FIG. 25, the top surfaces 274 of thruster compression seals 268 do not abut the exhaust surface 176 of the housing 102 as the two thrusters 235, 236 rotate about the central axis A1 through the second depression 178. The top surfaces 274 of thruster compression seals 268 do not abut the combustion surface 182 of the housing as the two thrusters 235, 236 rotate about the central axis A1 through the third depression 184. The thruster compression seals 268 are initially spaced from the decline surface 180. As best shown in FIG. 26, the decline surface 180 angles towards the central axis A1 to a point at which the tapered surfaces 278 of the thruster compression seals 268 abut the decline surface 180. The two side surfaces 276 of the thruster compression seals 268 constantly abut the housing wall 166 and the rotor seals 232 as the two thrusters 235, 236 rotate about the central axis A1.

Turning back to FIGS. 22-23, the first seal portions 270 and the second seal portions 272 overlap and define a gap 282 between the first seal portions 270 and the second seal portions 272. The gaps 282 allow high pressure combustion gases to flow into the gap 282 bias the first seal portions 270 and the second portions away from each other to abut the housing wall 166. The gaps 282 also allow for thermal growth of the first seal portions 270 and the second seal portions 272. The first seal portions 270 and the second seal portions 272 define corresponding interlocking features 284. The interlocking features 284 enable the first seal portions 270 and the second seal portions 272 to move towards and away from the housing wall 166 as a unit in a vertical direction. The interlocking features 284 enable the first seal portions 270 and the second seal portions 272 to move towards and away from the housing wall 166 and the rotor seals 232 separately in a horizontal direction.

The thruster compression seals 268 has a cross biasing member 286 mounted between the first seal portions 270 and the second seal portions 272 to bias the first seal portions 270 and the second seal portions 272 away from each other. The first seal portions 270 and the second seal portions 272 of the thruster compression seals 268 are configured to move relative to each other to abut the housing wall 166 and divide the working chamber 202.

The thruster compression seals 268 define a plurality of lubricant grooves 288 along the first seal portions 270 and the second seal portions 272. The plurality of lubricant grooves 288 of the thruster compression seals 268 are in fluid communication with the thruster channels 260. The plurality of lubricant grooves 288 of the thruster compression seals 268 facilitates lubricant flow into and from the thruster compression seals 268 with lubricant supplied by the thruster channels 260. The thruster compression seals 268 further define a plurality of thruster compression seal channels 290 in fluid communication with the plurality of rotor lubricant channels. The thruster compression seal channels 290 lubricate between the thruster compression seals 268 and the thruster compression seal chamber surfaces 264 as the thruster compression seals 268 move within the thruster.

The two thrusters 235, 236 include two vertical biasing members 292 and four horizontal biasing members 294 disposed in and mounted to the two thrusters 235, 236. One of the vertical biasing members 292 biases and dampens the movement of the first seal portions 270 and the other of the two vertical biasing members 292 bias and dampens the second seal portions 272. The two vertical biasing members 292 bias the first seal portions 270 and the second seal portions 272 away from the two thrusters 235, 236 and dampen the movement towards the two thrusters 235, 236 in a vertical direction. Two of the horizontal biasing members 294 bias and dampens the first seal portions 270 and the other two of the four horizontal biasing members 294 bias and dampens the second seal portion 272. The two horizontal biasing members 294 bias the first seal portions 270 and the second seal portions 272 away from the two thrusters 235, 236 and dampen the movement towards the two thrusters 235, 236 in a horizontal direction. However, it is to be appreciated that the two thrusters 235, 236 can have any number of vertical biasing members 292 or any number of horizontal biasing members 294 in any configuration.

The two thrusters 235, 236 have ball structures 294 disposed in the two thrusters 235, 236 between the thruster compression seals 268 and the biasing members 292, 293. The ball structures 294 define a ball chamber and include a steel ball 296 movably disposed in the ball chamber. The steel balls 296 abut the thruster compression seals 268 and the biasing members 292, 293. The two vertical biasing members 292 and the corresponding steel balls 296 bias the top surface 274s of the thruster compression seals 268 towards the housing wall 166. The four horizontal biasing members 294 and the corresponding steel ball 296 bias the two side surfaces 276 of the thruster compression seals 268 towards the housing wall 166 and the rotor seals 232. The steel balls 296 of the ball structures 294 enables corresponding the biasing members 292, 293 to maintain constant contact with the first seal portions 270 and second seal portions 272 as the first seal portions 270 and second seal portions 272 move. However, it is to be appreciated that the steel balls 296 can be any suitable material or shape to be used in the ball structure.

The two thrusters 235, 236 have two vertical dampers 298 in place of the two vertical biasing members 292. The two vertical dampers 298 are disposed in and mounted to the two thrusters 235, 236. The two vertical dampers 298 have a damper body 300 defining a damper chamber 302. The two vertical dampers 298 further include a damper piston 304 and a damper piston rod 306 disposed in the damper chambers 302 and dividing the damper chambers 302 into a first cavity 308 and a second cavity 310. The damper pistons 304 define a hydraulic channel 312 extending into the first cavities 308 and the second cavities 310. The two vertical dampers 298 additionally include a damper biasing member 314 disposed around the damper pistons rods 306 and abutting the damper bodies 300 and the damper pistons 304. The damper biasing members 314 bias the damper pistons 304 and the damper piston rods 306 away from the damper bodies 300.

The two vertical dampers 298 have a check valve 316 disposed in and mounted to the damper pistons 304. The check valves 316 and the hydraulic channels 312 facilitate flow of hydraulic fluid through the damper pistons 304 between the first cavities 308 and the second cavities 310. As the thruster compression seals 268 move along the first incline surface 168 and the second incline surface 174, the check valves 316 open and hydraulic fluid flows through the check valves 316 and the hydraulic channels 312 from the first cavities 308 and the second cavities 310. The damper pistons 304 are biased by the damper biasing members 314 away from the damper bodies 300 and can quickly move as the hydraulic fluid flows at a high flow rate through both the check valves 316 and the hydraulic channels 312.

As the thruster compression seals 268 abut the decline surface 180 and move toward the two thrusters 235, 236 in the thruster compression seal chambers 266, the check valves 316 are closed and the hydraulic fluid can only flow through the smaller hydraulic channels 312 at a lower flow rate. The lower flow rate creates resistance to the movement of the damper pistons 304 and damper rods 306 in the damper chambers 302. The resistance to the movement dampens the thruster compression seals 268 as the thruster compression seals 268 move inward toward the two thrusters 235, 236 in the thruster compression seal chambers 266.

As best shown in FIGS. 21-23, the thruster compression seals 268 have a front surface 318 and a rear surface 320 with the front surfaces 318 and the rear surfaces 320 interfacing with the thruster compression seal chamber surfaces 264. The thruster compression seals 268 further have a plurality of metal mesh pads 322 and foil layers (not shown) with the foil layers disposed around the plurality of metal mesh pads 322. The metal mesh pads 322 are mounted to the front surfaces 318 and the rear surfaces 320. As the thruster compression seals 268 are disposed in the thruster compression seal chambers 266, the metal mesh pads 322 are disposed between the front surfaces 318 and the rear surfaces 318 of the thruster compression seals 268 and the corresponding thruster compression seal chamber surfaces 264. The plurality of metal mesh pads 322 are compressed and seal between the thruster compression seals 268 in the thruster compression seal chambers 266. The plurality of metal mesh pads 322 and the foil layers prevent high pressure gases from by-passing the thruster compression seals 268 in the thruster compression seal chambers 266.

The first seal portions 270 have a first overlap surface 324 and the second seal portions 272 has a second overlap surface 326. The first overlap surfaces 324 and the second overlap surfaces 326 abut and define a overlap 328 between the first seal portions 270 and the second seal portions 272. The thruster compression seals 268 further have a metal mesh pad 330 and foil layer (not shown) mounted to one of the first overlap surfaces 324 and the second overlap surfaces 326. The foil layers are disposed around the metal mesh pads 330. The metal mesh pads 330 and foil layers maintain a constant seal between the first seal portions 270 and the second seal portions 272 as first seal portions 270 and the second seal portions 272 move relative to each other in a horizontal direction from thermal growth direction. Lubricant is circulated within the overlap 328 between the first seal portions 270 and the second seal portions 272 to the lubricant the movement of the first seal portions 270 and the second seal portions 272 and prevent gases from by-passing the overlap 328.

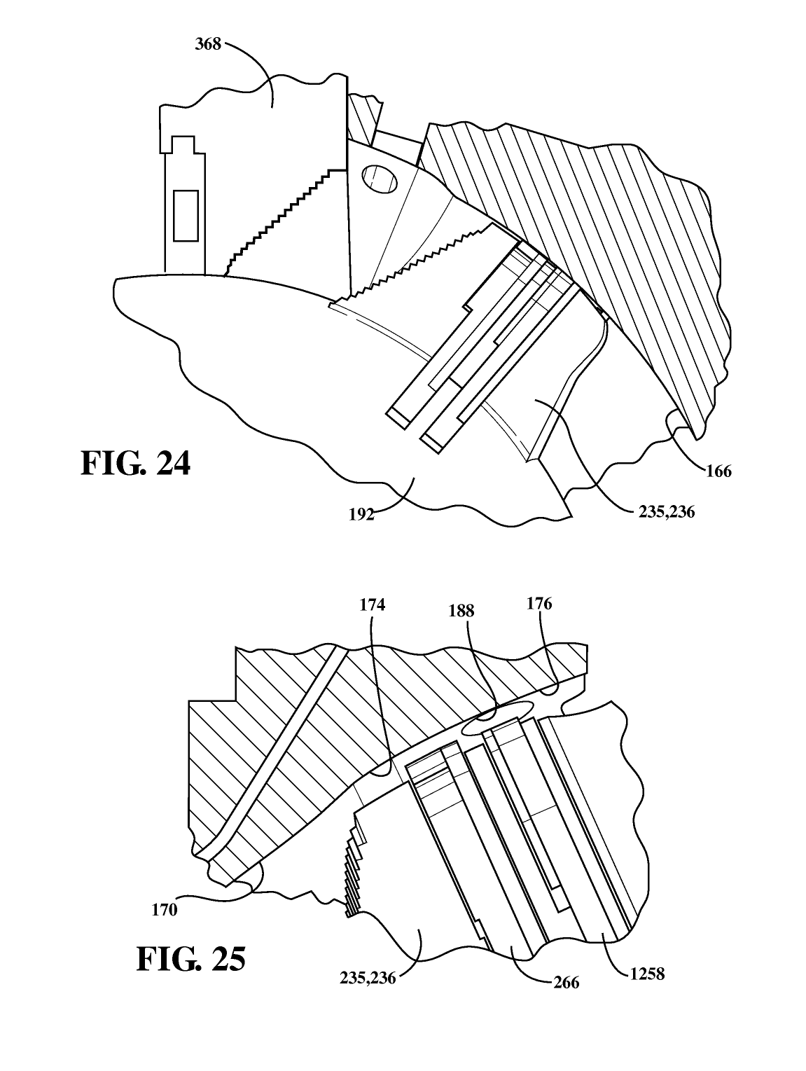

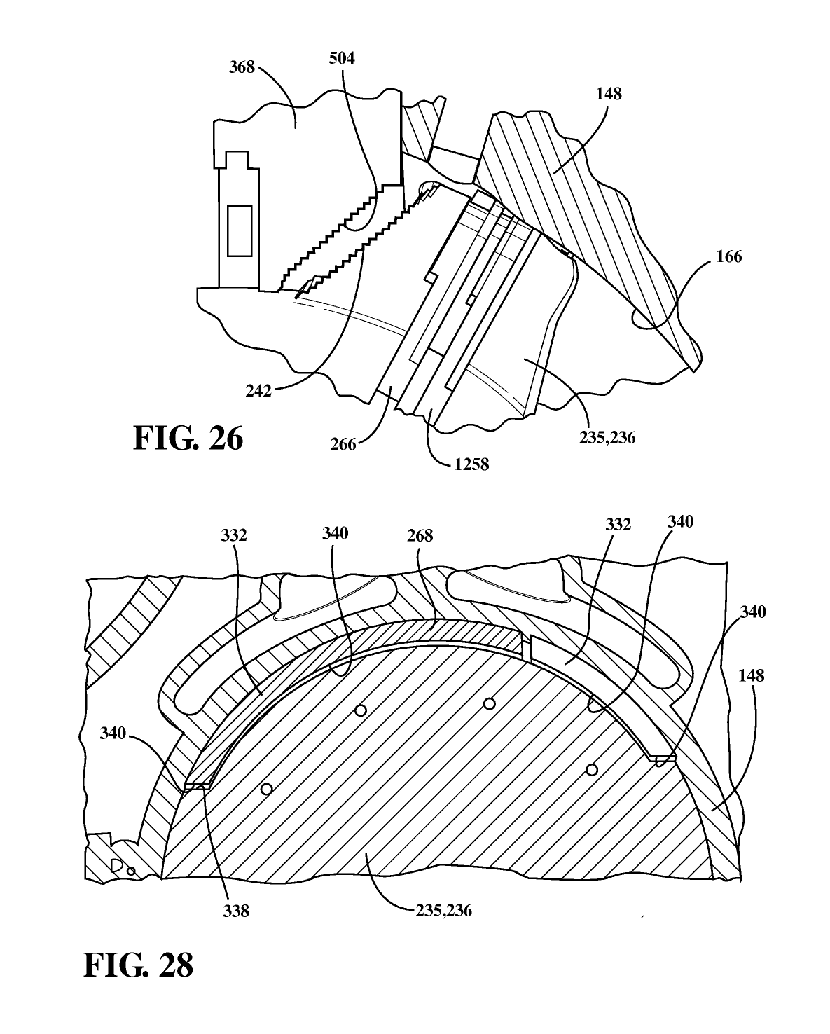

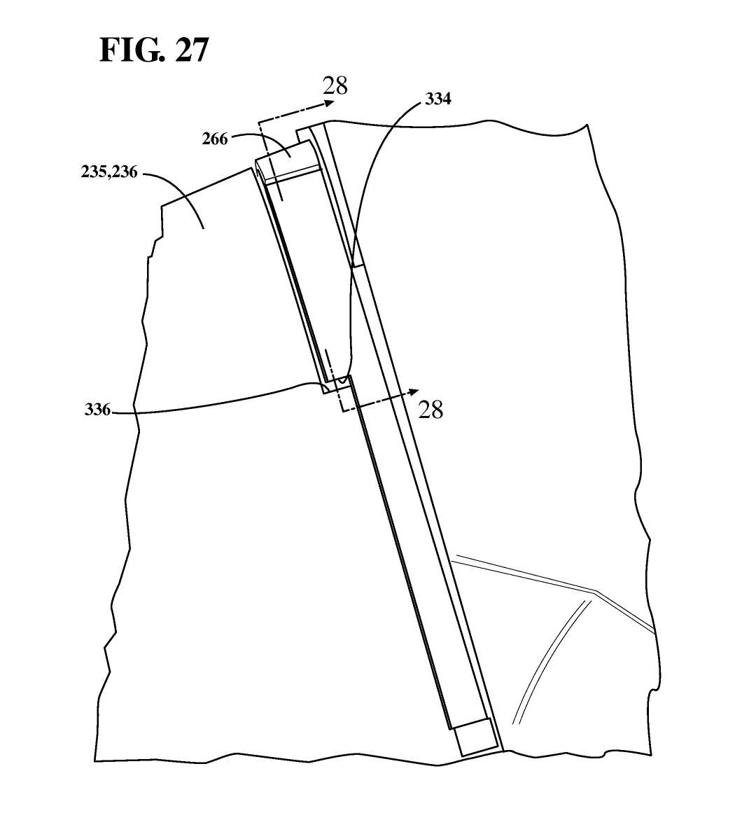

As best shown in FIGS. 27-28, the thruster compression seals 268 have a lip protrusion 332 with a lip surface 334. The two thrusters 235, 236 have a cutout surface 336 defining a lip cutout 338 adjacent to the thruster compression seal chambers 266. The lip protrusions 332 of the thruster compression seals 268 are disposed in the lip cutouts 338 of the thruster compression seal chambers 266. A pressure gap 340 is defined between the lip surfaces 334 and the lip cutouts 338. The pressure gaps 340 allow high pressure gases to fill the pressure gaps 340 and bias the lip protrusions 332 away from the lip cutouts 338. The high pressure gases bias the top surfaces 274 of the thruster compression seals 268 against the housing wall 166.

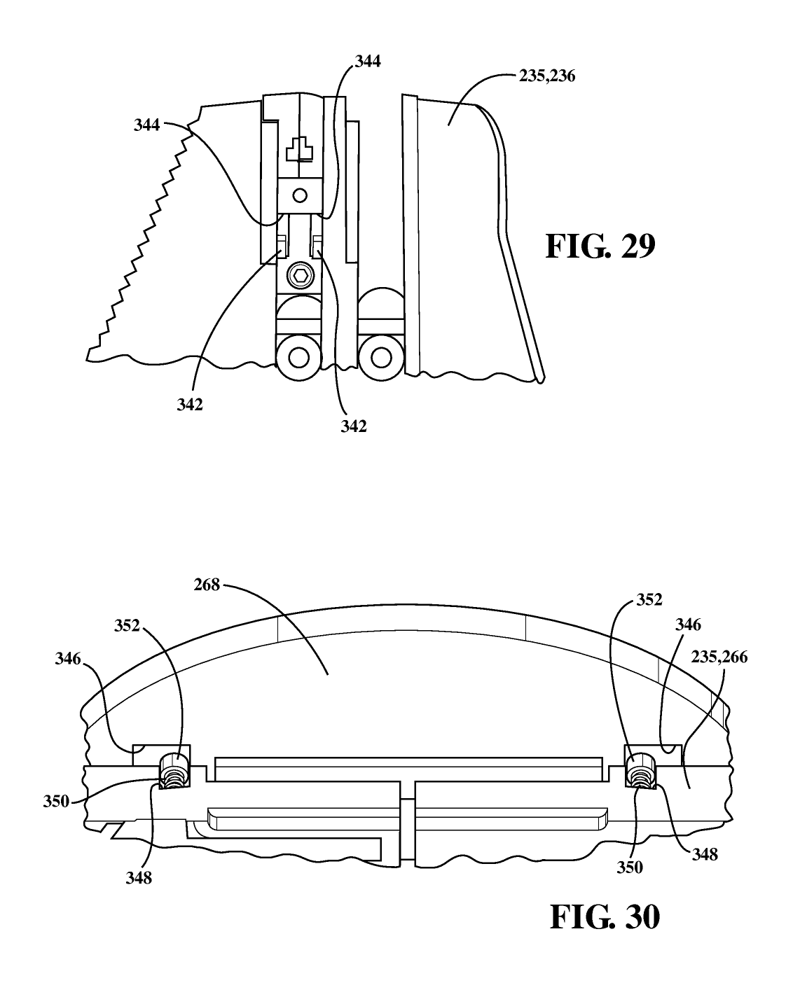

As best shown in FIGS. 20 and 29, the two thrusters 235, 236 define a limiting protrusion 342 extending into the thruster compression seal chambers 266. The thruster compression seals 268 define a protrusion slot 344. The limiting protrusions 342 of the two thrusters 235, 236 are disposed in the protrusion slots 344 of the thruster compression seals 268 as the thruster compression seals 268 are disposed in the thruster compression seal chamber 266. The width of the protrusion slots 344 are greater than the width of the limiting protrusions 342 to allow the thruster compression seals 268 to move in the two thrusters 235, 236. The vertical movement of the thruster compression seals 268 is limited by the limiting protrusions 342 disposed within the protrusion slots 344. The limiting protrusions 342 prevent the thruster compression seals 268 from abutting the exhaust surface 176 and the combustion surface 182 of the housing 102.

As best shown in FIG. 30, the thruster compression seal chamber 266 defines a retention slot 346. The thruster compression seals 268 define a button chamber 348. The thruster compression seals 268 have a button biasing member 350 and a button retainer 352. The button biasing members 350 are disposed in the button chambers 348 and mounted to the thruster compression seals 268. The button retainers 352 are mounted to the button biasing member 350 and are moveable into and from the button chambers 348. As the thruster compression seals 268 are installed into the two thrusters 326, the button biasing members 350 and the button retainers 352 are compressed into the button chambers 348. As the button biasing members 350 and the button retainers 352 are aligned with the corresponding retention slots 346, the button biasing members 350 are decompressed and dispose the button retainers 352 in the retention slots 346. The button retainers 352 move along the retention slots 346 as the thruster compression seals 268 move in and out of the two thrusters 235, 236. The horizontal movement of the thruster compression seals 268 is limited to the movement of the button retainers 352 in the retention slots 346.

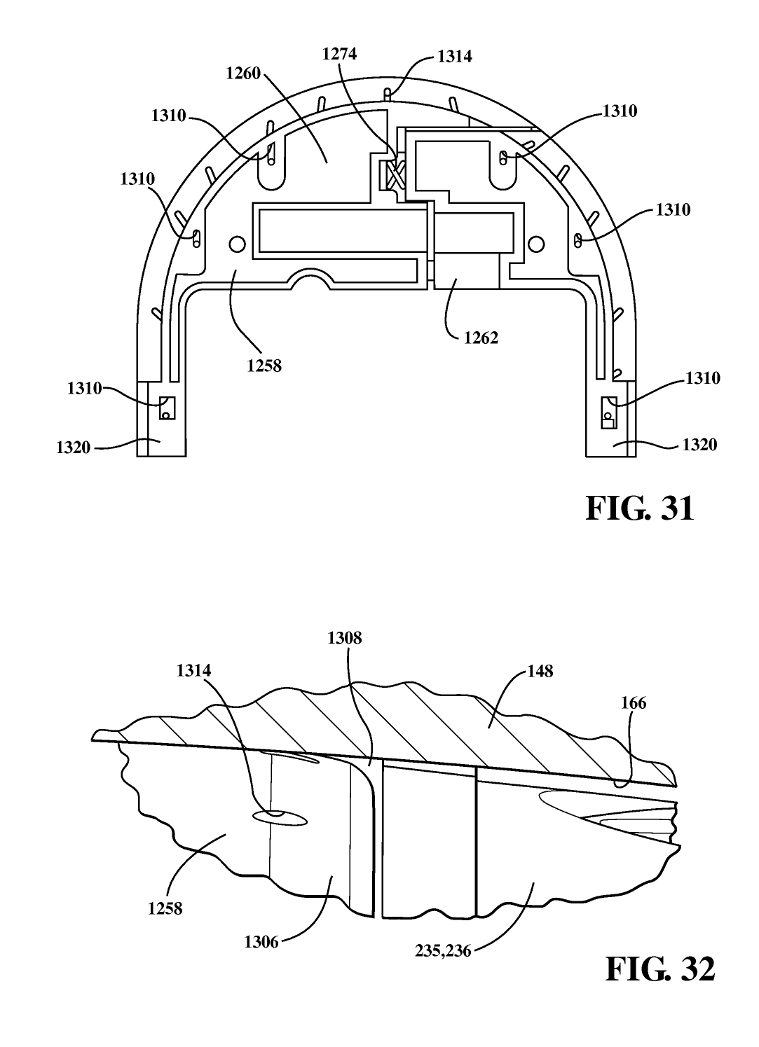

As shown in FIG. 31, the thruster lubricant seals 1258 have a first seal portion 1260 movably mounted to the two thrusters 235, 236 and a second seal portion 1262 movably mounted to the two thrusters 235, 236 and interfacing with the first seal portions 1260. The first seal portions 1260 and the second seal portions 1262 form a top surface 1264 and two side surfaces 1266. The top surfaces 1264 and the two side surfaces 1266 of the thruster lubricant seals 1258 form a configuration corresponding with the housing wall 166. The top surfaces 1264 and the two side surfaces 1266 of the thruster lubricant seals 1258 abut the housing wall 166 and the rotor seals 232 to form a continuous seal. The thruster lubricant seals 1258 further have a tapered surface 1268 corresponding with the decline surface 180 of housing 102. The tapered surfaces 1268 of the thruster lubricant seals 1258 abut the decline surface 180 as the two thrusters 235, 236 rotate along the decline surface 180 to form a continuous seal. The thruster lubricant seals 1258 abut the housing wall 166 and the rotor seals 232 to prevent lubricant from bypassing the two thrusters 235, 236.

As best shown in FIG. 24, the thruster lubricant seals 1258 abut housing wall 166. The thruster lubricant seals 1258 abut the first incline surface 168 and the lubricant wipe surface 170 as the two thrusters 235, 236 rotate about the central axis A1 through the first depression 172. The thruster lubricant seals 1258 initially abut the second incline surface 174 as the two thrusters 235, 236 rotate about the central axis A1 through the second depression 178. The second incline surface 174 angles away from the central axis A1 to a point at which the top surfaces 1264 of the thruster lubricant seals 1258 are spaced from the second incline surface 174. As best shown in FIG. 25, the top surfaces 1264 of thruster lubricant seals 1258 do not abut the exhaust surface 176 as the two thrusters 235, 236 rotate about the central axis A1 through the second depression 178. The top surfaces 1264 of thruster lubricant seals 1258 do not abut the combustion surface 182 as the two thrusters 235, 236 rotate about the central axis A1 through the third depression 184. As best shown in FIG. 26, the thruster lubricant seals 1258 are initially spaced from the decline surface 180. The decline surface 180 angles towards the central axis A1 to a point at where the tapered surfaces 1268 of the thruster lubricant seals 1258 abut the decline surface 180. The two side surfaces 1266 of the thruster lubricant seals 1258 constantly abut the housing wall 166 and the rotor seals 232 as the two thrusters 235, 236 rotate about the central axis A1.

Turning back to FIG. 31, the first seal portions 1260 and the second seal portions 1262 overlap and define a gap 1270 between the first seal portions 1260 and the second seal portion 1262. The gaps 1270 allow high pressure combustion gas to flow into the gaps 1270 and bias the first seal portions 1260 and the second portions 1262 away from each other to abut the housing wall 166. The gaps 1270 also allow for thermal growth of the first seal portions 1260 and the second portions 1262. The first seal portions 1260 and the second portions 1262 define corresponding interlocking features 1272 which overlap. The interlocking features 1272 enable the first seal portions 1260 and the second seal portions 1262 to move towards and away from the housing wall 166 as a unit in a vertical direction. The interlocking features 1272 further enable the first seal portions 1260 and the second seal portions 1262 to move towards and away from the housing wall 166 separately in a horizontal direction for thermal growth and contraction.

The thruster lubricant seals 1258 has a cross biasing member 1274 mounted between the first seal portions 1260 and the second seal portions 1262 to bias the first seal portions 1260 and the second seal portions 1262 away from each other. The first seal portions 1260 and the second seal portions 1262 of the thruster lubricant seals 1258 are configured to move relative to each other to abut the housing wall 166 and divide the working chamber 202.

The two thrusters 235, 236 include two vertical biasing members 1276 and four horizontal biasing members 1278 disposed in and mounted to the two thrusters 235, 236. One of the vertical biasing members 1276 bias and dampens the movement of the first seal portions 1260 and the other of the two vertical biasing members 1276 bias and dampens the second seal portions 1262. The two vertical biasing members 1276 bias the first seal portions 1260 and the second seal portions 1262 away from the two thrusters 235, 236 and dampen the movement towards the two thrusters 235, 236 in a vertical direction. Two of the horizontal biasing members 1278 bias and dampen the first seal portions 1260 and the other two of the four horizontal biasing members 1278 bias and dampen the second seal portion. The two horizontal biasing members 1278 bias the first seal portions 1260 and the second seal portions 1262 away from the two thrusters 235, 236 and dampen the movement towards the two thrusters 235, 236 in a horizontal direction. However, it is to be appreciated that the two thrusters 235, 236 can have any number of vertical biasing members 1276 or any number of horizontal biasing members 1278 in any configuration.

The two thrusters 235, 236 have ball structures 1280 disposed in the two thrusters 235, 236 between the thruster lubricant seals 1258 and the biasing members 1276, 1278. The ball structures 1280 define a ball chamber and include a steel ball 1284 movably disposed in the ball chamber. The steel balls 1284 abut the thruster lubricant seals 1258 and the biasing members 1276, 1278. The two vertical biasing members 1276 and the corresponding steel balls 1284 bias the top surfaces 1264 of the thruster lubricant seals 1258 towards the housing wall 166. The four horizontal biasing members 1278 and the corresponding steel balls 1284 bias the two side surfaces 1266 of the thruster lubricant seals 1258 towards the housing wall 166 and the rotor seals 232. The steel balls 1284 of the ball structures 1280 enables corresponding biasing members 1276, 1278 to maintain constant contact with the first seal portions 1260 and second seal portions 1262 as the first seal portions 1260 and second seal portions 1262 move. However, it is to be appreciated that the steel balls 1284 can be any suitable material or shape to be used in the ball structures 1280.

In another embodiment, the two thrusters 235, 236 have two vertical dampers 1286 in place of the two damper biasing members 1302. The two vertical dampers 1286 are disposed in and mounted to the two thrusters 235, 236. The two vertical dampers 1286 have a damper body 1288 defining a damper chamber 1290. The two vertical dampers 1286 further include a damper piston 1292 and a damper rod 1294 disposed in the damper chambers 1290 and dividing the damper chambers 1290 into a first cavity 1296 and a second cavity 1298. The damper piston 1292 defines a hydraulic channels 1300 extending into the first cavities 1296 and the second cavities 1298. The two vertical dampers 1286 additionally include a damper biasing member 1302 disposed around the damper rods 1294 and abutting the damper bodies 1288 and the damper pistons 1292. The damper biasing members 1302 bias the damper pistons 1292 and the damper rods 1294 away from the damper bodies 1288. It is to be appreciated that the thruster lubricant seals 1258 include similar features and components of the thruster compression seals 268 and mounted in a similar method to the two thrusters 235,236 as the thruster compression seals 268. In particular, the thruster lubricant seals 1258 are mounted to the two thrusters 235, 236 and interacting with the two vertical dampers 1286 as the thruster compression seal 268 is shown in FIG. 23.

The two vertical dampers 1286 have a check valve 1304 disposed in and mounted to the damper pistons 1292. The check valves 1304 and the hydraulic channels 1300 facilitate flow of hydraulic fluid through the damper pistons 1292 between the first cavities 1296 and the second cavities 1298. As the thruster lubricant seals 1258 move along the first incline surface 168 and the second incline surface 174, the check valves 1304 are open and hydraulic fluid flows through the check valves 1304 and the hydraulic channels 1300 from the first cavities 1296 to the second cavities 1298. The damper pistons 1292 are biased by the damper biasing members 1302 away from the damper bodies 1288 and can quickly move as the hydraulic fluid flows at a high flow rate through both the check valves 1304 and the hydraulic channels 1300.

As the thruster lubricant seals 1258 abut the decline surface 180 and move toward the two thrusters 235, 236 in the thruster lubricant seal chambers 1256, the check valves 1304 are closed and the hydraulic fluid can only flow through the hydraulic channels 1300 at a lower flow rate. The lower flow rate increases resistance to the movement of the damper pistons 1292 and damper rods 1294 in the damper chambers 1290. The resistance to the movement dampens the lubricant seal chambers 1258 as the lubricant seal chambers 1258 move inward toward the two thrusters 235, 236 in the thruster lubricant seal chambers 1256.

The thruster lubricant grooves 1308 extend around the two thrusters 235, 236 overlapping the housing wall 166 and the rotor seals 232 as the thruster lubricant seal 1258 abuts the housing wall 166 and the rotor seals 232. The thruster lubricant grooves 1308 disperse the lubricant across the thrusters 235, 236 as the rotor 192 rotates along the housing wall 166. The thruster lubricant seals 1258 further define a plurality of lubricant supply pathways 1310. Turning to FIG. 33, the thruster lubricant groove 1308 are in fluid communication with the valve passageways 262 through the plurality of lubricant supply pathways 1310. The plurality of thruster lubricant grooves 1308 disperse the lubricant released by the thruster valves 246 across the top surfaces 238 and the side surfaces 1266 of the two thrusters 235, 236. The thruster lubricant grooves 1308 apply lubricant between the housing wall 166, the primary surface 194 of the rotor 192, and the secondary surface of the rotor 192 to lubricate the between rotor 192 and the rotor seals 232. Further referring to FIG. 34, the thruster lubricant seals 1258 further define a plurality of thruster lubricant channels 1312 in fluid communication with the plurality of rotor lubricant channels. The thruster lubricant channels 1312 lubricate between the thruster lubricant seals 1258 and the two thrusters 235, 236 as the thruster lubricant seals 1258 move within the two thrusters 235, 236.

As best shown in FIG. 34, the thruster lubricant seals 1258 define a plurality of lubricant drain channels 1314. The plurality of lubricant drain channels 1314 are in fluid communication with the thruster lubricant grooves 1308. As the rotor 192 rotates along the housing wall 166 and lubricant wipe surface 170, lubricant accumulates in the thruster lubricant grooves 1308 and is forced into plurality of lubricant drain channels 1314 by the centrifugal force created by the rotation of the rotor 192. The plurality of lubricant drain channels 1314 are in fluid communication with the crankshaft channels. The lubricant flows from the plurality of lubricant drain channels 1314 into the plurality of crankshaft channels. The lubricant flows along the crankshaft channels and is drained from the crankshaft 104. As the thruster lubricant seals 1258 abut the lubricant wipe surface 170 and the thruster valves 246 are closed, the residual lubricant in the thruster lubricant grooves 1308 is drained. The residual lubricant is drained to prevent the lubricant from getting on the exhaust surface 176 of the housing 102 and the combustion surface 182 of the housing 102.

Referring back to FIGS. 21 and 31, the lubricant seals 1258 have a front surface 1316 and a rear surface 1318 interfacing with the thruster lubricant seal chamber surfaces 1254. The thruster lubricant seals 1258 further have metal mesh pads 1320 and foil layers (not shown) mounted to the front surfaces 320 and the rear surfaces 322. The foil layers are disposed around the metal mesh pads 1320. The metal mesh pads 1320 are mounted to the front surfaces 320 and the rear surfaces 322. As the thruster lubricant seals 1258 are disposed in the thruster lubricant seal chambers 1256, the metal mesh pads 1320 are disposed between the front surfaces 320 and the rear surfaces 322 of the thruster lubricant seals 1258 and the corresponding thruster lubricant seals chamber surfaces 254. The metal mesh pads 1320 are compressed and seal between the lubricant seal chambers 1258 in the thruster lubricant seal chambers 1256. The metal mesh pads 1320 and the foil layers prevent high pressure gases from by-passing the thruster lubricant seals 1258 in the thruster lubricant seal chambers 1256.

The first seal portions 1260 have a first overlap surface 1322 and the second seal portions 1262 have a second overlap surface 1324. The first overlap surfaces 1322 and the second overlap surfaces 1324 abut and define a gap 1326 between the first seal portions 1260 and the second seal portions 1262. The thruster lubricant seals 1258 further have a metal mesh pad 1328 and foil layer (not shown) mounted to each of the first overlap surfaces 1322 and the second overlap surfaces 1324. The foil layers are disposed around the metal mesh pads 1328. The metal mesh pads 1328 and foil layers maintain a constant seal between the first seal portions 1260 and the second seal portions 1262 as first seal portions 1260 and the second seal portions 1262 move relative to each other in a horizontal direction from thermal growth direction. Lubricant is circulated between the overlap sections (not shown) of the first seal portions 1260 and the second seal portions 1262 to the lubricant the movement of the first seal portions 1260 and the second seal portions 1262 and prevent gases from by-passing the gaps 1326.

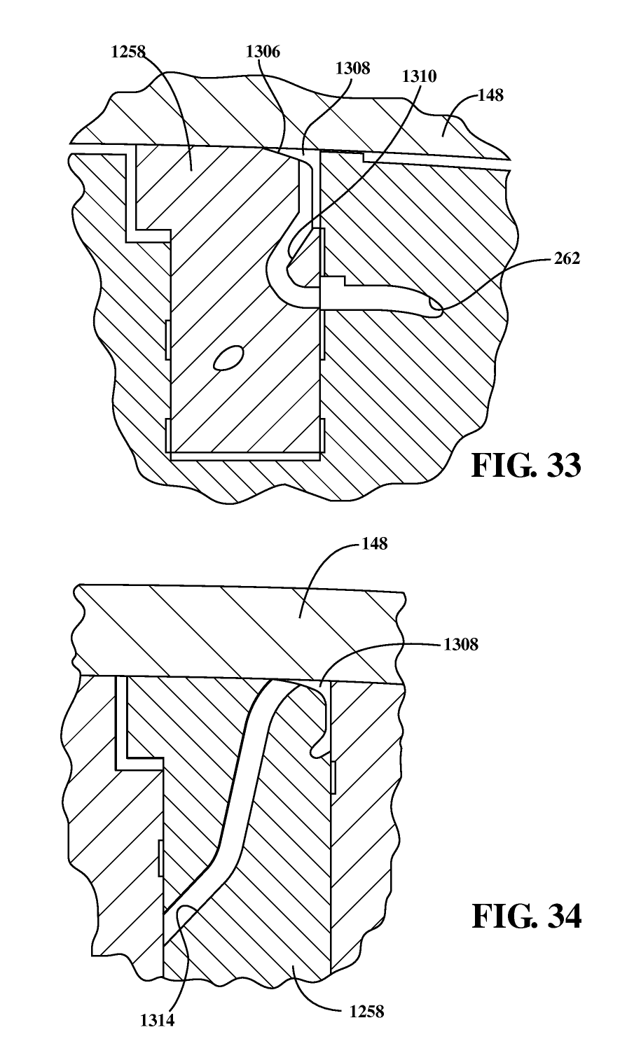

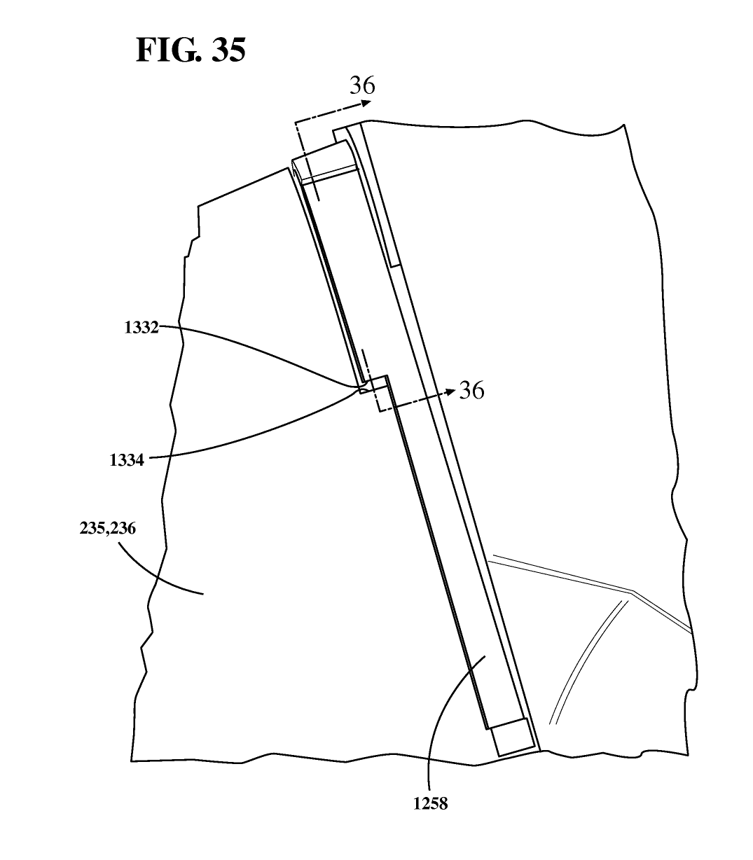

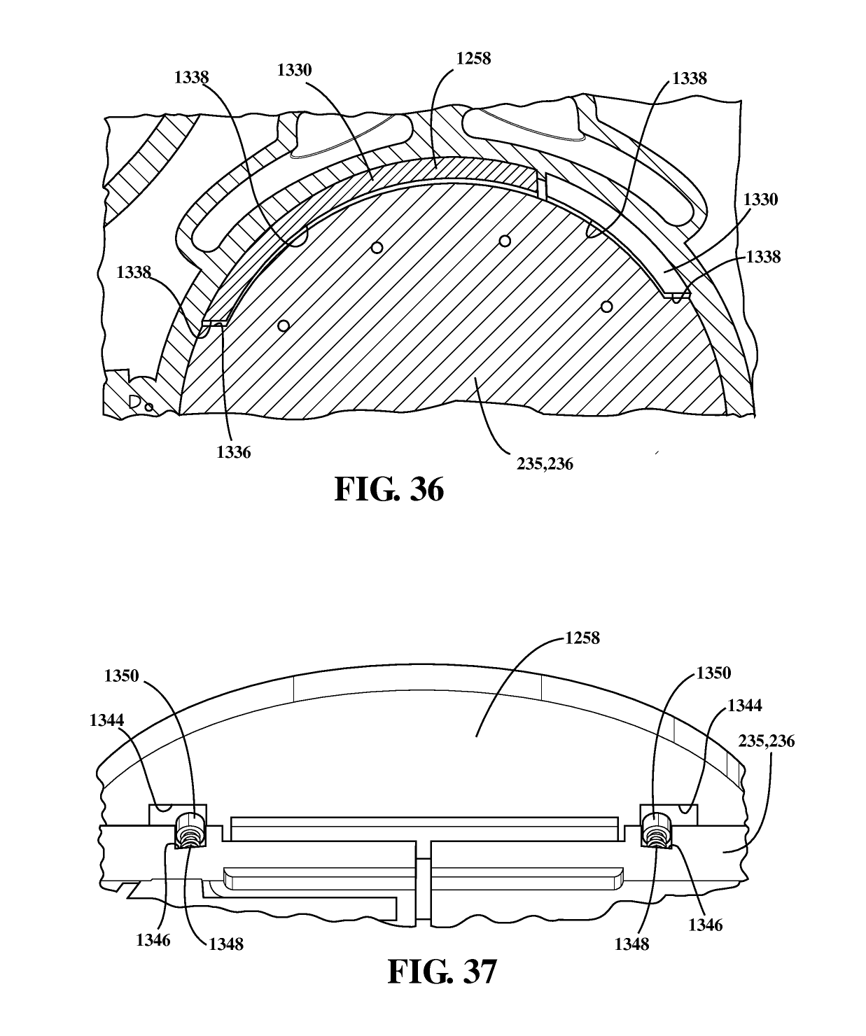

As best shown in FIGS. 35-36, the thruster lubricant seals 1258 have a lip protrusion 1330 with a lip face 1332. The two thrusters 235, 236 have a cutout surface 1334 defining a lip cutout 1336 adjacent to the thruster lubricant seal chambers 1256. The lip protrusions 1330 of the thruster lubricant seals 1258 are disposed in the lip cutouts 1336 of the thruster lubricant seal chambers 1256. A pressure gaps 1338 is defined between the lip faces 332 and the cutout surfaces 334. The pressure gaps 1338 allow high pressure gases to fill the pressure gaps 1338 and bias the lip protrusions 1330 away from the lip cutout 1336. The high pressure gases bias the top surfaces 1264 of the thruster lubricant seals 1258 against the housing wall 166.

As best shown in FIGS. 20 and 29, the two thrusters 235, 236 define a limiting protrusion 1340 extending into the thruster lubricant seal chambers 1256. The thruster lubricant seals 1258 define a protrusion slot 1342. The limiting protrusions 1340 of the two thrusters 235, 236 are disposed in the protrusion slots 1342 of the thruster lubricant seals 1258 as the thruster lubricant seals 1258 are disposed in the thruster lubricant seal chambers 1256. The width of the protrusion slots 1342 are greater than the width of the limiting protrusions 1340 to allow the thruster lubricant seals 1258 to move in the two thrusters 235, 236. The vertical movement of the thruster lubricant seals 1258 is limited by the limiting protrusions 1340 disposed within the protrusion slots 1342. The limiting protrusions 1340 prevent the thruster lubricant seals 1258 from abutting the exhaust surface 176 and the combustion surface 182 of the housing 102.

As best shown in FIG. 37, the thruster lubricant seal chambers 1256 define a retention slot 1344. The thruster lubricant seals 1258 define a button chamber 1346. The thruster lubricant seals 1258 further have a button biasing member 1348 and a button retainer 1350. The button biasing members 1348 are disposed in the button chambers 1346 and mounted to the lubricant seal chambers 1258. The button retainers 1350 are mounted to the button biasing members 1348 and are moveable into and from the button chambers 1346. As the thruster lubricant seals 1258 are installed into the two thrusters 263, the button biasing members 1348 and the button retainers 1350 are compressed into the button chambers 1346. As the button biasing members 1348 and the button retainers 1350 are aligned with the corresponding retention slots 1344, the button biasing members 1348 are decompressed and dispose the button retainers 1350 in the button chambers 1346. The button retainers 1350 move along the retention slots 1344 as the thruster lubricant seals 1258 moves in and out of the thruster. The horizontal movement of the thruster lubricant seals 1258 is limited to the movement of the button retainers 1350 in the retention slots 1344.

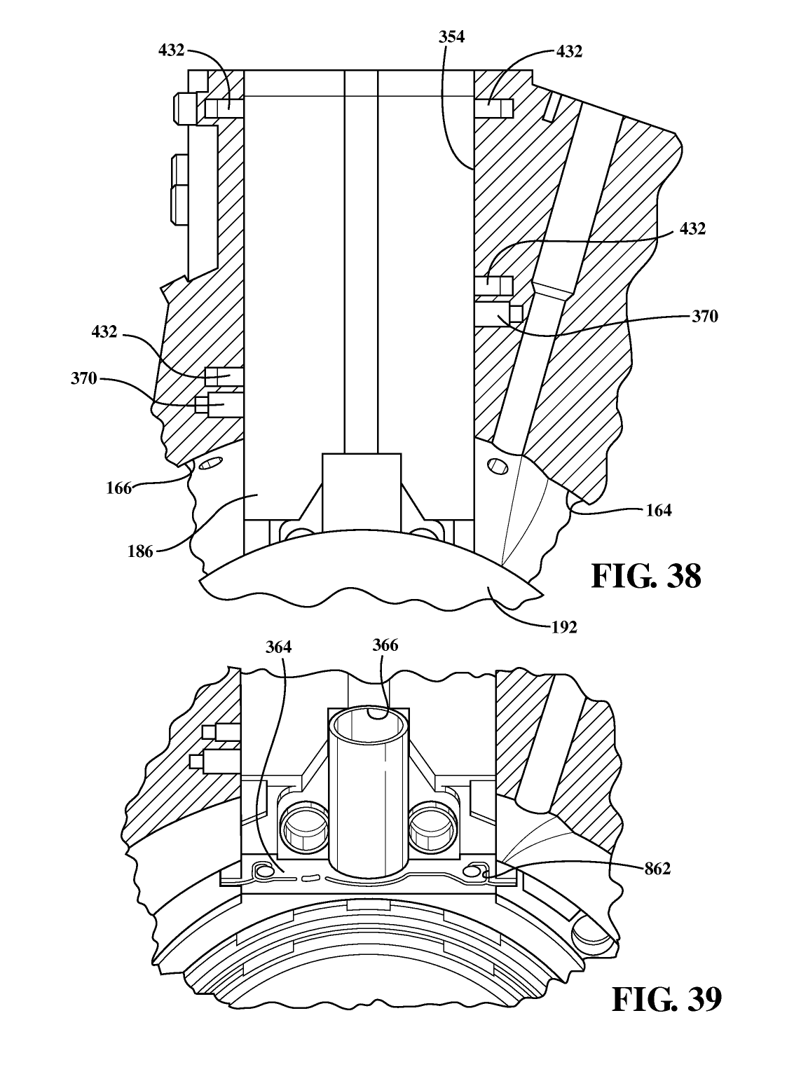

As best shown in FIGS. 38-39, the housing 102 has a vane chamber surface 1352 defining a vane chamber 354 with a rotor end 356 and a lock end 358. The vane chamber 354 extends into the vane cavity 186 of the rotor interior 164. The vane chamber 354 further has a combustion wall 360 and an exhaust wall 362.

At the rotor end 192 of the vane chamber 354, the housing 102 includes two rail structures 364 defining a rail chamber 366. The two rail structures 364 are disposed in the vane chamber 354 at the rotor end 356.

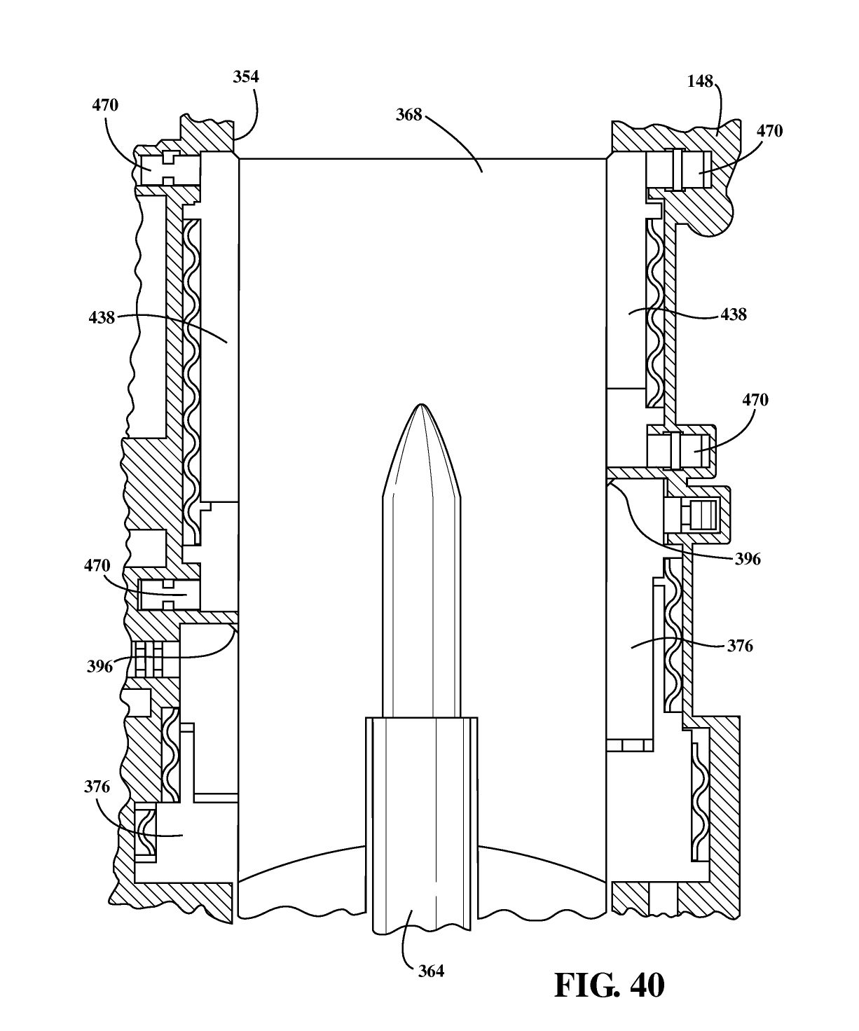

As best shown in FIG. 40, the rotational engine assembly 100 includes a vane 368 disposed in the vane chamber 354 and movably mounted to the housing 102. It should be appreciated that the vane 368 will be discussed in further detail later in the detailed description of the invention.

Referring back to FIG. 38, the vane chamber surface 1352 further defines two compression seal chambers 370 extending into the vane chamber 354. The two compression seal chambers 370 have a rectangular configuration with an outer surface 372 and a top surface 374.

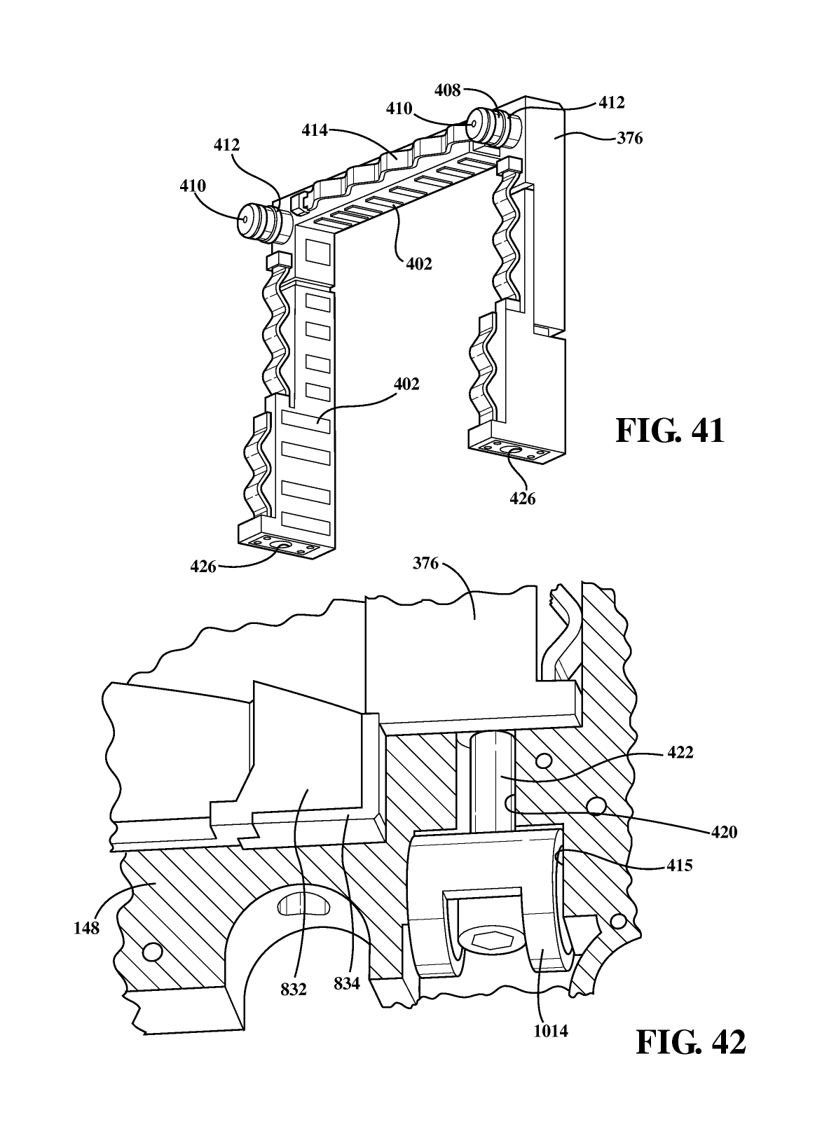

As best illustrated in FIG. 40, the rotational engine assembly 100 includes two compression seals 376 mounted in the two compression seal chambers 370. Turning to FIG. 41, the two compression seals 376 have a substantially U-shaped configuration. The two compression seals 376 each have four seal components 378 with overlap structures 380 and bottom surfaces 382. However, it is to be appreciated that the two compression seals 376 maybe any suitable configuration or compose any number of seal components 378 suitable for sealing.

The overlap structures 380 have protrusions 384 and define corresponding overlap cavities 448 that interface with each other. A plurality of gaps (not shown) are defined between the corresponding overlap protrusions 384 and overlap cavities 448. The overlap structures 380 interlock with each other as the two compression seals 376 move to abut the vane 368. The two compression seals 376 form a continuous seal with the vane 368 across the entire compression seal chambers 370. The overlap structures 380 also permit the four seal components 378 to move relative to each other with the thermal expansion and contraction to maintain sealing with the vane 368.

A plurality of metal mesh pads 386 are disposed between overlap structures 380 to prevent high pressure gases from escaping between the overlap structures 380. The metal mesh pads 386 have a foil layer (not shown) disposed around the metal mesh pads 386. The metal mesh pads 386 and the foil layers create a continuous seal around the plurality of gaps between the corresponding overlap protrusions 384 and overlap cavities 448 as the overlap structures 380 move relative to each other with thermal expansion and contraction.

The two compression seals 376 have a front surface 388 and a rear surface 390. The front surfaces 388 have a horizontal sealing surface 392 and two vertical sealing surfaces 394. The horizontal sealing surfaces 392 define a chamfer surface 396 for installation of the vane 368 in the vane chamber 354 while pushing the two compression seals 376 into the two compression seal chambers 370.

The two compression seals 376 have an inner surface 398 and an exterior surface 400. A gap (not shown) is defined between the inner surfaces 398 of the two compression seals 376 and the two compression seal chambers 370 as the two compression seals 376 are inserted into the two compression seal chambers 370. A plurality of metal mesh pads 402 are mounted to the inner surfaces 398 of the two compression seals 376. Each of the plurality of metal mesh pads 402 have a foil layer disposed around the metal mesh pads 402. The plurality of metal mesh pads 402 and the foil layers are compressed as the two compression seals 376 are inserted into the two compression seal chambers 370. As the metal mesh pads 402 and the foil layers are compressed, the metal mesh pads 402 and the foil layers bias the two compression seals 376 against the outer surfaces 372 of the two compression seal chambers 370.

High pressure gases flow into the gaps between the inner surfaces 398 of the two compression seals 376 and the two compression seal chambers 370. The high pressure gases bias the inner surfaces 398 of the two compression seals 376 away from the two compression seal chambers 370 and bias the exterior surfaces 400 of the two compression seals 376 against the two compression seal chambers 370. The high pressure gases further bias the two compression seals 376 against the vane 368.

Referring back to FIG. 40, the housing 102 defines two pin cavities 406 extending into each of the two compression seal chambers 370. The two compression seals 376 each have two locating pins 408 extending from rear surfaces 390. The two locating pins 408 locate the correct placement of the two compressions seals 376 as the two compression seals 376 are inserted into the two compression seal chambers 370. The two locating pins 408 are tapered for ease of installation.

The two locating pins 408 define a pin lubricant channel 410 extending through the locating pins 408. The pin lubricant channels 410 are aligned with and in fluid communication with one of the plurality of housing lubricant supply channels as the two locating pins 408 are inserted into the two pin cavities 406. The two locating pins 408 further have pin seals 412 disposed around the two locating pins 408. The pin seals 412 abut the two pin cavities 406 as the two locating pins 408 are inserted into the two pin cavities 406. The pin seals 412 will prevent the by-pass of lubricant between the two locating pins 408 and the two pin cavities 406.

The four seal components 378 of the two compression seals 376 define seal lubricant conduits (not shown) extending through the four seal components 378. The seal lubricant conduits are in fluid communication with the pin lubricant channels 410. The seal lubricant conduits release lubricant into the plurality of gaps defined between the overlap structures 380 and sealed by the plurality of metal mesh pads 386.

The two compression seals 376 have a wave biasing members 414 mounted to the rear surfaces 390. The wave biasing members 414 are mounted across the four seal components 378. The wave biasing members 414 abut the housing 102 and bias the two compression seals 376 away from the housing 102 and against the vane 368.

As best shown in FIG. 42, the housing 102 defines a guide pin chamber 415 and the rotational engine assembly 100 has a outer bushing 1014 mounted in the guide pin chamber 415 and defining a bolt slot (not shown) and a pin chamber (not shown). The outer bushing 1014 has seal guide pin 416 movably disposed in the pin chamber. The seal guide pins 416 have a base pin 418 and define a bolt hole 419 through the base pin 418. The seal guide pins 416 further have a bolt 422 disposed in the bolt hole 419. The base pin 418 and the bolt 422 move as a unit. The housing 102 further defines a thru slot 420. The two compression seals 376 have a bottom surface 424 and define a threaded hole 426 extending through on the bottom surfaces 424. The bolts 422 extend from the base pins 418 through the bolt slot of the outer bushing 1014, through the thru slots 420 of the housing 102, and are disposed in the threaded holes 426 of the compression seals 376. The bolts 422 can move along the bolt slot and the thru slot 420 as the base pin 418 or the compression seal 376 move.

As the bolts 422 are screwed into the threaded holes 426 of the corresponding compression seals 376, the bolts 422 moves the bottom surfaces 424 of the corresponding compression seals 376 to abut the top surfaces 374 of the corresponding compression seal chambers 370. High pressure gases are prevented from bypassing the two compression seals 376 and the vane 386 or the outer surfaces 372 of the two compression seals 376 and the two compression seal chambers 370. High pressure gases are further prevented from bypassing the bottom surfaces 424 of the two compression seals 376 and the two compression seal chambers 370. The bolts 422 also serve as a locater for the two compression seals 376 against the outer surfaces 372 of the two compression seal chambers 370.

Turning back to FIG. 41, the two compression seals 376 have a lubricant surface 428 defining a lubricant pathway 430 extending through the bottom surfaces 424 of the two compression seals 376. The lubricant pathways 430 are in fluid communication with the bottom surfaces 424 of the two compression seal chambers 370. The lubricant circulated between the overlap structures 380 and sealed by the plurality metal mesh pads 402. The lubricant flows through the lubricant pathways 430 to the bottom surfaces 424 of the compression seal chambers 370. The lubricant lubricates between the two compression seals 376 and the two compression seal chambers 370 to allow the two compression seals 376 to move towards the vane 368 as the two compression seals 376 deteriorate overtime while overcoming the biasing of the bolts 422 of the seal guide pins 416. The bolts 422 move in the thru slots 420 as two compression seals 376 deteriorate and move. The lubricant is drained through one of the plurality housing lubricant drain channels.

A metal mesh pad (not shown) is mounted to the bottom surfaces 424 of the two compression seals 376. The metal mesh pad has a foil layer (not shown) disposed around the metal mesh pad. The metal mesh pad and the foil layer create a continuous seal between the two compression seals 376 and the two compression seal chambers 370 as the bolts 422 retain the two compression seals 376 against the two compression seal chambers 370.

Referring back to FIG. 38, the vane chamber surface 1352 further defines two lubricant seal chambers 432 extending into the vane chamber 354. The two lubricant seal chambers 432 have a rectangular configuration with an outer surface 434 and a top surface 436.

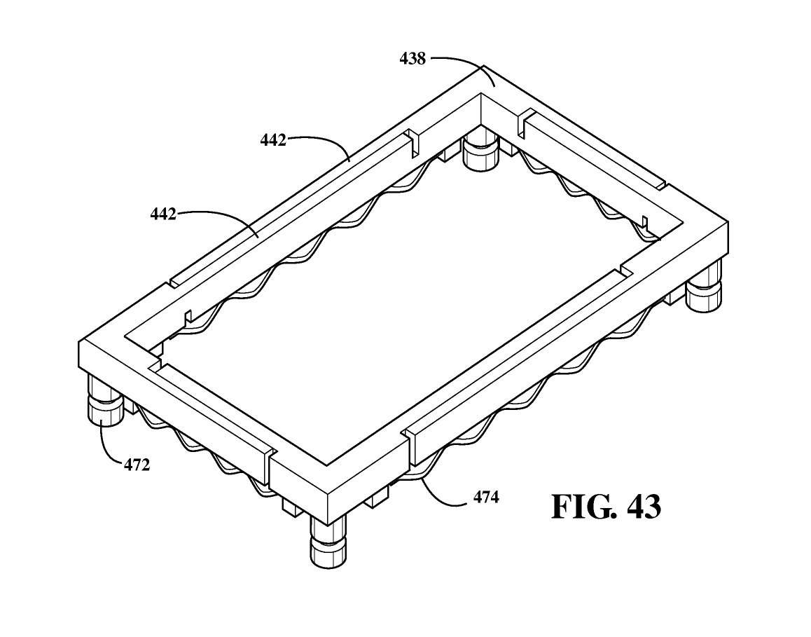

Turning to FIG. 40, the rotational engine assembly 100 includes two lubricant seals 438 mounted in the two lubricant seal chambers 432. Further referring to FIG. 43, the two lubricant seals 438 have a substantially rectangular shaped configuration. The two lubricant seals 438 each have four seal components 440 with overlap structures 442 and bottom surfaces 444. However, it is to be appreciated that the two lubricant seals 438 maybe any suitable configuration or compose any number of seal components 440 suitable for sealing.

The overlap structures 442 have protrusions 446 and define corresponding overlap cavities 448 that interface with each other. A plurality of gaps (not shown) are defined between the corresponding overlap protrusions 446 and overlap cavities 448. The overlap structures 442 interlock with each other as the two lubricant seals 438 move to abut the vane 368. The two lubricant seals 438 form a continuous seal with the vane 368 across the entire lubricant seal chambers 432. The overlap structures 442 also permit the four seal components 440 to move relative to each other with the thermal expansion and contraction to maintain sealing with the vane 368.

A plurality of metal mesh pads 450 are disposed between overlap structures 442 to prevent high pressure gases from escaping between the overlap structures 442. The metal mesh pads 450 have a foil layer (not shown) disposed around the metal mesh pads 450. The metal mesh pads 450 and the foil layers create a continuous seal around the plurality of gaps between the corresponding overlap protrusions 446 and overlap cavities 448 as the overlap structures 442 move relative to each other with thermal expansion and contraction.

The two lubricant seals 438 have a front surface 454 and a rear surface 456. The front surfaces 454 have two horizontal sealing surfaces 458 and two vertical sealing surfaces 460. The horizontal sealing surfaces 458 define a chamfer surface 462 for installation of the vane 368 in the vane chamber 354 while pushing the two lubricant seals 438 into the two lubricant seal chambers 432.

The two lubricant seals 438 have an inner surface 464 and an exterior surface 464. A metal mesh pad 468 is mounted to the inner surfaces 464 of the two lubricant seals 438. Each of the plurality of metal mesh pads 468 have a foil layer (not shown) disposed around the metal mesh pads 468. The plurality of metal mesh pads 468 and the foil layers are compressed as the two lubricant seals 438 are inserted into the two lubricant seal chambers 432. As the metal mesh pads 468 and the foil layers are compressed, the metal mesh pads 468 and the foil layers bias the two lubricant seals 438 against the outer surfaces 434 of the two lubricant seal chambers 432.

Turning back to FIG. 40, the housing 102 defines four pin cavities 470 extending into each of the two lubricant seal chambers 432. The two lubricant seals 438 each have four locating pins 472 extending from rear surfaces 456. The four locating pins 472 locate the correct placement of the two lubricants seals 438 as the two lubricant seals 438 are inserted into the two lubricant seal chambers 432. The four locating pins 472 are tapered for ease of installation.

The two lubricant seals 438 have a wave biasing members 474 mounted to the rear surfaces 456. The wave biasing members 474 are mounted across the four seal components 440. The wave biasing members 474 abut the housing 102 and bias the two lubricant seals 438 away from the housing 102 and against the vane 368.

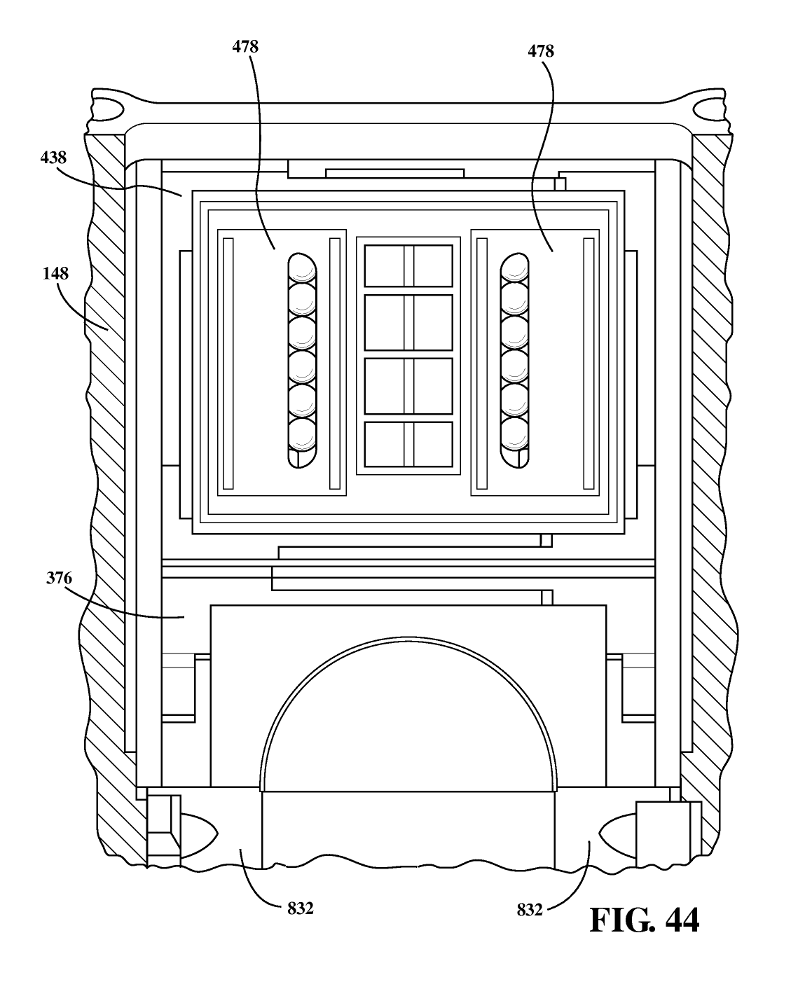

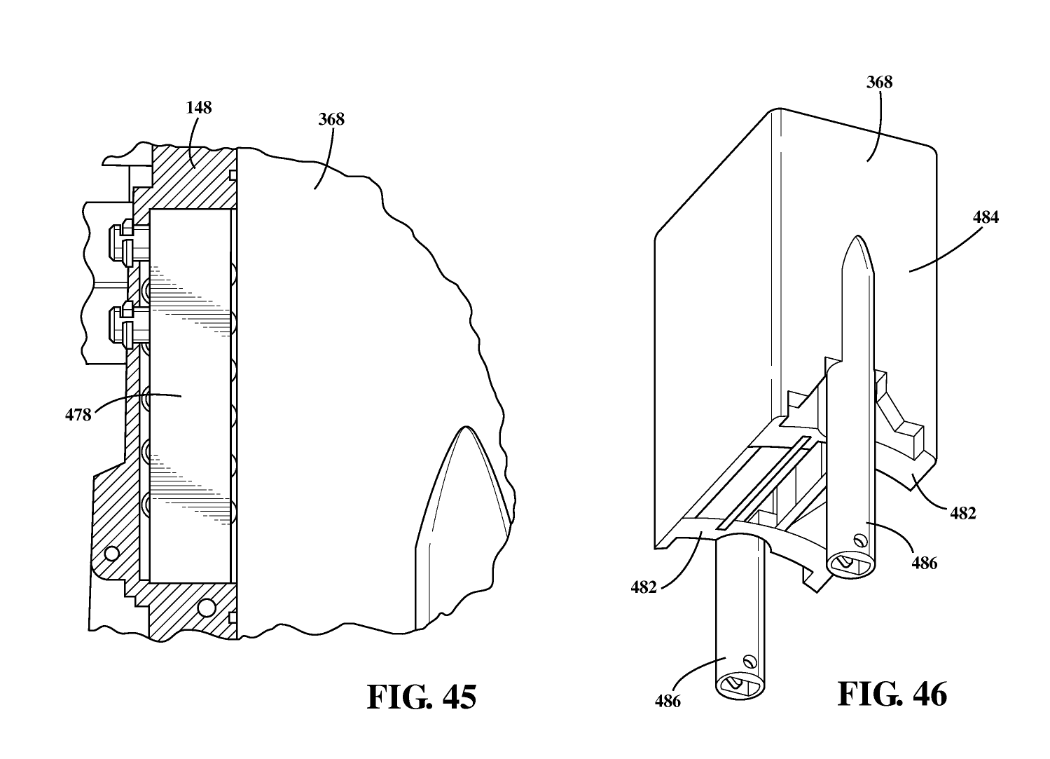

As best shown in FIGS. 44-45, the rotational engine assembly 100 further includes a plurality of bearing assemblies 476 with ball bearings 478 disposed in the vane chamber 354 and mounted the housing 102. The bearing assemblies 476 assist the movement of the vane 368 in the vane chamber 354. The ball bearings 478 of the bearing assemblies 478 abut the vane 368 to assist movement of the vane 368 in the vane chamber 354.

As best shown in FIG. 46, the vane 368 has a bottom end 480 with two pad surfaces 482. The vane 368 further has two vane sides 484 and two vane guide arms 486 along the two vane sides 484 and extending past the bottom end 480. The vane guide arms 486 of the vane 368 are disposed in the rail chambers of the rail structures 364 to guide the movement of the vane 368 in the vane chamber 354. The rail structures 364 define lubricant supply grooves 487 extending into the rail chamber 364 to lubricate the sliding interface between the vane guide arms 486 and the rail structures 364.

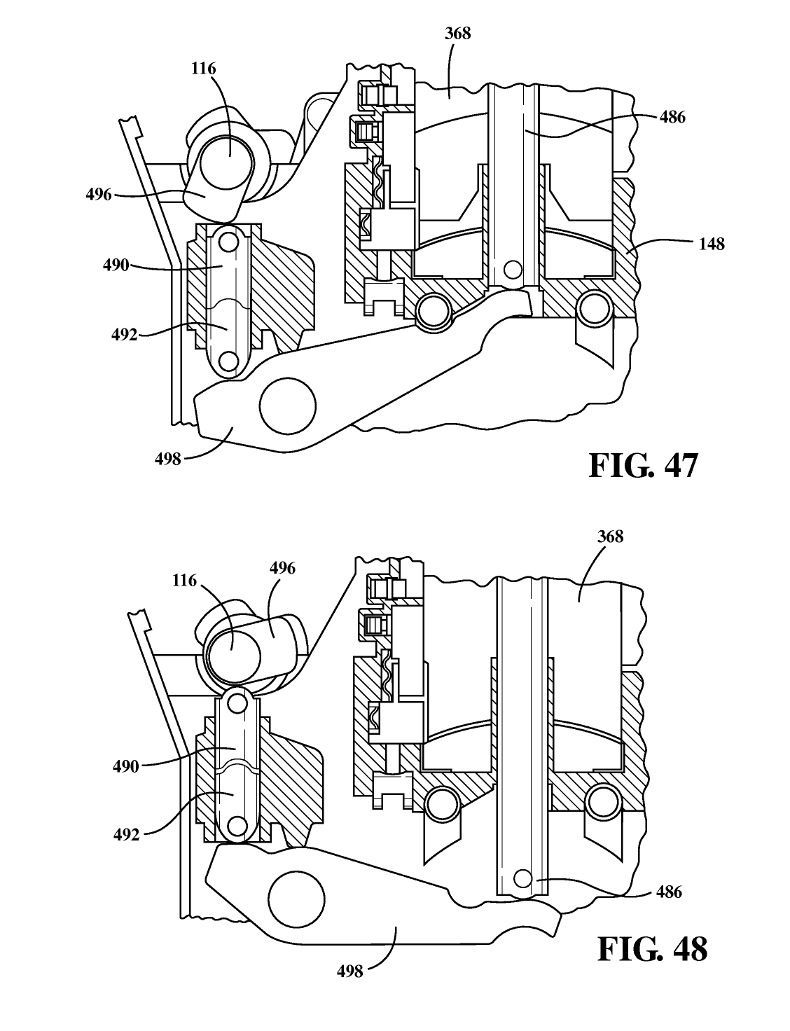

As best shown in FIG. 47-48, the rotational engine assembly 100 includes a camshaft lifter 488 movably mounted in the housing 102. The camshaft lifter 488 has an upper lifter 490 and a lower lifter 492. A gap 494 is defined in between the upper lifter 490 and the lower lifter 492. The upper lifter 490 and the lower lifter 492 are movable relative to each other. The camshaft 116 has a lobe 496 with a substantially lobular configuration. The lobe 496 facilitates downward movement of the upper lifter 490 until the upper lifter 490 and lower lifter 492 abut and the gap 494 is eliminated. The upper lifer 490 and the lower lifter 492 move as a unit as the vane 368 is actuated out of the lowered position. The upper lifer 490 and the lower lifter 492 are decoupled and define gap 494 as the vane 368 approaches the lowered position against the rotor seals 232. A lifter biasing member (not shown) is disposed between the upper lifer 490 and the lower lifter 492 to biases the upper lifer 490 and the lower lifter 492 from each other, such that when the vane 368 is in lowered position, the upper lifter 490 abuts the lobe 496 and the lower lifter 492 abuts the rocker arm 498. The rocker arm 498 abuts with vane guide arm 486.

The rotational engine assembly 100 includes a rocker arm 498 pivotably mounted in the housing 102 with a rod end 500 and an arm end 502. The camshaft lifter 488 abuts the rod end 500 of the rocker arm 498 and the vane guide arms 486 abut the arm end 502 of the rocker arm 498. As the camshaft 116 rotates, the lobe 496 facilitates movement of the camshaft lifter 488. The camshaft lifter 488 facilitates pivoting of the rocker arm 498. As the rocker arm 498 pivots, the rocker arm 498 facilitates movement of the vane guide arms 486 and the vane 368 in the vane chamber 354 between a raised position with the vane 368 disposed in the vane chamber 354 and a lowered position with the two pad surfaces 482 of the vane 368 abutting the two rotor seals 232 and the vane 368 is positioned relative to the rotor 192 in the vane cavity 186.

Turning back to FIG. 4, the vane 368 has a step surface 504 and two side surfaces 506 defining a combustion cavity 508. The step surface 504 has a step configuration for creating turbulent air flow and improving the mixing of air and fuel. The vane further has an exhaust surface 509.

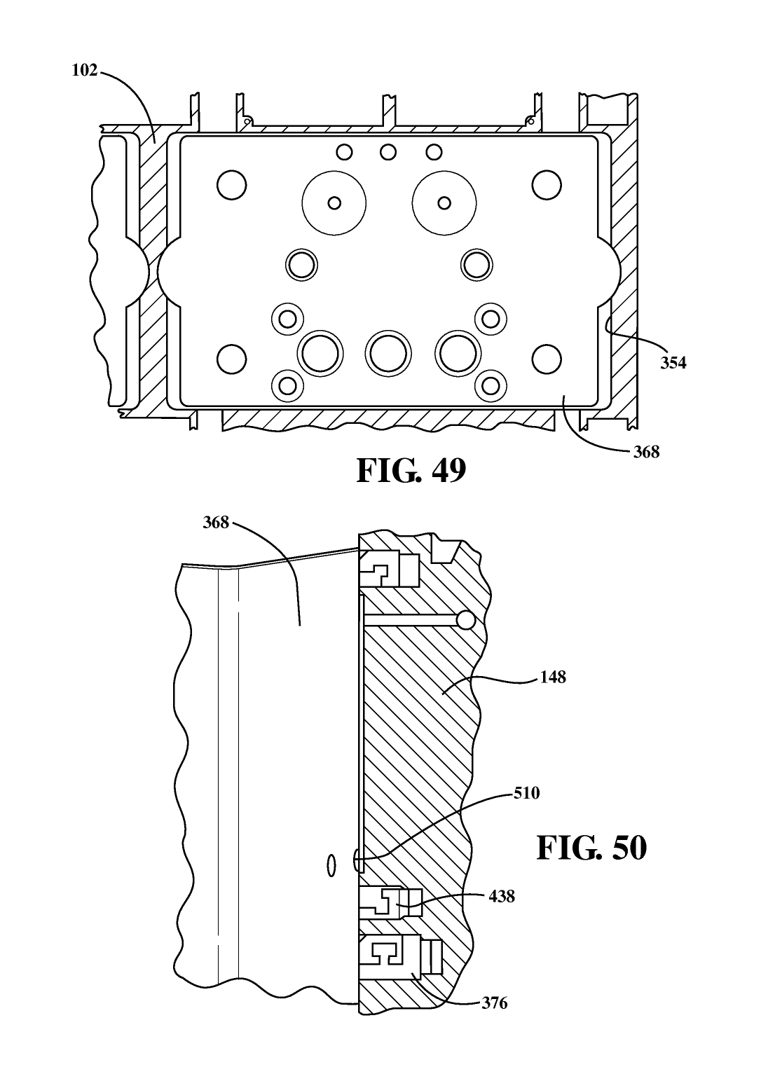

As best shown in FIGS. 49-50, the vane 368 defines a plurality of vane lubricant supply channels 510. Some of the plurality of housing lubricant supply channels extend into the vane chamber 354 through the combustion wall 360. The vane lubricant supply channels 510 are capable of aligning with and being in fluid communication with the plurality of housing lubricant supply channels extending into the vane chamber 354. The lubricant lubricates the movement of the vane 368 in the vane chamber 354 between the raised position and the lowered position.

The vane 368 defines a plurality of vane lubricant drain channels 512. Some of the plurality of housing lubricant drain channels extend into the vane chamber 354 through the exhaust wall 362. The vane lubricant drain channels 512 are capable of aligning with and being in fluid communication with the plurality of housing lubricant drain channels extending into the vane chamber 354. The lubricant is drained from the vane chamber 354 through the plurality of housing lubricant drain channels extending through the exhaust wall 362.

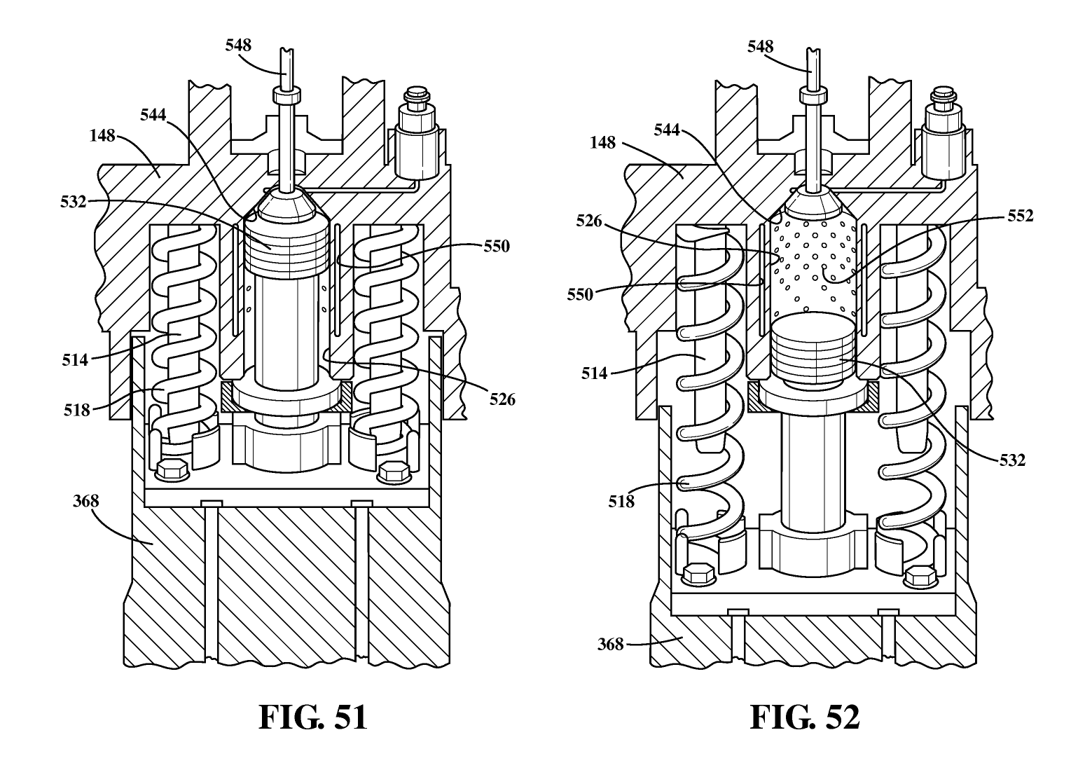

As best shown in FIGS. 51-52 the housing 102 has two biasing member rods 514 extending into the vane chamber 354 and the vane 368 defines two biasing structures 516. The housing 102 has two vane biasing members 518 disposed around the two biasing member rods 514. The two vane biasing members 518 abut the housing 102 and are further disposed in the two biasing structures 516. The two vane biasing members 518 bias the vane 368 toward the rotor end 356 of the vane chamber 354. The vane biasing members 518 further bias the vane 368 and the two vane guide arms 486 against the rocker arms 498 in the raised position. The vane 368 moves between the lowered position at the rotor end 356 of the vane chamber 354 and a raised position at the lock end 358 of the vane chamber 354. The vane biasing members 518 bias the vane 368 against the rotor seals 232 in the lowered position relative to the rotor 192. The vane 368 and the rotor 192 define a gap 520 between the vane 368 and the rotor surface 200 in the lowered position.

In another embodiment, the rotational engine assembly 100 includes a hydraulic lock 522 at least partially mounted to the housing 102. The housing 102 has a piston chamber wall 524 defining a piston chamber 526 with a first end 528 and a second end 530.

The vane 368 has a vane piston 532 and a vane piston rod 534 extending from the vane 368 and disposed in the piston chamber 526. The vane piston 532 has a top end 536 and defines a top cavity 538 in the piston chamber 526. The vane piston 532 has a bottom end 540 and defines a bottom cavity 542 in the piston chamber 526. The vane piston 532 is movable in the piston chamber 526 between a locked position with the vane 368 retained in the vane cavity 186 against the rotor seals 232 and an unlocked position with the vane 368 movable in the vane chamber 354.

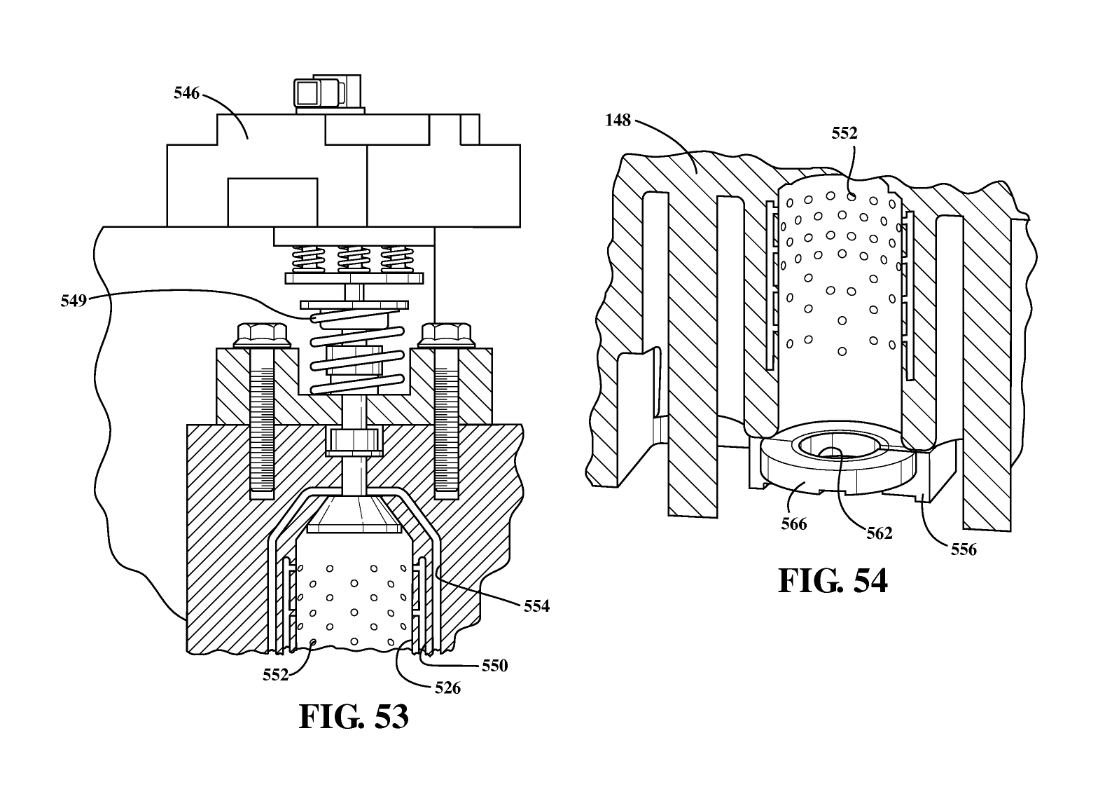

As best shown in FIGS. 51-53, the housing 102 further has a valve port 544 in fluid communication with the first end 528 of the piston chamber 526. The rotational engine assembly 100 includes a lock solenoid 546 mounted to the housing 102 and a solenoid valve 548 movably mounted to the lock solenoid 546 and disposed in the valve port 544. The lock solenoid further has a lock solenoid biasing member 549 biasing the solenoid valve 548 into the valve port 544. The solenoid valve 548 facilitates flow of hydraulic fluid into the piston chamber 526 as the lock solenoid 546 facilitates movement of the lock valve 548 out of the valve port 544. The solenoid valve 548 seals the valve port 544 and retains hydraulic fluid in the piston chamber 526 as the lock solenoid biasing member 549 retains the solenoid valve 548 in the valve port 544 for retaining the piston in the locked position and the vane 368 in the lowered position.

Turning back to FIGS. 51-53, the housing 102 defines a secondary cavity 550 around the piston chamber wall 524. The housing 102 additionally defines a plurality of perforations 552 in the piston chamber wall 524 extending between the piston chamber 526 and the secondary cavity 550 such that the piston chamber 526 and the secondary cavity 550 are in fluid communication between the piston chamber 526 and the secondary cavity 550.

The housing 102 defines a fluid channel 554 in fluid communication with the valve port 544 and the bottom cavity 542 of the piston chamber 526. The solenoid valve 548 facilitates flow of hydraulic fluid from the top cavity 538 of the piston chamber 526 through the valve port 544 and the fluid channel 554 to the bottom cavity 542 of the piston chamber 526 as the lock solenoid 546 facilitates movement of the lock valve 548 out of the valve port 544. The solenoid valve 548 seals the valve port 544 and retains hydraulic fluid in the top cavity 538 of the piston chamber 526 as the lock solenoid biasing member 549 retains the solenoid valve 548 in the valve port 544 for retaining the vane piston 532 in the locked position and the vane 368 in the lowered position.

As the vane piston 532 moves along the piston chamber 526, the hydraulic fluid flows between the top cavity 538 and the bottom cavity 542 through the valve port 544 and the fluid channel 554. The hydraulic fluid can also flow between the top cavity 538 and the bottom cavity 542 through the perforations 552 and the secondary cavity 550. As bet shown in FIG. 54, the number of perforations 552 defined in piston chamber wall 524 is reduced as the vane piston 532 moves along the piston chamber 526 towards the locked position. The reduced number of perforations 552 restricts the flow of hydraulic fluid between the piston chamber 526 and the secondary cavity 550. This restricted hydraulic fluid flow dampens at the downward movement of the vane piston 532 and the vane 368 as the vane 368 approaches the lowered position.

As the solenoid valve 548 is disposed in the valve port 544 and the vane piston 532 is in the locked position, the vane 368 is abutting the rotor seal 232 relative to the rotor 192 in the lowered position. The vane 368 moves to the raised position as the solenoid valve 548 is moved out of the valve port 544 and the vane piston 532 moves to the unlocked position. The vane 368 is disposed in the vane chamber 354 such that the two thrusters 235, 236 can rotate under the vane 368 as the vane 368 is in the raised position.

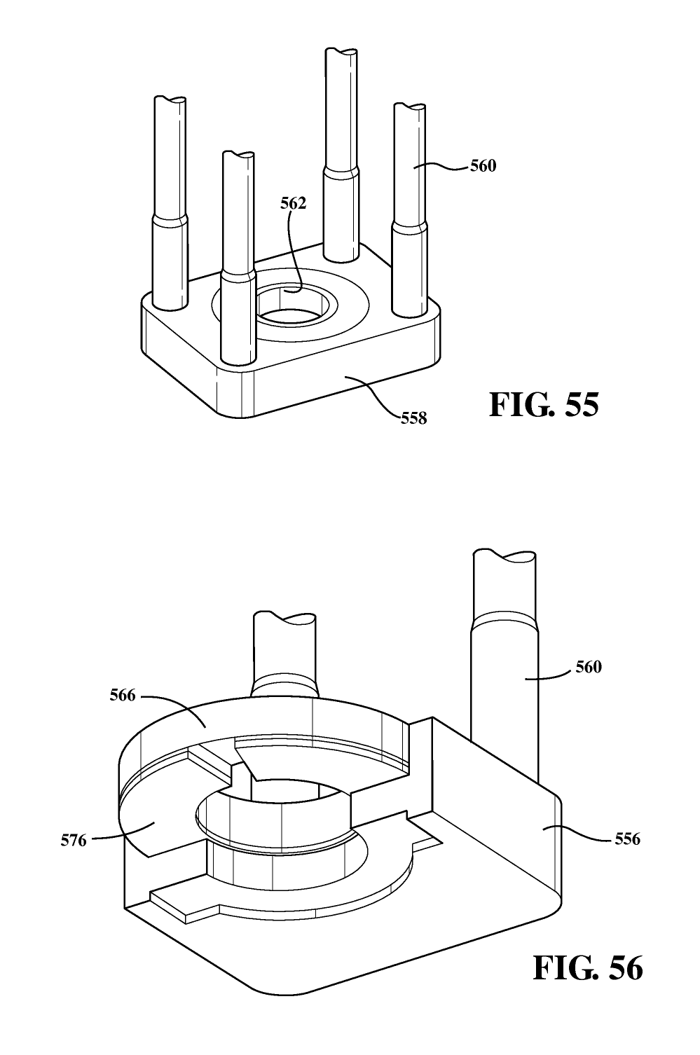

As best shown in FIGS. 51-52, the rotational engine assembly 100 has a cover plate 556 mounted to the housing 102 at the second end 530 of the piston chamber 526. Turning to FIG. 55, the cover plate 556 has a cover plate base 558 having a rectangular configuration. The cover plate base 558 defines four cover plate attachments rods 560 extending from the cover plate base 558. The four cover plate attachments rods 560 are bolted to the housing 102 to secure the cover plate base 558 to the second end 530 of the piston chamber 526. The cover plate base 558 defines a cover plate piston hole 562 extending through the cover plate base 558. The vane piston rod 534 of the vane 368 is movably disposed in the cover plate piston hole 562. The cover plate 556 has a cover plate gasket 564 mounted on the cover plate base 558 and disposed between the cover plate base 558 and the housing 102 relative to the piston chamber 526 to prevent any hydraulic fluid from bypassing the piston chamber 526.

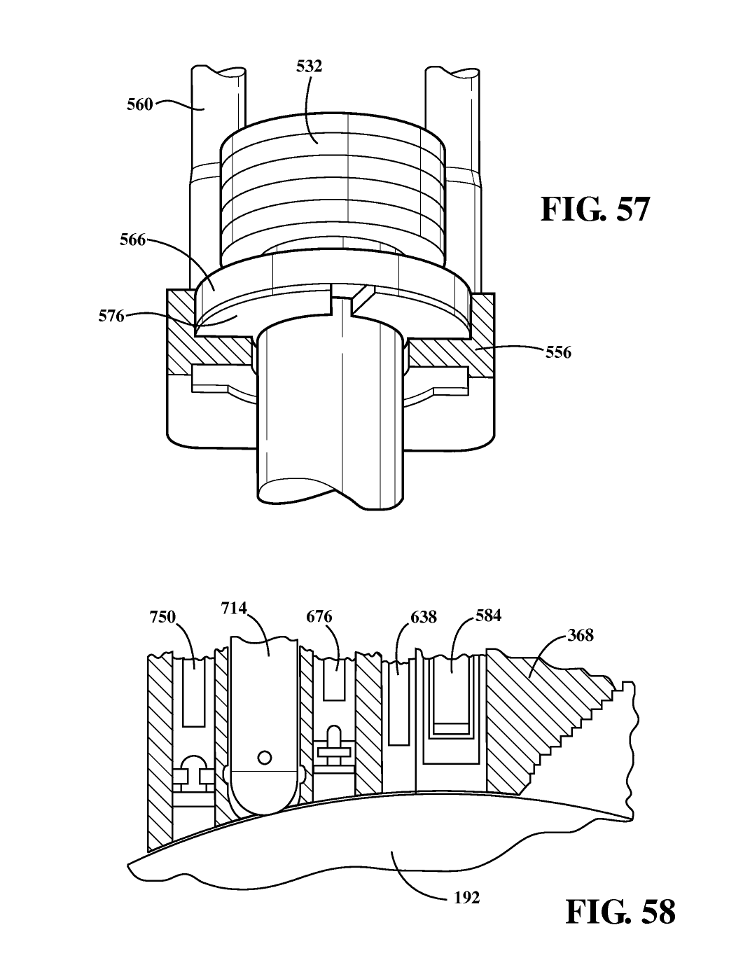

As best shown in FIGS. 56-57, the cover plate 556 has a vane piston rod seal 566 mounted in the cover plate piston hole 562 and abutting the vane piston rod 534 to prevent any hydraulic fluid from bypassing the piston chamber 526. The vane piston rod seal 566 simultaneously seals the vane piston rod 534, the cover plate 556, and the second end 530 of the piston chamber 526. The vane piston rod seal 566 has an inner diameter 568 and a plurality of spiral coil layers 570 wound tightly each over to create an overlapping and movable interface between spiral coil layers 570. The inner diameter 568 of the vane piston rod seal 566 is smaller than the vane piston rod 534. As the vane piston rod 534 moves through the vane piston rod seal 566 during assembly, the vane piston rod seal 566 conforms to the vane piston rod 534. The vane piston rod 534 is lubricated with hydraulic fluid from the piston chamber 526 reducing friction as the vane piston rod 534 moves in the vane piston rod seal 566.

The vane piston rod seal 566 has outer surface 572 and a bottom surface 574. The vane piston rod seal 566 has a first metal mesh pad 576 mounted to the outer surface 572. The first metal mesh pad 576 has a foil layer (not shown) disposed around the first metal mesh pad 576. The vane piston rod seal 566 has a second metal mesh pad 578 mounted to the bottom surface 574. The second metal mesh pad 578 has a foil layer (not shown) disposed around the second metal mesh pad 578.

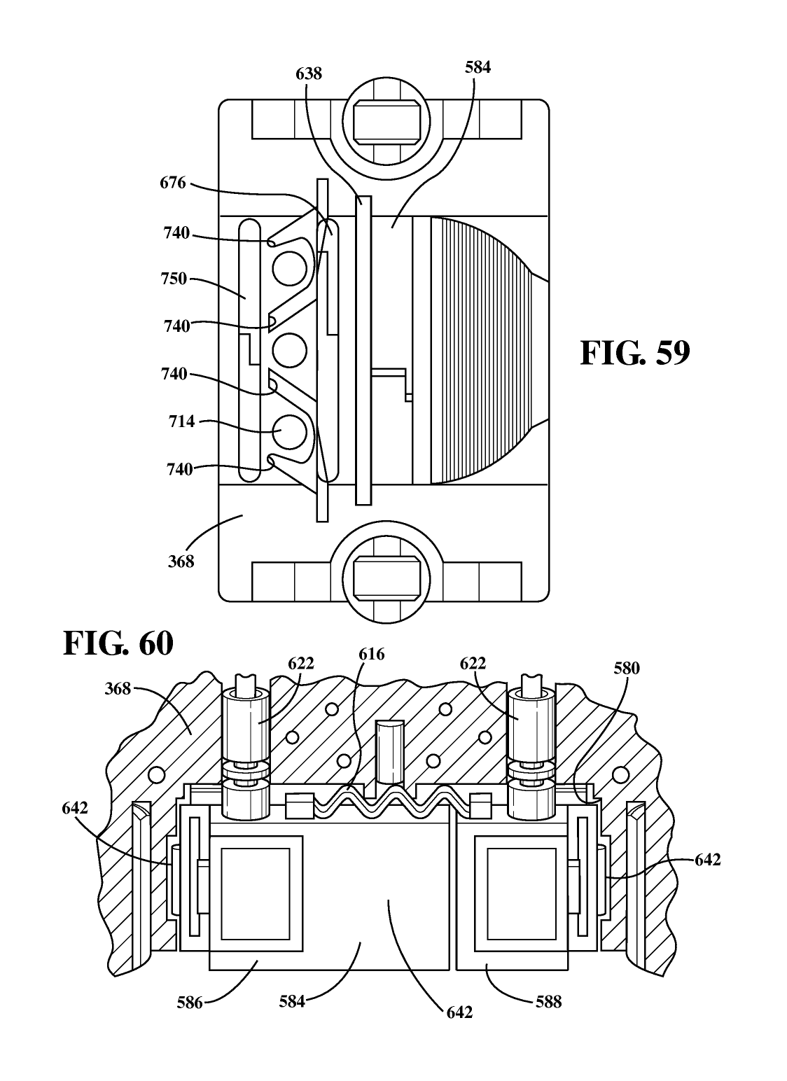

As best shown in FIG. 46, the vane 368 defines a vane compression seal chamber 580 with two side ends 582. Turning to FIG. 58-59, the vane 368 has a vane compression seal 584 disposed in the vane compression chamber 580 and movably mounted to the vane 368 relative to the step surface 504 of the vane 368. Further referring to FIG. 60, the vane compression seal 584 has a primary seal portion 586 movably mounted to the vane 368 and a secondary seal portion 588 movably mounted to the vane 368 and interfacing with the primary seal portion 586.

The primary seal portion 586 has a bottom surface 590 and the secondary seal portion 588 has a bottom surface 592. The bottom surfaces 590 of the primary seal portion 586 and the bottom surface 592 of the secondary seal portion 588 have a corresponding configuration with the rotor surface 200.

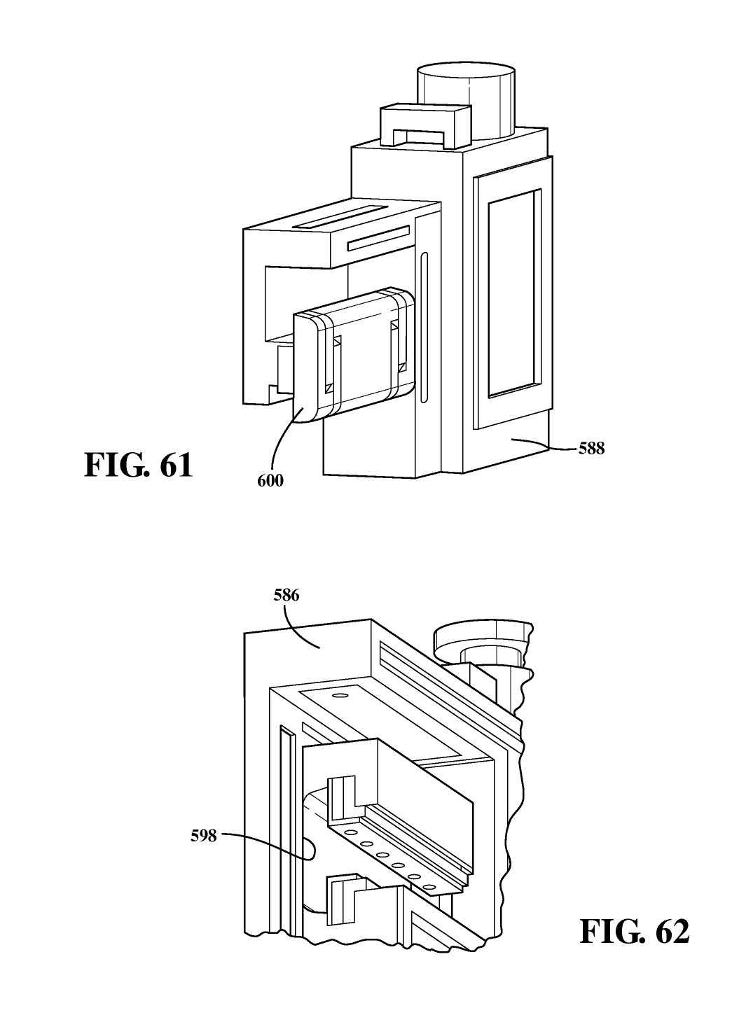

As best shown in FIG. 61, the primary seal portion 586 defines an interlock channel 598 with a T-shaped configuration. Turning to FIG. 62, the secondary seal portion 588 has an interlock protrusion 600 with a T-shaped configuration. The primary seal portion 586 and the secondary seal portion 588 overlap with the interlock protrusion 600 of the secondary seal portion 588 disposed in the interlock channel 598 of the primary seal portion 586. The primary seal portion 586 and the secondary seal portion 588 vertically move in the vane 368 as a unit. The primary seal portion 586 and the secondary seal portion 588 horizontally move separately for thermal expansion and contraction. However, it is to be appreciated that the interlock features can be reversed or any different configuration that maybe suitable for sealing.

The interlock channel 598 has contact surfaces 602 and the interlock protrusion 600 has mating surfaces 604. The contact surfaces 602 and mating surfaces 604 abut and define a gap 606 as the interlock protrusion 600 is disposed in the interlock channel 598. The vane compression seal 584 has a metal mesh pad 608 disposed between the contact surfaces 602 and the mating surfaces 604 to seal the gap 606. The metal mesh pad 608 has a foil layer (not shown) disposed around the metal mesh pad 608. Lubricant is circulated between the interlock protrusion 600 and the interlock channel 598 around the gap 606 to lubricant the horizontal movement of the primary seal portion 586 and the secondary seal portion 588. The metal mesh pad 608 and the foil layer is compressed between primary seal portion 586 and the secondary seal portion 588 and prevents high pressure gases from escaping the gap 606 from by-passing the vane compression seal 584.

The primary seal portion 586 defines an interface channel 610. The secondary seal portion 588 has an interface protrusion 612 with an L-shaped configuration. The interface protrusion 612 has a metal mesh pad 614 and a foil layer (not shown). The foil layer is disposed around the metal mesh pad 614. The primary seal portion 586 and the secondary seal portion 588 overlap with the interface protrusion 612 of the secondary seal portion 588 disposed in the interface channel 610 of the primary seal portion 586. The primary seal portion 586 and the secondary seal portion 588 vertically move in the vane 368 as a unit. The primary seal portion 586 and the secondary seal portion 588 horizontally move separately for thermal expansion and contraction. However, it is to be appreciated that the interface features can be reversed or any different configuration that maybe suitable for sealing.

Turning back to FIG. 60, the vane compression seal 584 has a wave biasing member 616 fixed to the primary seal portion 586 and the secondary seal portion 588. The wave biasing member 616 extends across the top surface 594 of the primary seal portion 586 and the top surface 596 of the secondary seal portion 588 and abuts the vane 368 to bias the vane compression seal 584 against the rotor surface 200. The vane compression seal 584 further has two seal dampers 618 to bias the vane compression seal 584 against the against rotor surface 200 and dampen upward movement of the vane compression seal 584 as the vane compression seal 584 contacts the rotor 192. The damping forms a quick seal between the rotor 192 and the vane compression seal 584 as the vane 368 reaches the lowered position and limits any bounce-off excitation of the vane compression seal 584.

As best shown in FIG. 61-62, the primary seal portion 586 and the secondary seal portion 588 define a plurality of lubricant grooves 620 in fluid communication with the vane 368 for facilitating lubricant flow between the vane 368 and the vane compression seal 584. The lubricant grooves 620 disperse the lubricant through the vane compression seal 584 to lubricate the movement of the vane compression seal 584 in the vane compression seal chamber 580. The lubricant also flows between the primary seal portion 586 and secondary seal portion 588 and circulates between the interface channel 610 and the interface protrusion 612 to lubricate thermal growth movement.

As best shown in, FIG. 60, the primary seal portion 586 and the secondary seal portion 588 each have a guide rod 622 extending from the top surfaces 594, 596. The vane 368 defines two guide cavities 624 extending into the vane compression seal chamber 580. The two guide rods 622 are disposed in the two guide cavities 624 to the guide the movement of the vane compression seal 584 in the vane compression seal chamber 580. The two guide rods 622 also locate the position of the primary seal portion 586 and the secondary seal portion 588 in the vane compression seal chamber 580. The vane compression seal 584 further has two outer ends 626. The two outer ends 626 of the vane compression seal 584 abut the two side ends 582 of the vane compression seal chamber 580.

One of the plurality of vane lubricant supply channels 510 extends into the two guide cavities 624. Lubricant is supplied to the two guide cavities 624 to lubricate the movement of the two guide rods 622. The vane compression seal 584 has ring seals 628 disposed around the guide rods 622 and abutting the guide cavities 624. The ring seals 628 prevent high pressure gases from by-passing the guide rods 622 and also prevents lubricant from bypassing the guide rods 622.

The vane compression seal 584 has front surface 630 and a plurality of metal mesh pads 632 mounted to the front surface 630. The plurality of metal mesh pads 632 and a plurality of foil layers (not shown). The plurality of foil layers are disposed around the plurality of metal mesh pads 632. The plurality of metal mesh pads 632 are compressed between the front face 630 of the vane compression seal 584 and the vane compression seal chamber 580. The plurality of metal mesh pads 632 conform to seal and prevent the by-pass of gases and lubricant.

The vane compression seal 584 has two end surfaces 634. The vane compression seal 584 further has a metal mesh pad 636 and a foil layer (not shown) mounted to the two end surfaces 634. The foil layers are disposed around the metal mesh pads 636. The metal mesh pads 636 are compressed between the two end surfaces 634 of the vane compression seal 584 and the vane compression seal chamber 580. Lubricant is circulated in the two end surfaces 634 between the vane 368 and the vane compression seal chamber 580. The metal mesh pads 636 conform to seal and prevent the by-pass of gases and lubricant.

As best shown in FIGS. 58-59 and 63, the vane 368 includes a trailing seal 638 is disposed in the vane compression seal chamber 580 and movably mounted to the vane 368 adjacent to the primary seal portion 586 and the secondary seal portion 588 of the vane compression seal 584. It should be appreciated that the trailing seal 638 will be discussed in further detail later in the detailed description of the invention.

As best shown in FIG. 64, the vane compression seal 584 defines a gap 640 between the primary seal portion 586 and the secondary seal portion 588. The high pressure gases flow into the gap 640 and bias the primary seal portion 586 and the secondary seal portion 588 against the trailing seal 638. The high pressure gases also bias the primary seal portion 586 and secondary seal portion 588 away from each other such that the two outer ends 626 of the vane compression seal 584 abut the two end surfaces 634 of the vane compression seal chamber 580.

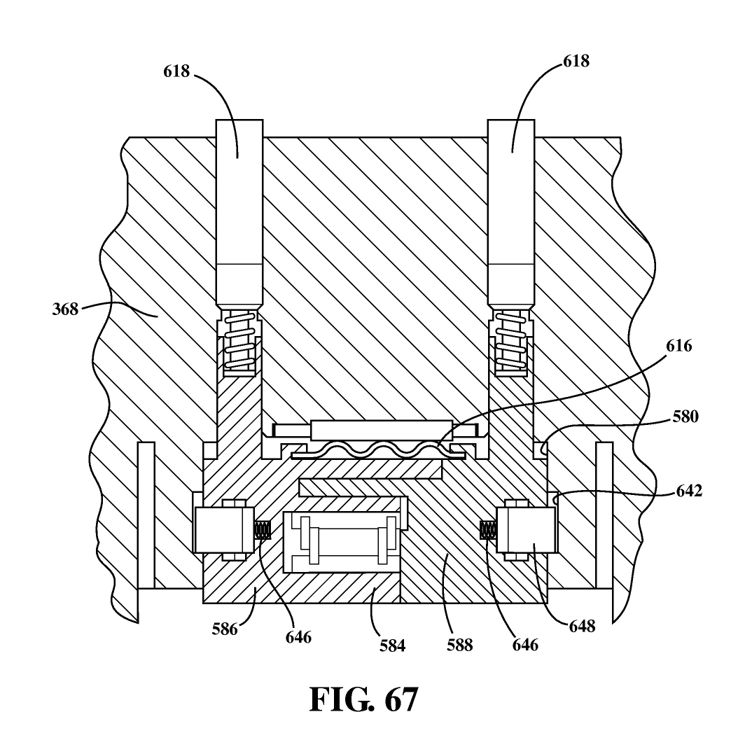

Turning to FIGS. 67 and 69, the vane compression seal chamber 580 defines two retention cavities 642. The vane compression seal 584 defines two retainer plates 648 disposed in the two retainer plate chambers 644. The vane compression seal 584 further has two retainer biasing members 646. The two retainer biasing members 646 are disposed in the two retainer plate chambers 644 and mounted to the vane compression seal 584. The two retainer plates 648 are mounted to the two retainer biasing members 646 and are moveable into and away the two retainer plate chambers 644. As the vane compression seal 584 is installed into the vane 368, the two retainer biasing members 646 and the two retainer plates 648 are compressed into the two retainer plate chambers 644. As the two retainer biasing members 646 and the two retainer plates 648 are aligned with the corresponding two retention cavities 642, the two retainer biasing members 646 are decompressed and dispose the two retainer plates 648 in the two retention cavities 642.

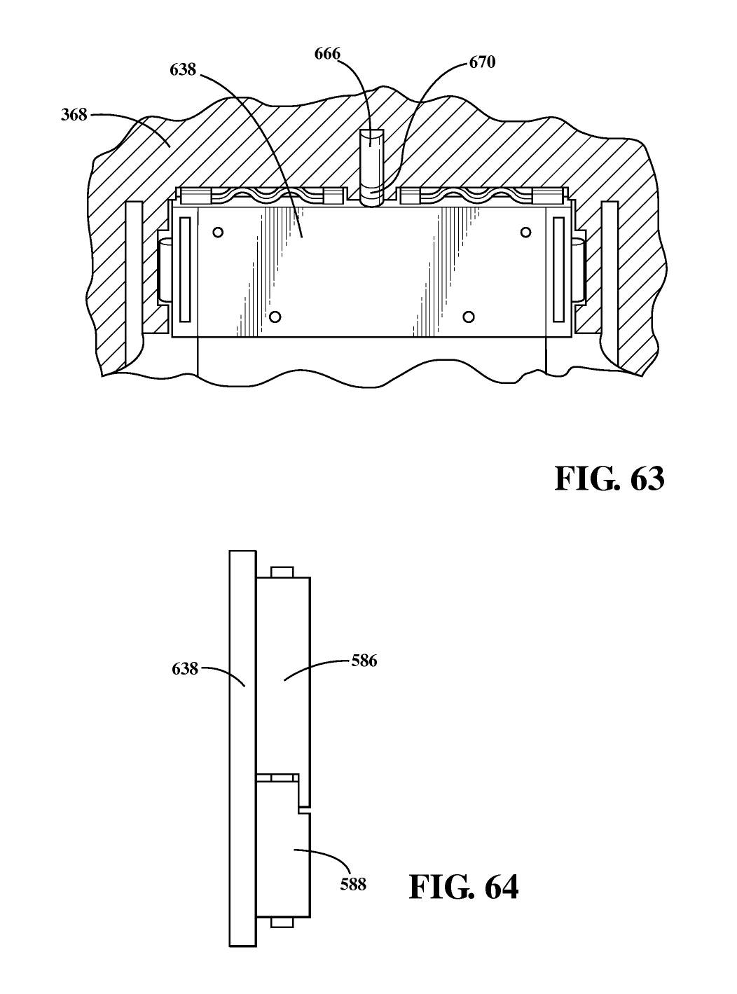

As best shown in FIG. 58, the trailing seal 638 has a bottom surface 650 with a corresponding configuration to the rotor surface 200 and the rotor seals 232. Turning to FIG. 63, the trailing seal 638 further has a top surface 652 and two wave biasing members 654 mounted to the top surface 652. The wave biasing members 654 bias the trailing seal 638 towards the rotor surface 200 and the rotor seals 232.

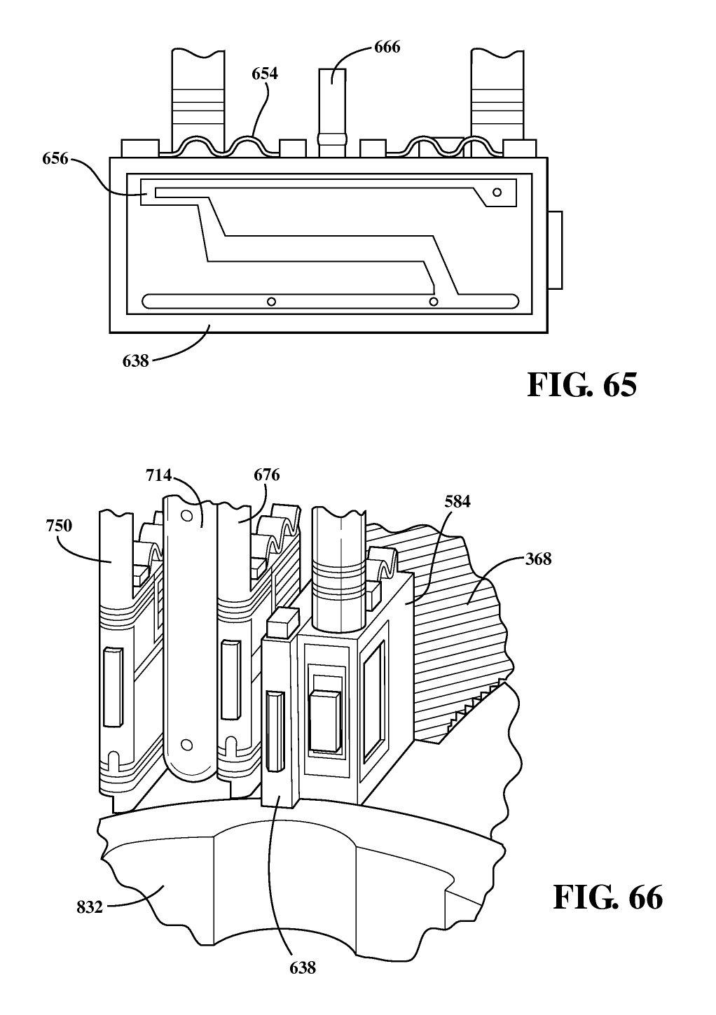

As best shown in FIG. 64-65, the trailing seal 638 defines a trailing channel 656 in fluid communication with the lubricant grooves 620 of the primary seal portion 586 and the secondary portion 588 of the vane compression seal 584 for facilitating lubricant flow between said vane compression seal 584 and the trailing seal 638. The lubricant lubricates the movement of the trailing seal 638 between the vane 368 and the vane compression seal 584.

The lubricant also forms a seal between the vane compression seal 584 and the trailing seal 638 and the vane compression seal chamber 580. The trailing seal 638 prevents combustion gases that bypass the vane compression seal 584 from bypassing the vane 368. The trailing seal 638 is greater in width than the vane compression seal 584. The width of the vane compression seal 584 is equal to the width of the rotor 192. The outer ends 626 of the vane compression seal 584 are aligned with the primary surface 194 and the secondary surface of the rotor 192. The bottom surface 650 of the trailing seal 638 abuts the rotor and the rotor seals 232. The trailing seal 638 has two ends 658.

As show in FIG. 66, the primary seal portion 586 and the secondary seal portion 588 adjust to compensate, as the bottom surfaces 590, 592 of the primary seal portion 586 and the secondary seal portion 588 deteriorate. As the bottom surface 650 of the trailing seal 638 deteriorates, the vertical travel of the trailing seal 638 will not change and will no longer abut the rotor 192 but the trailing seal 638 will still abut the rotor seals 232. A small gap (not shown) is defined between the bottom surface 650 of the trailing seal 638 and the rotor surface 200 as the bottom surface deteriorates. The primary seal portion 586 and the secondary seal portion 588 will enclose the small gap.

Turning back to FIG. 64, the trailing seal 638 has a front surface 660 and a rear surface 662. The trailing seal 638 further has metal mesh pad 664 and a foil layer (not shown) mounted to the front surface 660 and the rear surface 662. The foil layers are disposed around the metal mesh pads 664. The metal mesh pads 664 of the trailing seal 638 abut the vane compression seal 584 and the vane compression seal chamber 580. The metal mesh pads 664 and the foil layers are compressed as the vane compression seal 584 is installed into the vane compression seal chamber 580 to seal and prevent high pressure gases and lubricant from by-passing the vane compression seal 584.

As best shown in FIG. 63, the trailing seal 638 has a guide rod 666 extending from the top surface 652. The vane 368 defines a guide cavity 668. The guide rod 666 is disposed in the guide cavity 668 as the trailing seal 638 is inserted into the vane 368. The guide rod 666 locates the trailing seal 638 and guides the movement of the trailing seal 638 in the vane compression seal chamber 580.

One of the plurality of vane lubricant supply channels 510 extends into the guide cavity 668. Lubricant is supplied to the guide cavity 668 to lubricate the movement of the guide rod 666. A metal mesh pad 670 and a foil layer (not shown) are mounted to the guide rod 666 and abuts the guide cavity 668. The metal mesh pad 670 and the foil layer prevent lubricant from by-passing the guide rod 666.

As best shown is FIG. 63, a gap 672 is also defined between the top surfaces 594, 596 of the vane compression seal 584 and the top surface 652 of the trailing seal 638. The high pressure gases also flows into the gap bias the vane compression seal 584 and the trailing seal 638 against the rotor surface 200.

As best shown in FIG. 58-59, the vane 368 defines a vane lubricant seal chamber 674 relative to the trailing seal 638. The vane 368 has a vane lubricant seal 676 disposed in the vane lubricant chamber 580 and movably mounted to the vane 368. The vane lubricant seal 676 has a bottom surface 678 and a top surface 680. The vane lubricant seal 676 has a primary seal portion 682 movably mounted to the vane 368 and a secondary seal portion 684 movably mounted to the vane 368 and interfacing with the primary seal portion 682.

The bottom surface 678 of the vane lubricant seal 676 has a corresponding configuration with the rotor surface 200. The primary seal portion 682 and the secondary seal portion 684 overlap and define a gap 686 between the primary seal portion 682 and the secondary seal portion 684. The gap 686 allows the primary seal portion 682 and the secondary seal 684 portion to thermally expand and contract.

The primary seal portion 682 defines an interface channel 688. The secondary seal portion 684 has an interface protrusion structure 690. The primary seal portion 682 and the secondary seal portion 684 vertically move in the vane 368 as a unit. The primary seal portion 682 and the secondary seal portion 684 horizontally move separately for thermal expansion and contraction. However, it is to be appreciated that the interface features can be reversed or in any different configuration that maybe suitable for sealing.

The interface protrusion structure 690 has a metal mesh pad 691 and a foil layer. The foil layer is disposed around the metal mesh pad 691. The primary seal portion 682 and the secondary seal portion 684 overlap with the interface protrusion structure 690 of the secondary seal portion 684 disposed in the interface channel 688 of the primary seal portion 682. The metal mesh pad 691 is compressed between the primary seal portion 682 and the secondary seal portion 684. Lubricant flows through the interface channel 688 overlap sections to seal between the primary seal portion 682 and the secondary seal portion 684 and lubricate the horizontal movement that occurs with thermal expansion and contraction.

The vane lubricant seal 676 has a wave biasing member 693 mounted to the top surface 680. The wave biasing member 693 bias the vane lubricant seal 676 against the rotor surface 200 as the vane 368 is in the lowered position. The vane lubricant seal 676 further has a two guide rods 695 extending from the top surface. The vane defines two guide rod cavities 697. The two guide rods 695 of the vane lubricant seal 676 are disposed in the two guide rod cavities 697 of the vane 368.

The vane lubricant seal 676 has two outer ends 699. The two guide rods 695 direct the movement of the vane lubricant seal 676 within the vane lubricant seal chamber 674 and locate the two outer ends 699 of the of the vane lubricant seal 676 against the vane lubricant seal chamber 674. The two outer ends 699 of the vane lubricant seal 676 are aligned with the rotor 192. The width of vane lubricant seal 676 is equal to the width of the rotor 192. A rod groove seal 701 is disposed around the two guide rods 695. The two rod groove seals 701 abut the two guide rod seal cavities 678. Lubricant is supplied by the vane 368 to lubricate the movement of the two guide rods 695 in the two guide rod cavities 697. The two rod groove seals 701 prevent lubricant from by-passing the two guide rods 695.

The vane lubricant seal 676 has dampers 703 mounted to the vane 368 and disposed between the vane 368 and each the two guide rods 695. The two dampers 703 include vertical biasing members 705 that further bias the vane lubricant seal 676 against the rotor surface 200 and dampen the upward movement of the vane lubricant seal 676 in the vane lubricant seal chamber 674 as the vane lubricant seal 676 initially abuts the rotor surface 200 and the vane 368 is moving towards the rotor surface 200 and the lowered position. The wave biasing member 693 and the two dampers 703 quickly form a seal between the vane lubricant seal 676 to the rotor surface 200 as the vane 368 reaches the lowered position by limiting any bounce-off excitation of the vane lubricant seal 676.

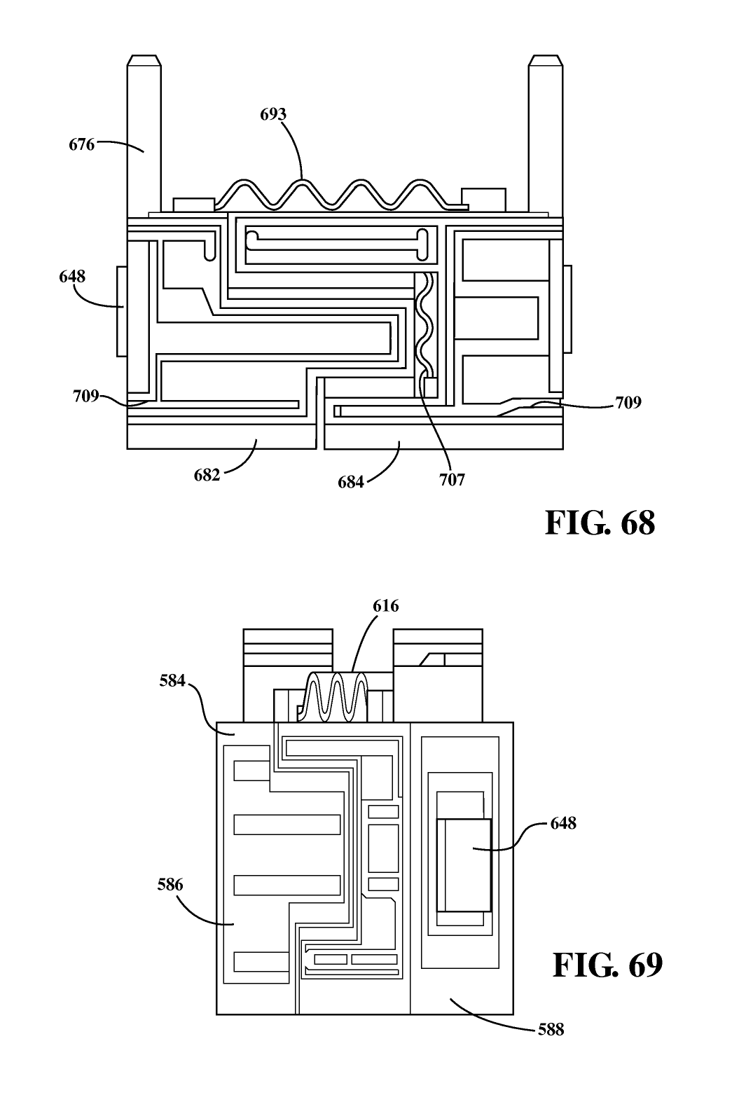

As best shown in FIG. 68, The vane lubricant seal 676 has a separation biasing member 707 mounted between the primary seal portion 682 and the secondary seal portion 684. The separation biasing member 707 biases the primary seal portion 682 and the secondary seal portion 684 away from each other such that the outer ends 680 are biased against the vane lubricant seal chamber 674 to ensure a sealing interface between the outer ends 680 and the vane lubricant seal chamber 674.

The vane lubricant seal 676 defines a lubricant channel 709 in fluid communication with one of the plurality of vane lubricant supply channels 510 for facilitating lubricant flow between the vane 368 and the vane lubricant seal 676. The lubricant channel 709 disperses the lubricant through the vane lubricant seal 676 to lubricate the movement of the vane lubricant seal 676 in the vane lubricant seal chamber 674. The vane lubricant seal 676 prevents lubricant between the vane 368 and the rotor surface 200 from bypassing the vane 368.

The vane lubricant seal 676 has a front surface 692 and rear surface 694. The vane lubricant seal 676 further has two end surfaces 996. The vane lubricant seal 676 has a metal mesh pad 696 and a foil layer (not shown) mounted to the front surface 692, the rear surface 694, and the two end surface 996. The foil layer is disposed around the metal mesh pad 696. The metal mesh pads 696 and the foil layers are compressed between the vane lubricant seal 676 and the vane lubricant seal chamber 674. The compression of the metal mesh pads 696 and the foil layers form a continuous seal between the vane lubricant seal 676 and the vane lubricant seal chamber 674 to prevent the by-pass of gases and lubricant.

Turning back to FIG. 67, the vane lubricant seal chamber 674 defines two retention cavities 698. The vane lubricant seal 676 defines two retainer plate chambers 700. The vane lubricant seal 676 further has two retainer biasing members 702 and two retainer plates 648. The two retainer biasing members 702 are disposed in the two retainer plate chambers 700 and mounted to the vane lubricant seal 676. The two retainer plates 704 are mounted to the two retainer biasing members 702 and are moveable into and from the two retainer plate chambers 700. As the vane lubricant seal 676 is installed into the vane 368, the two retainer biasing members 702 and the two retainer plates 704 are compressed into the two retainer plate chambers 644. As the two retainer biasing members 702 and the two retainer plates 704 are aligned with the corresponding two retention cavities 698, the two retainer biasing members 702 are decompressed and dispose the two retainer plates 704 in the two retention cavities 698.

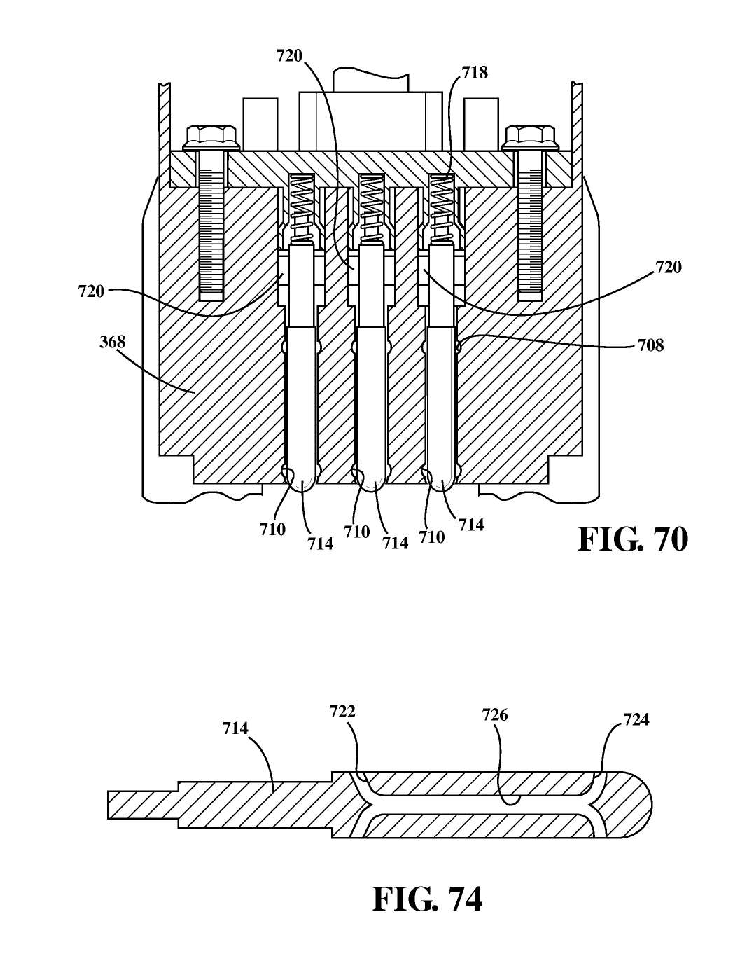

As best shown in FIG. 70, the vane 368 defines three valve chambers 706 relative to the vane lubricant seal chamber 674 and extending into the rotor interior 164. The vane 368 further defines an inlet pocket 708 extending into each valve chamber 706. The vane 368 additionally defines an outlet pocket 710 extending into each valve chamber 706 spaced from the inlet pocket 708. Each inlet pocket 708 is in fluid communication with the vane 368. However, it is to be appreciated that the vane 368 may define any number of valve chambers 706 suitable for lubricating the rotor 192.

The vane 368 has three vane valves 714 disposed in the three valve chambers 706 and movably mounted to the vane 368. The three vane valves 714 can move between an open position and a closed position. The three vane valves 714 have a valve protrusion 716 and a valve protrusion biasing member 718. The valve protrusion biasing members 718 are disposed around the valve protrusions 716 between the vane valves 714 and the vane 368 to bias the three vane valves 714 in the closed position as the vane 368 is moved from the lowered position. The three vane valves 714 abut the rotor surface 200 and compress the valve protrusion biasing members 718 in the open position. The three vane valves 714 further have valve seals 720 mounted to the valve chambers 706. The valve seals 720 prevent lubricant from by-passing the inlet pocket 708 and flowing into the vane 368. However, it is to be appreciated that the vane 368 may have any number of vane valves 714 suitable for lubricating the rotor 192.

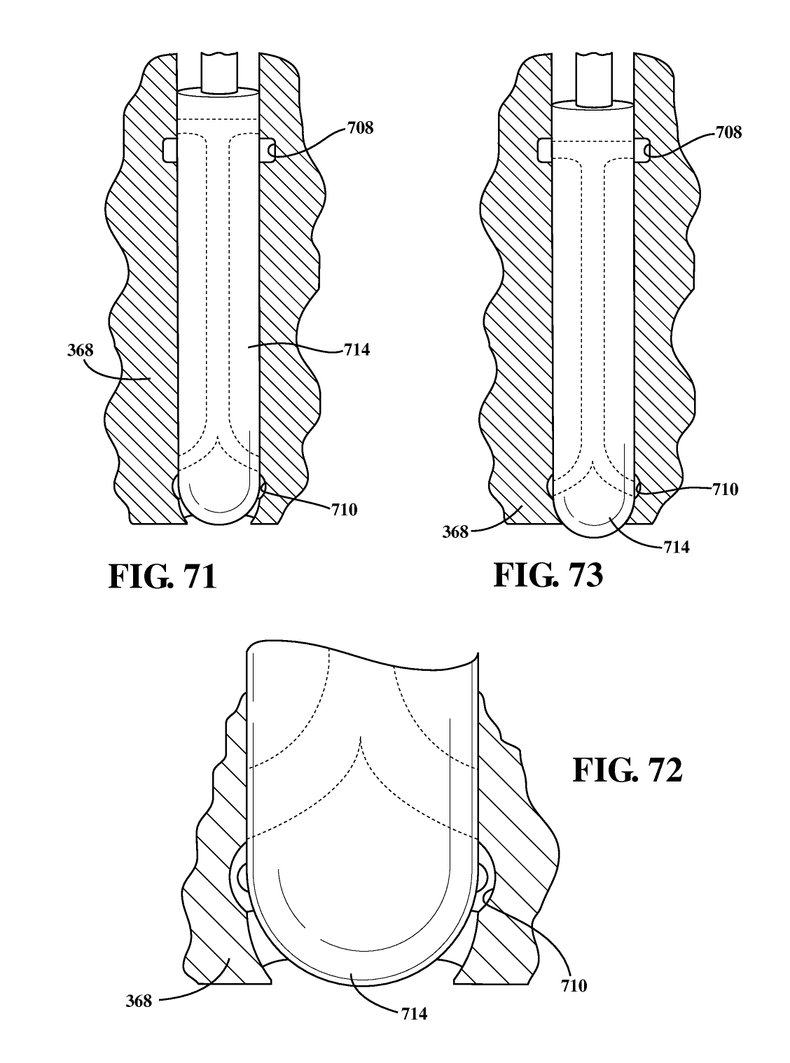

As best shown in FIG. 71-72, the vane valve 714 is in the open position. As the three vane valves 714 are in the open position, the outlet pockets 710 are in fluid communication with the vane valve chambers 706 and the rotor surface 200. As best shown in FIG. 73, the vane valve 714 is in the closed position. As the three vane valves are in the closed position, the three vane valves 714 are disposed between the vane valves chambers 706 and the outlet pockets 710 such that the outlet pockets 710 are not in fluid communication with the vane valves chamber 706 and the rotor surface 200

As best shown in FIG. 74, the three vane valves 714 define a valve inlet 722 and a valve outlet 724 spaced from the valve inlet 722. The three vane valves 714 further define a valve conduit 726 in fluid communication with the valve inlet 722 and the valve outlet 724. As the three vane valves 714 are in the closed position, the valve inlets 722 align with the inlet pockets 708 and the valve outlets 724 align with the outlet pockets 710. The lubricant flows from the inlet pockets 708 through the valve conduits 726 and into the outlet pockets 710 as the three vane valves 714 are in the closed position. As the three vane valves 714 are in the open position, the lubricant flows from the outlet pockets 710 through the vane valve chambers 706 and onto the rotor surface 200 to lubricate and seal between the rotor 192 and the vane 368. As the three vane valves 714 are in the open position, the valve inlets 722 are not in fluid communication with the inlet pockets 708 and do not allow lubricant to flow from the inlet pockets 708 to the outlet pockets 710.

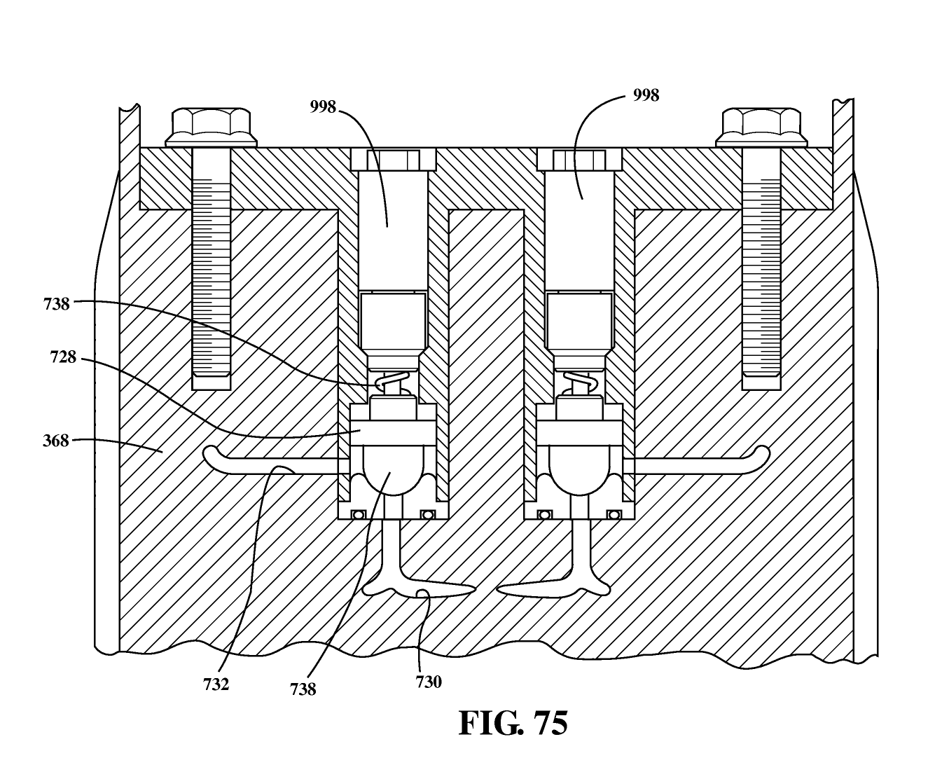

As best shown in FIG. 75, the rotational engine assembly 100 includes two lubricant pressure regulators 728 disposed in and mounted to the vane 368. The vane 368 defines a plurality of regulator lubricant channels 730 and a plurality of regulator drain channels 732. The inlet pockets 708 are in fluid communication with the vane lubricant supply channels 510 and the regulator lubricant channels 730. The regulator drain channels 732 are in fluid communication with the vane lubricant supply channels. One of the two lubricant pressure regulators 728 is in fluid communication with the plurality of the inlet pockets 708. The other of the two lubricant pressure regulators 728 is in fluid communication with one of the plurality of vane lubricant drain channels 512 to regulate the pressure level 736 of lubricant supplied to the vane seals in the vane 368.

The two lubricant pressure regulators 728 have a pressure valve 734 defining a pressure level 736 at which the two lubricant pressure regulators 728 will facilitate movement of the pressure valves 734. The two lubricant pressure regulators 728 have pressure valve biasing members 738 mounted to the pressure valves 734. The pressure valve biasing members 738 bias the pressure valve 734 in the closed position. The vane 368 has two dampers 998 mounted the vane 368 and disposed between the vane 368 and the pressure valves 734. The dampers 998 restrict movement of the pressure valves 734 that may be influenced by the movement of the vane between the raised position and the lowered position.

The pressure valves 734 have a closed position allowing the pressure of the lubricant flow into the inlet pockets 708 to increase to the defined pressure level 736. The pressure valves 734 also have an open position facilitating flow of lubricant from the inlet pockets 708 into one of the plurality of vane lubricant drain channels 512. The pressure valves 734 are biased to the closed position by the pressure valve biasing members 738. As the pressure of the lubricant in the inlet pockets 708 exceeds the defined pressure level 736, the pressure valves 734 are moved to the open position compressing the pressure valve biasing members 738 and facilitating lubricant flow from the inlet pockets 708. A portion of the lubricant is then removed from the inlet pockets 708 of the vane 368 through the plurality of regulator drain channels 732. As the pressure of the lubricant in the inlet pockets 708 falls below the defined pressure level 736, the pressure valves 734 are moved to the closed position by the biasing of the pressure valve biasing members 738 and facilities lubricant pressure to increase in the inlet pockets 708.

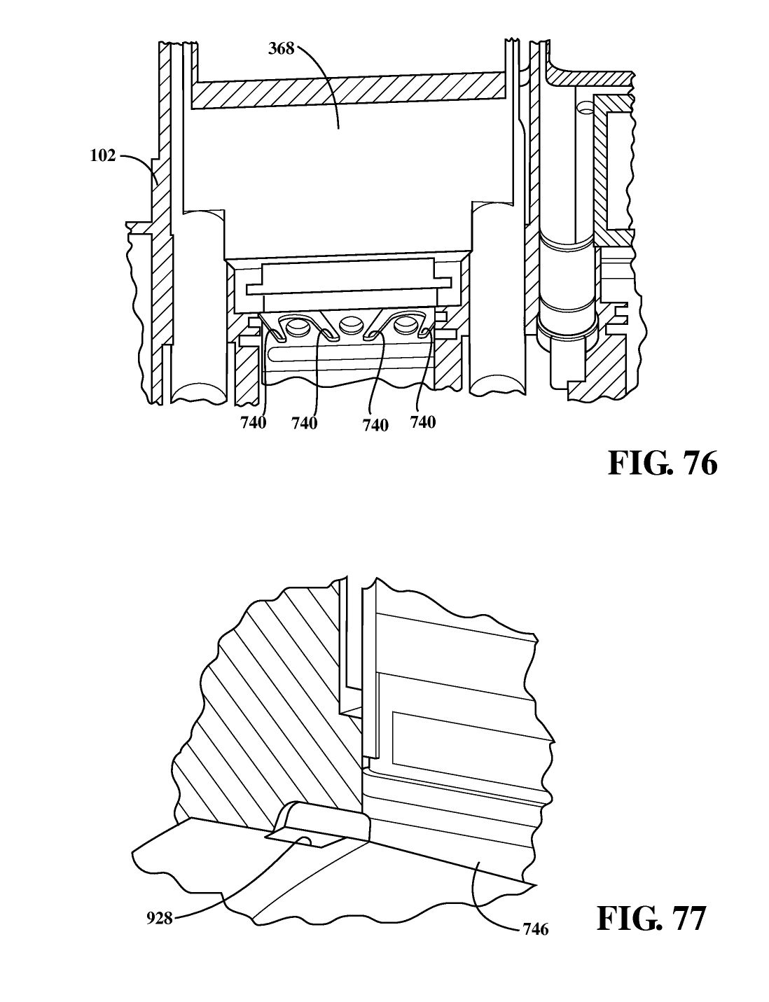

As best shown in FIG. 59, the vane 368 defines a plurality of recessed pockets 740 on the bottom surface 382 of the vane 368. As the vane 368 is in the lowered position and the rotor 192 rotates, lubricant between the bottom surface 382 of the vane 368 and the rotor surface 200 of the rotor 192 collects in the recessed pockets 740. The vane 368 has a plurality of groove surfaces 742 partially defining a plurality of drain grooves 744 on the bottom surface 382 of the vane 368. As best shown in FIGS. 76-77, the vane lubricant seal 676 defines a drain cutout 746 extending through the bottom surface 382 of the vane lubricant seal 676. The drain cutout 746 of the vane lubricant seal 676 and the groove surfaces 742 of the vane 368 form a plurality of drain grooves 744. The plurality of recessed pockets 740 are in fluid communication with the plurality of drain grooves 744. The recessed pockets 740 have a flared profile forming a wedge configuration to enable the spinning rotor 192 to bias lubricant toward the sides of the rotor 192 from the recessed pockets 740 through the drain grooves and the drain cutout 744. As best shown in FIG. 10, the vane further has a plurality of vane lubricant supply channels 510 and a plurality of vane lubricant drain channels 512 as the rotor 192 rotates.

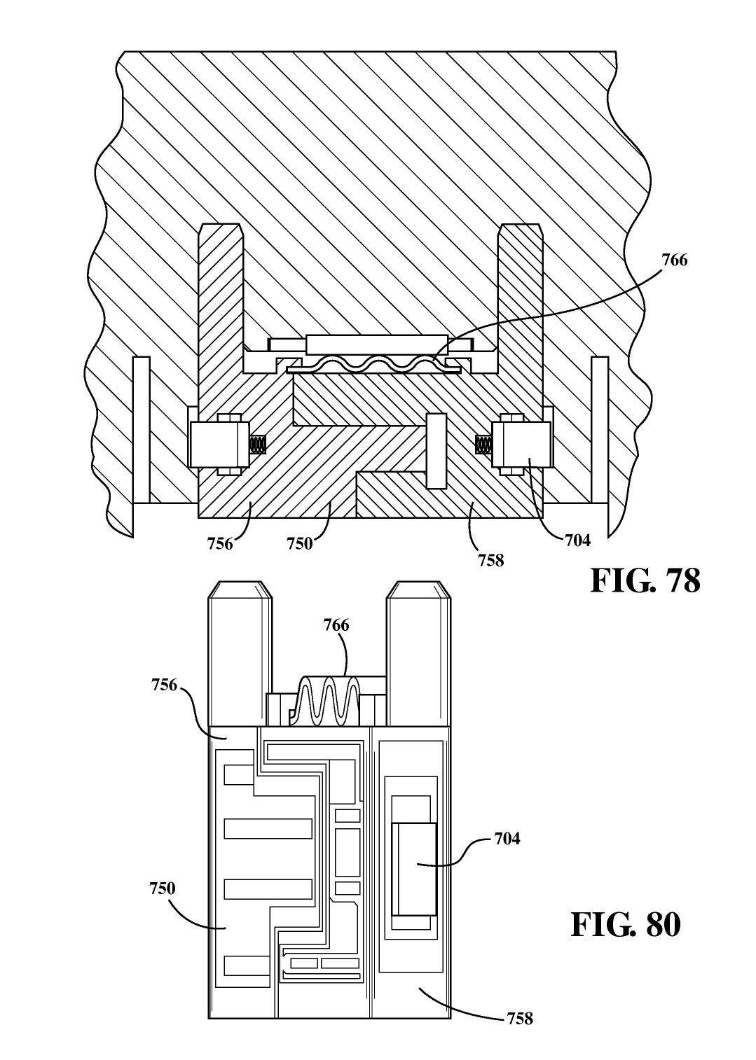

As best shown in FIG. 58-59, the vane 368 defines a vane exhaust seal chamber 748 relative to the vane lubricant seal chamber 674. The vane 368 includes a vane exhaust seal 750 disposed in the vane exhaust seal chamber 748 and movably mounted to the vane 368. Turning to FIG. 78, the vane exhaust seal 750 has bottom surface 752 and a top surface 754. As best shown in FIG. 77, the vane exhaust seal 750 has a primary seal portion 756 movably mounted to the vane 368 and a secondary seal portion 758 movably mounted to the vane 368 and interfacing with the primary seal portion 756.

The bottom surface 752 of the vane exhaust seal 750 has a corresponding configuration to the rotor surface 200. The primary seal portion 756 and the secondary seal portion 758 overlap and define a gap 760 between the primary seal portion 756 and the secondary seal portion 758. The gap 760 allows the primary seal portion 756 and the secondary seal portion 758 to thermally expand and contract.

The primary seal portion 756 defines an interface channel 762. The second seal portion has an interface protrusion structure 764. The primary seal portion 756 and the secondary seal portion 758 vertically move in the vane 368 as a unit. The primary seal portion 756 and the secondary seal portion 758 horizontally move separately for thermal expansion and contraction. However, it is to be appreciated that the interface features can be reversed or any different configuration that maybe suitable for sealing.

The interface protrusion structure 764 has a metal mesh pad 768 and a foil layer (not shown). The foil layer is disposed around the metal mesh pad 768. The primary seal portion 756 and the secondary seal portion 758 overlap with the interface protrusion structure 764 of the secondary seal portion 758 disposed in the interface channel 762 of the primary seal portion 756. The metal mesh pad 768 is compressed between the primary seal portion 756 and the secondary seal portion 758. Lubricant flows through the interface channel 762 to seal between the primary seal portion 756 and the secondary seal portion 758 and to lubricate horizontal movement and seal the overlap interfaces.

The vane exhaust seal 750 has a wave biasing member 766 mounted to the top surface 754. The wave biasing member 766 biases the vane exhaust seal 750 against the rotor surface 200 as the vane 368 is in lowered position. The vane exhaust seal 750 further has a two guide rods 770 extending from the top surface 754. The vane 368 defines two guide rod cavities 772. The two guide rods 770 of the vane exhaust seal 750 are disposed in the two guide rod cavities 772 of the vane 368.

The vane exhaust seal 750 has two outer ends 774. The two guide rods 770 direct the movement of the vane exhaust seal 750 within the vane exhaust seal chamber 748 and locates the two outer ends 774 of the of the vane exhaust seal 750 against the vane exhaust seal chamber 748. The two outer ends 774 of the vane exhaust seal 750 are aligned with the rotor 192. The width of vane exhaust seal 750 is equal to the width of the rotor 192. A rod groove seal 776 is disposed around the two guide rods 770. The two rod groove seals 776 abut the two guide rod seal cavities 772. Lubricant is supplied by the vane 368 to lubricate the movement of the two guide rods 770 in the twp guide rod cavities 772. The two rod groove seals 776 prevent lubricant from by-passing the two guide rods 770.

The vane exhaust seal 750 has a damper 778 mounted to the vane 368 and disposed between the vane 368 and each of the two guide rods 770. The two dampers 778 include vertical biasing members 780 that further bias the vane exhaust seal 750 against the rotor surface 200 and dampen the upward movement of the vane exhaust seal 750 in the vane exhaust seal chamber 748 as the vane exhaust seal 750 initially abuts the rotor surface 200 and the vane 368 is moving towards the rotor surface 200 and the lowered position. The wave biasing member 766 and the two dampers 778 quickly form a seal between the vane exhaust seal 750 and the rotor surface 200 as the vane 368 reaches the lowered position by limiting any bounce-off excitation of the vane exhaust seal 750.

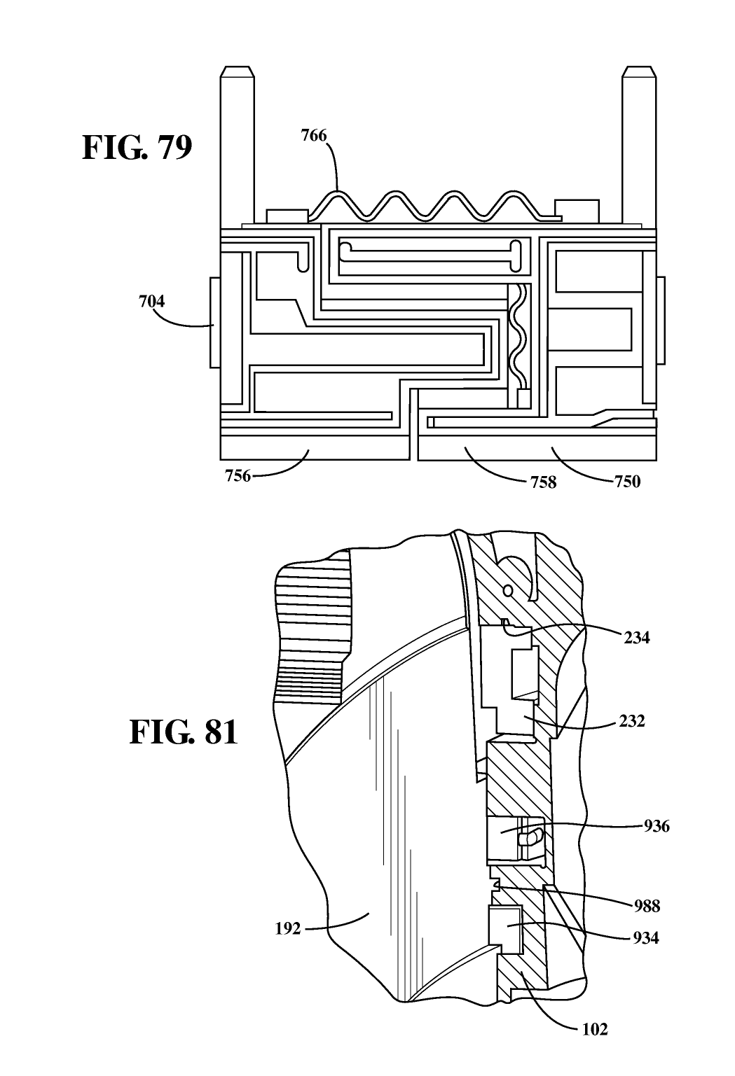

As best shown in FIG. 79, The vane exhaust seal 750 has a separation biasing member 782 mounted between the primary seal portion 756 and the secondary seal portion 758. The separation biasing member 782 biases the primary seal portion 756 and the secondary seal portion 758 away from each other such that the outer ends 774 of the vane exhaust seal 750 are biased against the vane exhaust seal chamber 748 to ensure a sealing interface between the vane exhaust seal 750 and the vane lubricant seal chamber 748.

As best shown in FIG. 80, the vane exhaust seal 750 defines a lubricant channel 784 in fluid communication with one of the plurality of vane lubricant supply channels 510 for facilitating lubricant flow between the vane 368 and the vane exhaust seal 750. The lubricant channel 784 disperses the lubricant through the vane exhaust seal 750 to lubricate the movement of the vane exhaust seal 750 in the vane exhaust seal chamber 748. The vane exhaust seal 750 prevents gases between the vane 368 and the rotor surface 200 from bypassing the vane 368.

Turing back to FIG. 78, the vane exhaust seal 750 has a front surface 786 and rear surface 788. The vane exhaust seal 750 further has two outer ends 774. The vane exhaust seal 750 has a metal mesh pad 790 and a foil layer (not shown) mounted to the front surface 786, the rear surface 788, and the two outer ends 774. The foil layer is disposed around the metal mesh pad 790. The metal mesh pad 790 and the foil layers are compressed between the vane exhaust seal 750 and the vane exhaust seal chamber 748. The compression of the metal mesh pad 790 and the foil layers form a continuous seal between the vane exhaust seal 750 and the vane exhaust seal chamber 748 to prevent the by-pass of gases and lubricant.

Turning back to FIG. 78, in another embodiment, the vane exhaust seal chamber 748 defines two retention cavities 792. The vane exhaust seal 750 defines two retainer plate chambers 794. The vane exhaust seal 750 further has two retainer biasing members 796 and two retainer plates 798. The two retainer biasing members 796 are disposed in the two retainer plate chambers 794 and mounted to the vane exhaust seal 750. The two retainer plates 798 are mounted to the two retainer biasing members 796 and are moveable into and from the two retainer plate chambers 794. As the vane exhaust seal 750 is installed into the vane 368, the two retainer biasing members 796 and the two retainer plates 798 are compressed into the two retainer plate chambers 794. As the two retainer biasing members 796 and the two retainer plates 798 are aligned with the corresponding two retention cavities 792, the two retainer biasing members 796 are decompressed and dispose the two retainer plates 704 in the two retention cavities 792.

The vane compression seal 584 abuts the rotor surface 200 to prevent combustion gases from bypassing the vane 368. The trailing seal 638 abuts the vane compression seal 584, the rotor surface 200, and the rotor seal 232 to prevent combustion gases from bypassing the vane 368. The vane lubricant seal 676 abuts the rotor surface 200 to prevent lubricant from bypassing the vane 368. The three vane valves 714 abut the rotor surface 200 and release lubricant to lubricate and seal between the rotor surface 200 and the vane 368. The vane exhaust seal 750 abuts the rotor surface 200 to prevent exhaust gases from bypassing the vane 368.

As previously discussed and best shown in FIG. 81, the rotational engine assembly 100 includes two rotor seals 232 with one of the rotor seals 232 disposed in the first rotor seal chamber 224 and the other of the rotor seals 232 disposed in the second rotor seal chamber 226.

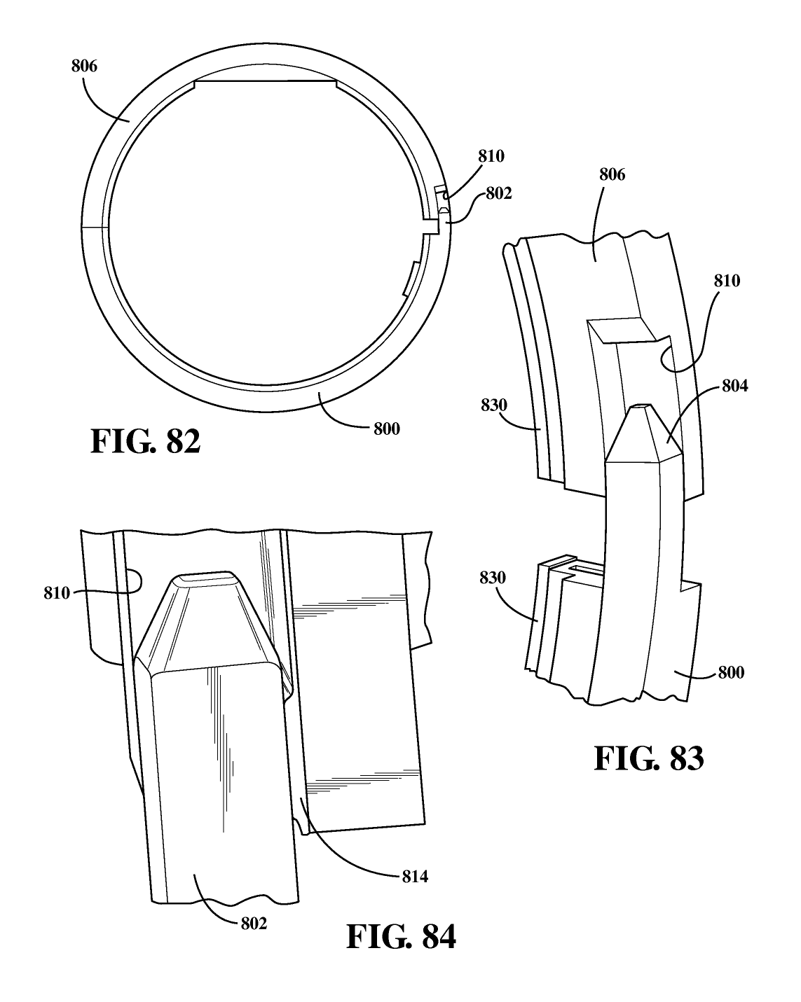

As best shown in FIGS. 82-83, the rotor seals 232 have a lower seal 800 with a protrusion rod 802 having a square configuration. The protrusion rod 802 has a rod end 804 with a tapered square configuration. The rotor seals 232 further have an upper seal 806 with a rod cutout end 808. A rod cutout 810 is defined in the rod cutout end 808. Turning to FIG. 84, the protrusion rod 802 of the lower seal 800 is disposed in the rod cutout 810 of the upper seal 806 and a gap 812 is defined between the protrusion rod 802 and the rod cutout 810. The gap 812 will allow the upper seal 806 and the lower seal 800 to thermally expand and contract. The upper seal 806 has a metal mesh pad 814 and a foil layer (not shown) disposed in the rod cutout 810. The metal mesh pad 814 is compressed between the rod cutout 810 of the upper seal 806 and the protrusion rod 802 of the lower seal 800 to create a seal between the upper seal 806 and the lower seal 800.

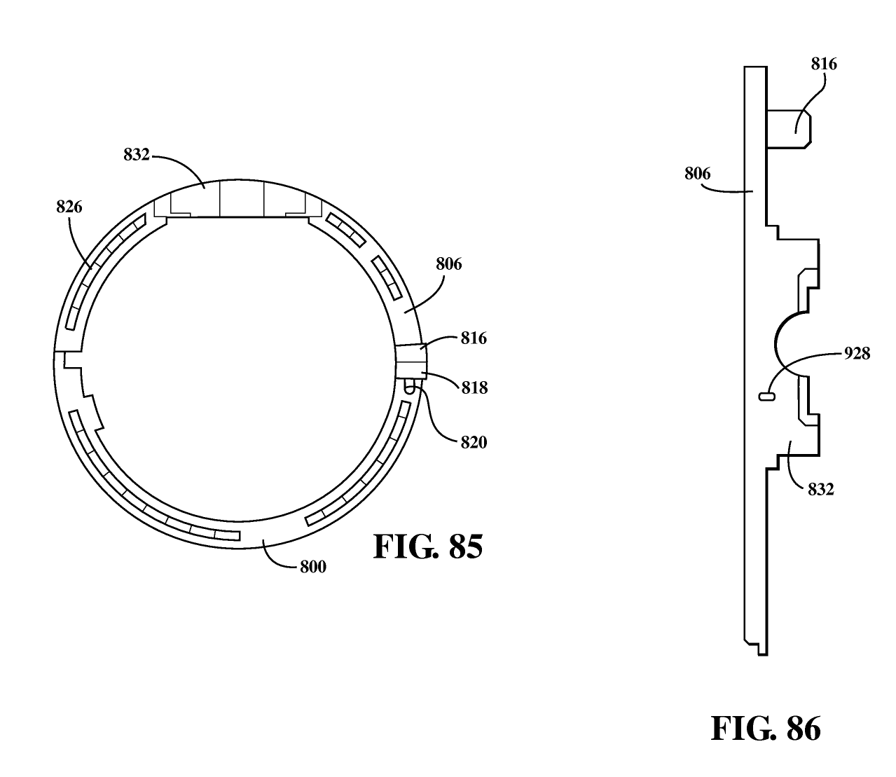

As best shown in FIG. 85, the lower seal 800 has a joint protrusion 816 defining a locating hole (not shown). The upper seal 806 has a second protrusion 818 and a joint rod 820 with a partially threaded end (not shown). The joint protrusion 816 of the lower seal 800 is aligned with and abuts the second protrusion 818 of the upper seal 806. The locating hole of the lower seal 800 is also aligned with the joint rod 820 of the upper seal 806. The joint rod 820 is disposed in the locating hole and a threaded nut 822 is mounted to the threaded end of the joint rod 820 to adjoin the opposing mating surfaces of the protrusion of upper and lower seals.

The two rotor seals 232 have a rotor sealing surface 823 and define a plurality of slots 824. The two rotor seals 232 have a plurality of wave biasing members 826 disposed in the slots 824 and mounted to the two rotor seals 232. The wave biasing members 826 bias the rotor sealing surfaces 823 of the rotor seals 232 against the rotor 192.

Turning back to FIG. 82, the two rotor seals 232 have a rotor sealing surface 823 and an inner surface 828 with a metal mesh pad 830 and a foil layer. The foil layers are disposed around the metal mesh pads 830. As the two rotor seals 232 are inserted into the respective rotor seal chambers 224, 226 the metal mesh pads 830 and the foil layers are compressed between inner surfaces 828 of the rotor seals 232 and rotor seal chambers 224, 226.

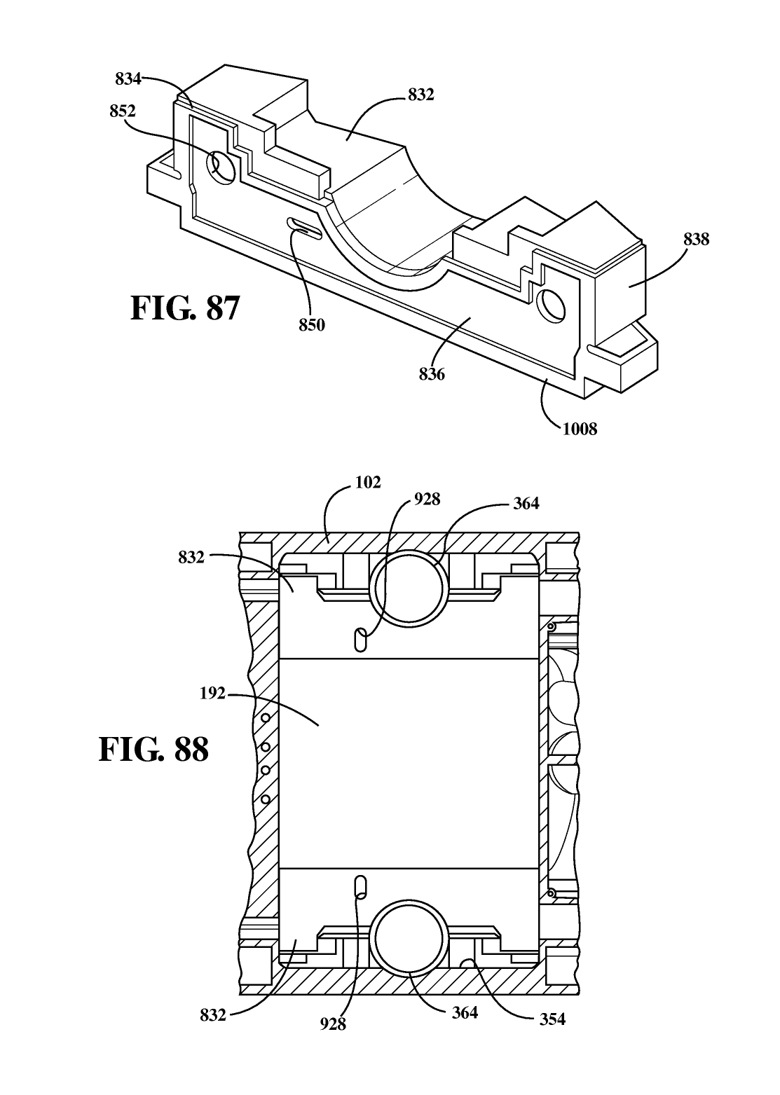

As best shown in FIG. 86, the upper rotor 192 seal has a rail pad 832. Turning to FIG. 87, the rail pad 832 has a frame 834 with a base 836 and four flanges 838. The frame 834 has a corresponding configuration with the rail pad 832. However, it is to be appreciated that the frame 834 may have any suitable number of flanges 838 and have any suitable configuration for sealing around the rail pad 832.

As best shown in FIG. 90, the four flanges 840 have an inner surface 840, a top surface 842, and an outer surface 844. The base 836 has a bottom surface 846 and a mesh pad surface 1008 defining a mesh groove (not shown) along the base 836.

The base 836 defines two of the guide pin holes 852 extending through the base 836. The rail pads 832 define two threaded holes 853 aligned with the guide pin holes 852 of the base 836. The base 836 further has perimeter edges 1004

As best shown in FIGS. 42 and 88, the frame 834 has a metal mesh pad 1008 disposed in the mesh groove and extending past the base 836. The rail pad 832 and the rotor seal 232 are disposed in one of the rotor seal chamber 224, 226, the metal mesh pad 1008 extending past the base 836 abuts the rail structure 364 and is crushed to form a metal to metal contact between rail structure 364 and bottom of rail pad 832 of rotor seal.

The foil layer is disposed over the base 836 and the four flanges 840. The metal mesh pad 1008 is mounted relative to perimeter edges 1004 of the base 836. The metal mesh pad 1008 is also mounted to the inner surfaces 840, the top surfaces 842, and outer surfaces 844 of the four flanges 840. The metal mesh pad 1008 is disposed around the frame 834 between the frame and foil layer. The foil layer is laser welded onto the surfaces 840, 842, 844, and 846 of the frame 834. However, it is to be appreciated that the metal mesh pad 854 and the foil layer may be attached to the frame 834 in any suitable method.

The frame 834 abuts the vane compression seal 376, the rail pad 832, and the housing 102. The portion of the metal mesh pad 1008 on the inner surfaces of the flanges 840 abut and seal against the rail pad 832. The portion of the metal mesh pad 1008 on the outer surfaces 844 of the flanges 840 abut and seal against the housing 102. The portion of the metal mesh pad 1008 on the top surfaces 842 of two of the four flanges abuts and seals against the vane compression seal 376. The portion of the metal mesh pad 1008 on the bottom surface 846 of the base 836 abuts and seals against the housing 102. The metal mesh pad 854 and the foil layer are compressed to seal and prevent the by-pass of the high pressure gases and lubricant.

As best shown in FIG. 39, the rail pad 832 has a rail structure surface 856 and a vane surface 860. The rail structures 364 define a lubricant groove 862. The rail structure surfaces 856 of the rail pads 832 abut and cover the lubricant grooves 862 of the rail structures 364. The lubricant grooves 862 are in fluid communication with one of the plurality of housing lubricant supply channels. The lubricant flowing between the rail structures 364 and the rail pads 832 creates a robust seal and also allows the rotor seals 232 to move towards the rotor 192 as the rotor seals 232 deteriorate.

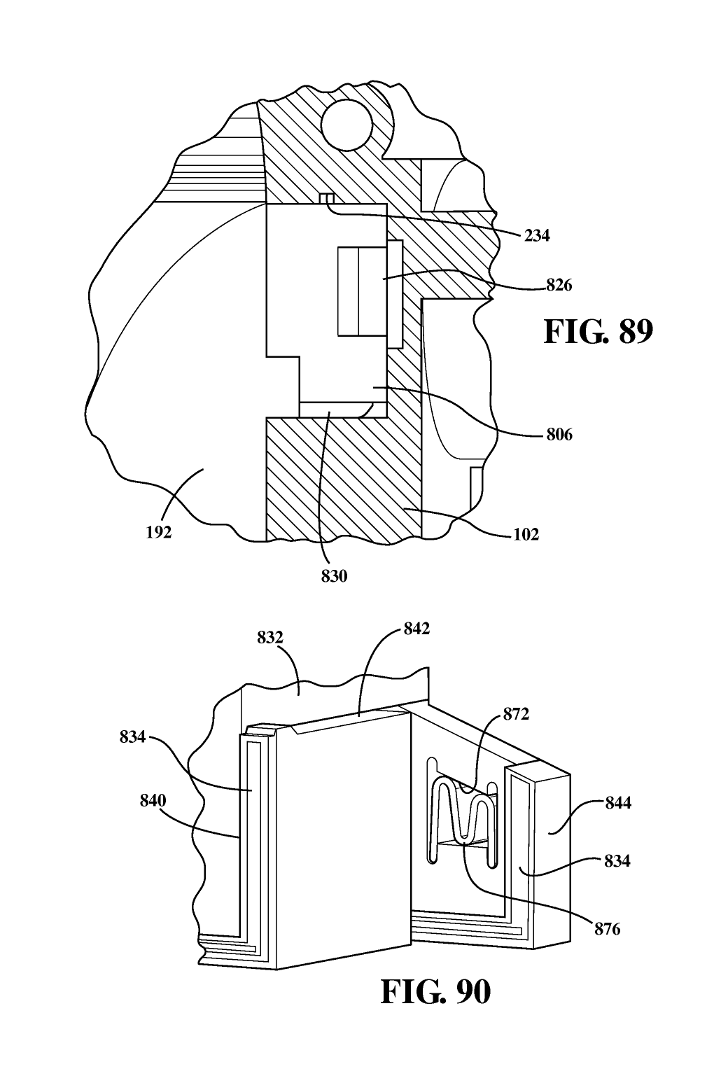

As best shown, in FIGS. 14 and 89, the two rotor seals 232 have a top surface 864 and a bottom surface 866. The two rotor seal chambers 224, 226 have a vertical surface 868 defining a plurality biasing member slots 870.

As best shown in FIG. 90, the rotor seals 232 define a biasing member chamber 872 and two slits 874 extending into the biasing member chamber 872. The rotor seals 232 have a compression biasing member 876 disposed in the biasing member chamber 872. The compression biasing member 876 biases the rotor seals 232 against the top surface 228 and the bottom surface 230 of the rotor seal chamber 224. The two slits 874 facilitate additional expansion of the rotor seals 232 for continuous abutment of the top surface 864 and the bottom surface 866 of the rotor seals 232 to the top surface 228 and the bottom surface 230 of the rotor seal chambers 224, 226.

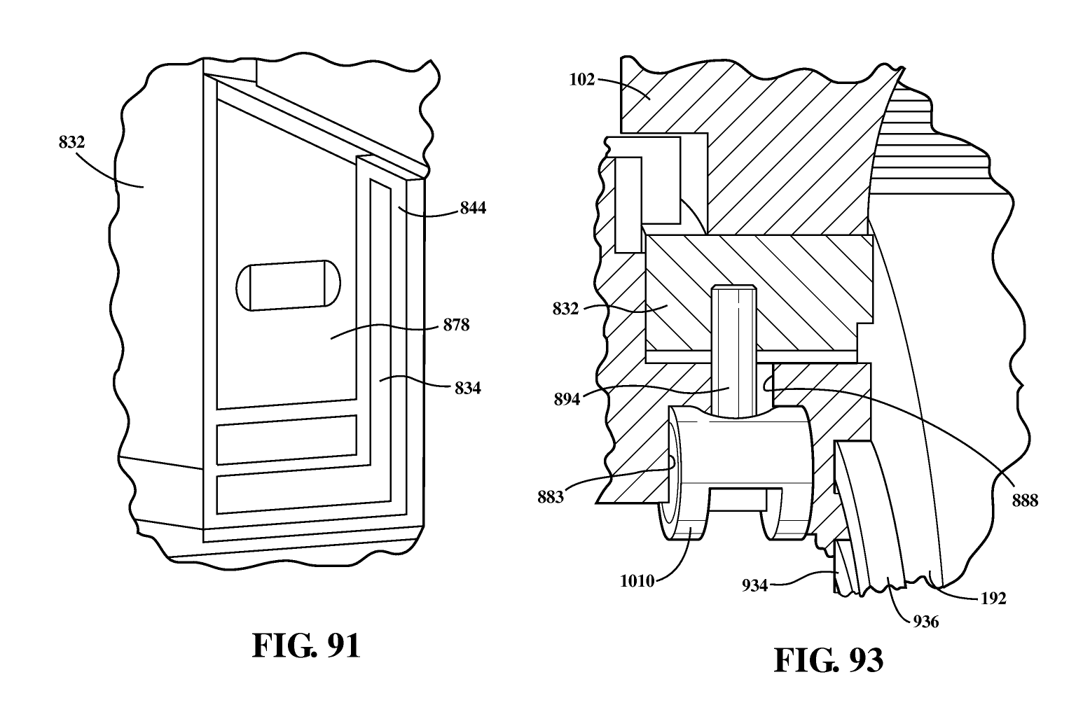

As best shown in FIG. 91, the biasing member chamber 872 extends into the vane chamber 354. The rotor seals 232 further have a metal foil layer 878. The metal foil layer 878 is mounted to the rotor seals 232 and encapsulates the biasing member chamber 872 to prevent high pressure gases from by-passing the biasing member chamber 872 near the rotor end 356 of the vane chamber 354.

The metal foil layer 878 defines an expansion pocket feature that allows the rotor seals 232 to expand a vertical direction in the biasing member chamber 872. The biasing member chamber 872 can expand to a greater size than the biasing member chamber 872 prior to rotors seals 232 installation. The capability to change size enables the rotor seals 232 to conform to the rotor seal chambers 224, 226 and abut the rotor seal lubricant channels 234. The metal foil layer 878 is laser welded to the rotor seals 232 relative the perimeter edges. However, it is to be appreciated that the metal foil layer 878 may be attached to the rail pad 832 in any suitable method.

As best shown in FIG. 92, the two rotor seals 232 are minor image designs and have sealing surfaces 882. The two rotor seals 232 are disposed in the first rotor seal chamber 224 and the second rotor seal chamber 226. The sealing surfaces 882 of the rotor seals 232 abut the primary surface 194 and the secondary surface of the rotor 192. The rail structure surfaces 858 of the rail pads 832 are disposed around the rail structures 364 in the vane chamber 354. The vane surfaces 860 of the two rotor seals 232 abut the two pad surfaces 482 of the vane 368 as the vane 368 is in the lowered position. The rail pads 832 also prevent rotation of the rotor seals 232 in the rotor seal chambers 224, 226.

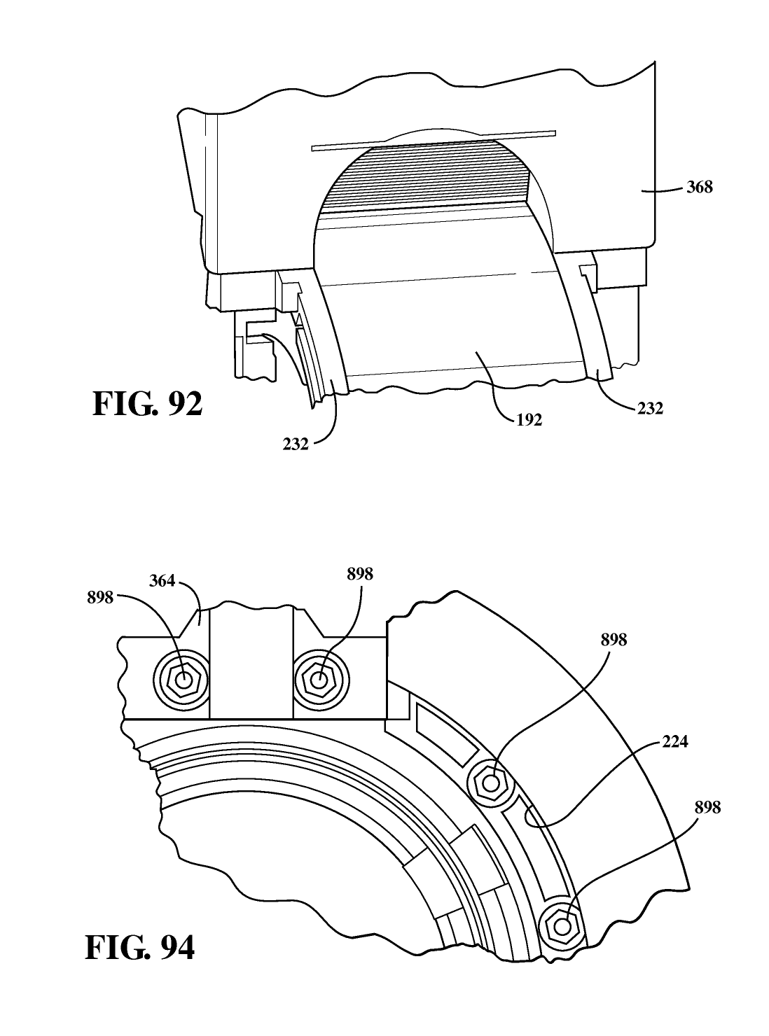

As best shown in FIG. 93, the housing 102 defines a seal guide pin chamber 883 and the rotational engine assembly 100 has a rotor seal guide pins 884 mounted in the guide pin chamber 883. The rail structures 364 have a top surface 886 and define a thru slot 888 extending through the rail structures 364. The thru slot 888 of the rail pad 832 extends parallel to the central axis A1. The outer bushing 1010 further defines a pin slot 885 aligned with the thru slot 888. The rotor seal guide pins 884 have a base pin 890 and define a bolt hole 891 through the base pin 890. The rotor seal guide pins 884 further have an outer bushing 1010. The outer bushing 1010 defines has a pin chamber (not shown) and a pin slot (not shown). The rotor seal guide pins 884 and the bolts 894 are movably disposed in the pin slot 885 of the outer bushing 1010. The bolts 894 are disposed in the bolt hole 891 of the base pin 890. The base pin 890 and the bolt 894 move as a unit. The bolts 894 transversely extend through the pin slot (not shown) of the outer bushing 1010, the thru slots 888 of the rail structures 364 and into the 853 threaded holes of the rail pads 832.

As the bolts 894 are screwed into the corresponding rotor seals 232, the bolts 894 move the rotor seals 232 to abut the top surfaces 886 of the rail structures 364. As the rotor seal 232 is secured to the rail structure 364 by the rotor seal guide pin bolt 894, there is metal to metal contact between the rotor seal 232s, the foil layer 878, and the frame 836 base, as the metal mesh pad compresses in the bottom side of the frame base mesh groove.

The bolts 894 also serve as a locater for the rotor seals 232 within the rotor seal chambers 224, 226 and ensure even compression of the metal mesh pads 854 of the frame 834 on both sides of the vane chamber 354. The lubricant is circulated through the lubrication groove 862 of the rail structures 364 to allow the rotor seals 232, the frame 834, and the bolts 894 to move toward the rotor 192 as the sealing surfaces 882 of the rotor seals 232 deteriorate. The circulated lubricant helps the rotor seals 232 can overcome the clamp load between the rotor seals 232 and rail pad 832.

The two rotor seals 232 have a metal mesh pad 896 and a foil layer mounted to the bottom surfaces 866. The foil layers are disposed around the metal mesh pads 896. The metal mesh pads 896 abut the bottom surfaces 230 of the two rotor seal chambers 224, 226. The metal mesh pads 896 bias the top surfaces 886 of the rotor seals 232 against the top surfaces 238 of the rotor seal chambers 224, 226 to form a biasing member loaded gas tight seal at this interface. The lubricant is flows through the rotor seal lubricant channels 234 along the rotor seals 232 to lubricate the sealing interfaces between top surfaces 886 of the rotor seals 232 and rotor seal chambers 224, 226. This enhances this sealing interface to further prevent high pressure gases from by-passing the rotor seals 232 and the rotor seal chambers 224, 226.

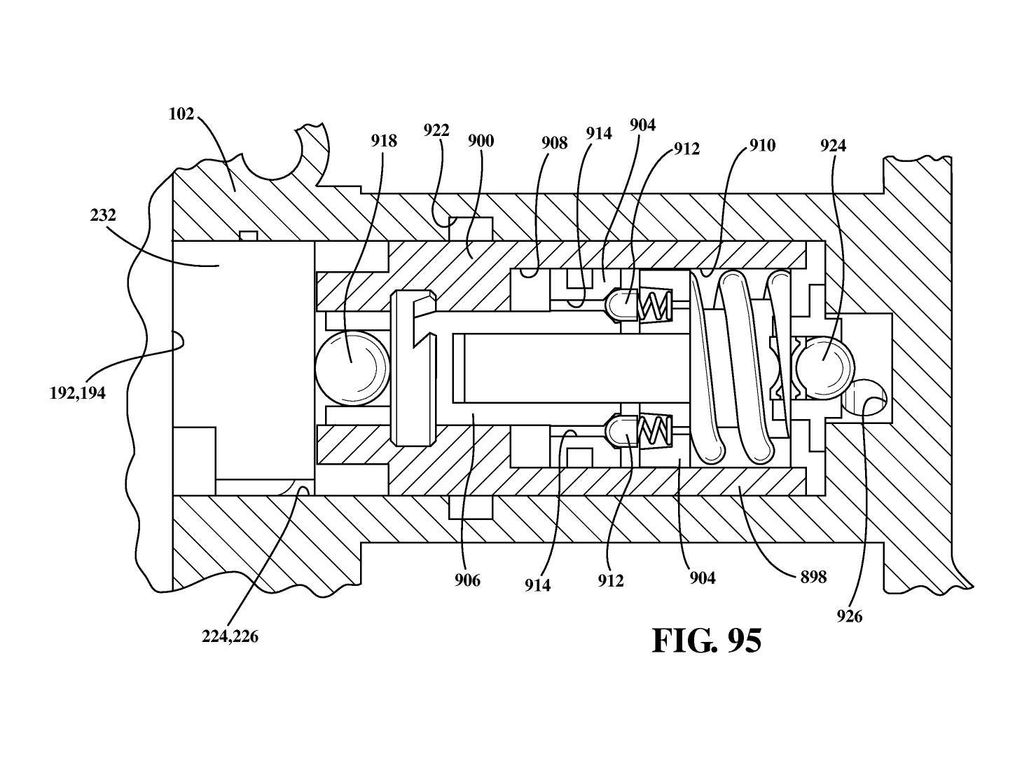

As best shown in FIG. 94, the rotational engine assembly 100 has a plurality of rotor seal lock dampers 898 mounted to the housing 102 and extending into the rotor seal chambers 224, 226. Turning to FIG. 95, the rotor seal lock dampers 898 abut and bias the rotor seals 232 against the primary surface 194 and the secondary surface of the rotor 192. The wave biasing members 826 of the rotor seals 232 abut vertical surface 686 of the rotor seal chambers 224, 226 to bias the rotor seals 232 against the primary surface 194 and the secondary surface of the rotor 192. The rotor seal lock dampers 898 have a lock position in which the rotor seal lock dampers 898 retain the rotor seals 232 against the rotor 192 to prevent combustion gases and exhaust gases from bypassing the rotor 192 and entering the crankshaft 104 chamber by locking the rotor seals 232 against the rotor 192. The rotor seal lock dampers 898 adjust the lock position as the sealing surfaces 882 of the rotor seals 232 deteriorate. The rotor seal lock dampers 898 apply additional force to the rotor seals 232 in correlation with the wave biasing members 826.

The rotor seal lock dampers 898 have a damper body 900 defining a damper cavity 902. The rotor seal lock dampers 898 further include a damper piston 904 and a piston rod 906 with the damper pistons 904 movably disposed in the damper cavities 902. The damper pistons 904 divide the damper cavities 902 into a front damper chamber 908 and a rear damper chamber 910.

The rotor seal lock dampers 898 have two check valves 912 mounted to the damper pistons 904 between the front damper chambers 908 and the rear damper chambers 910. The damper pistons 904 further define fluid channels 914 connecting the front damper chambers 908 and the rear damper chambers 910. The two check valves 912 are in fluid communication with the fluid channels 914. The check valves 912 facilitate the flow of hydraulic fluid from the front damper chambers 908 to the rear damper chambers 910 as the rotor seals 232 deteriorate against the rotor and the damper pistons 904 move toward the rotor 192, adjusting the lock position. The check valves 912 prevent the flow of hydraulic fluid from the rear damper chambers 910 to the front damper chambers 908 to lock the position and prevent the rotor seals 232 and damper pistons 904 from moving away from the rotor 192. It is to be appreciated that any number of check valves and fluid channels can exist in this manner.

As best shown FIG. 95, the piston rod 906 of the rotor seal lock dampers 898 define a ball chamber 916 and has a ball 918 disposed in the ball chambers 916. The balls 918 extend out of the ball chambers 916 and abut the damper pistons 904 and the rotor seals 232. The balls 918 allow the rotor seals 232 to freely expand and contract thermally while still allowing a constant force to be applied by the rotor seal lock dampers 898.

The rotor seal lock dampers 898 have a fill valve 920 disposed in and mounted to the damper bodies 900. The fill valves 920 are in fluid communication with the damper cavities 902. The housing 102 defines a plurality of fill passageways 922 in fluid communication with the fill valves 920. The rotor seal lock dampers 898 further have a drain valve 924 disposed in and mounted to the damper bodies 900. The drain valves 924 are in fluid communication with the damper cavities 902. The housing 102 further defines a drain passageway 926 in fluid communication with the drain valves 924. The fill passageways 922 and the drain passageways 926 are arranged so that less dense air pockets can be bled out of damper cavity 902 during the fluid fill process. The fluid fill process is performed after the rotor seal lock dampers 898, the rotor seals 232, and the rotor 192 are installed.

As best shown in FIG. 77, the rotor seals 232 define a plurality of drain conduits 928 in fluid communication with the housing 102. The drain conduits 928 are aligned with and in fluid communication with the drain grooves 744. The lubricant from the drain grooves 744 is further drained through the drain conduits 928 and away from the rotor 192 and vane 368.

As best shown in FIGS. 5-6 and 81, the housing 102 defines an inner seal chamber 930 and an outer seal chamber 932 on the first housing surface 154 and the second housing surface 160. The inner seal chambers 930 and the outer seal chambers 932 are symmetric and oppose each other.

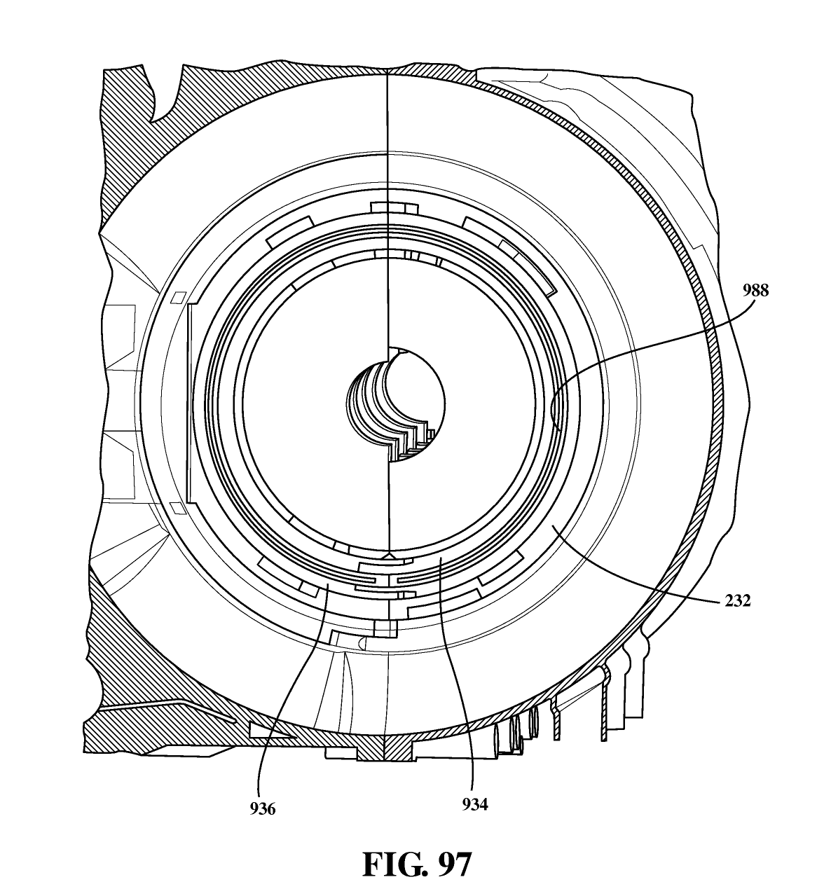

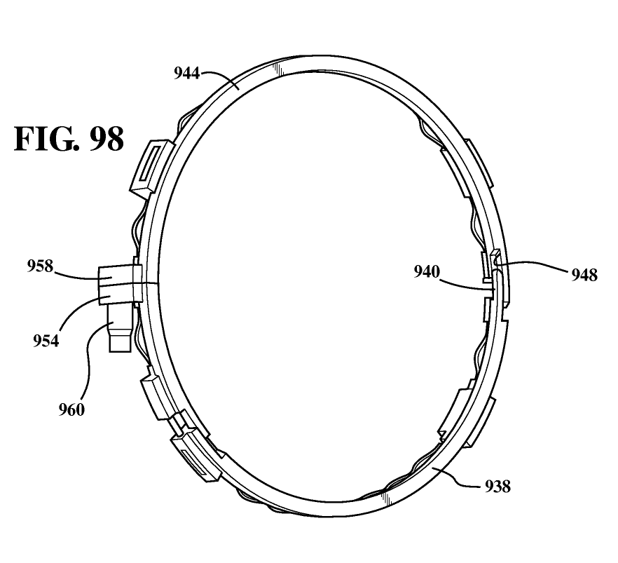

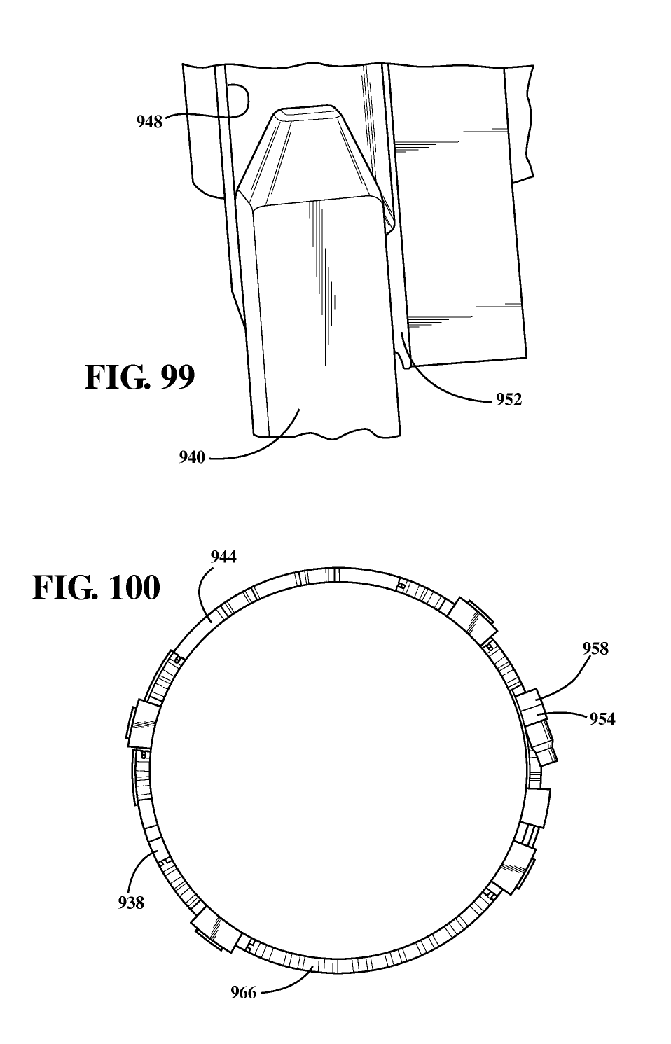

As best shown in FIGS. 5, 93, 97, the rotational engine assembly 100 includes two inner lubricant seals 934 disposed in and mounted to the inner seal chambers 930. The rotational engine assembly 100 further includes two outer lubricant seals 936 disposed in and mounted to the outer seal chambers 932. Turning to FIG. 98, the inner lubricant seals 934 and the outer lubricant seals 936 have a lower seal 938 with a seal rod 940 having a square configuration. The seal rods 940 have a seal rod end 942 with a tapered square configuration. Turning to FIG. 99, the inner lubricant seals 934 and the outer lubricant seals 936 further have an upper seal 944 with a cutout end 946 that defines a rod cutout 948. The seal rods 940 of the lower seals 938 are disposed in the rod cutouts 948 of the upper seals 944 and a gap 950 is defined between the seal rods 940 and the rod cutouts 948. The gaps 950 will allow the upper seals 944 and the lower seals 938 to thermally expand and contract. The upper seals 944 have a metal mesh pad 952 and a foil layer (not shown) disposed in the gap 950. The metal mesh pads 952 are compressed between the rod cutouts 948 of the upper seals 944 and the seal rods 940 of the lower seals 938 to create a gas tight seal between the upper seals 944 and the lower seals 938.

As best shown in FIG. 100, the lower seal 938 has a joint protrusion 954 defining a locating hole (not shown). The upper seal 944 has a second protrusion 958 and a joint rod 960 with a partially threaded end (not shown). The joint protrusion 954 of the lower seal 938 is aligned with and abuts the second protrusion 958 of the upper seal 944. The locating hole of the lower seal 938 is also aligned with the joint rod 960 of the upper seal 944. The joint rod 960 is disposed in the locating hole and a threaded nut 962 is mounted to the threaded end of the joint rod 960 to adjoin upper seal 994 and the lower seal 938.

The inner lubricant seals 934 and the outer lubricant seals 936 define a plurality of slots 964. The inner lubricant seals 934 and the outer lubricant seals 936 have a plurality of wave biasing members 966 disposed in the slots 964 and mounted to the inner lubricant seals 934 and the outer lubricant seals 936. The wave biasing members 966 bias the inner lubricant seals 934 and the outer lubricant seals 936 against the rotor 192. The inner lubricant seals 934 and the outer lubricant seals 936 have an inner surface 968 with a metal mesh pad 970 and a foil layer. The foil layers are disposed around the metal mesh pads 970. As the inner lubricant seals 934 and the outer lubricant seals 936 are inserted into the respective inner seal chamber 930 and outer seal chamber 932, the metal mesh pads 970 and the foil layers are compressed between inner surfaces 968 of the inner lubricant seals 934 and the outer lubricant seals 936 and the inner seal chamber 930 and outer seal chamber 932.

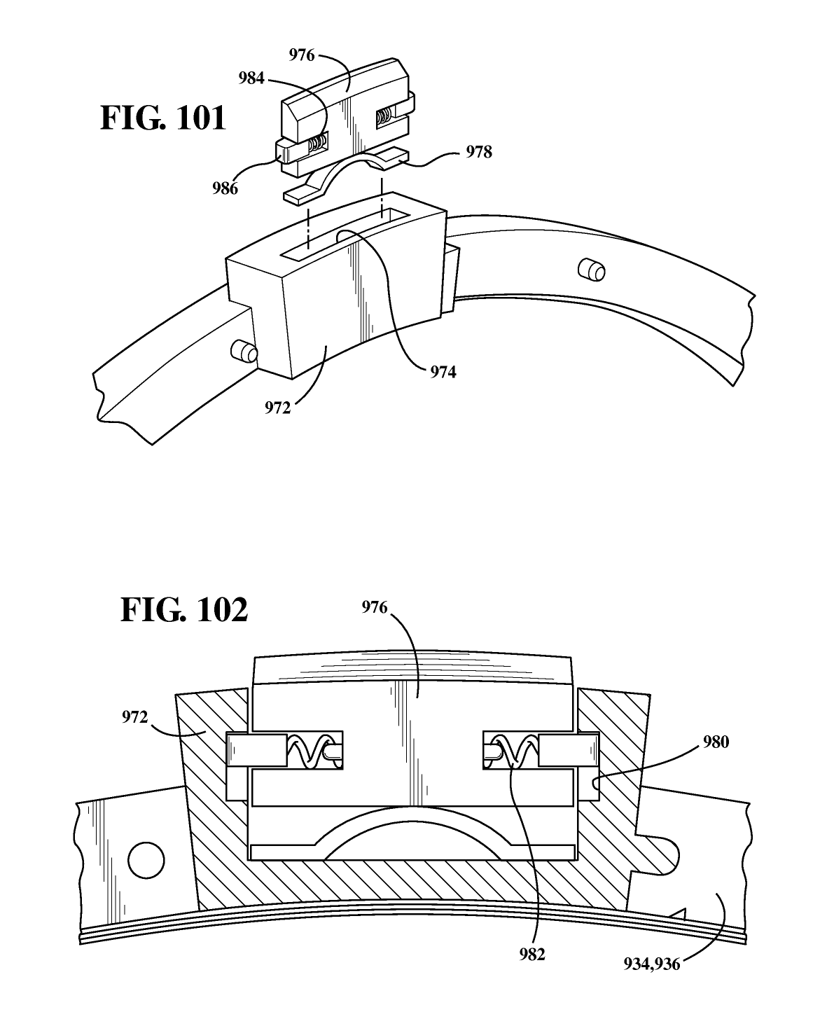

As best shown in FIGS. 101-102, the inner lubricant seals 934 and the outer lubricant seals 936 have a retention structure 972 to retain the inner lubricant seals 934 and the outer lubricant seals 936 in the housing 102. The retention structures 972 define a retainer chamber 974 and have a retainer plate 976 and a retainer biasing member 978. The retainer biasing members 978 are disposed in the retainer chambers 974 and are mounted to the retention structures 972. The retainer plates 976 are disposed in the retainer chambers 974 and abut the retainer biasing members 978. The retainer plates 976 can resiliently move in the retainer chambers 974 and the retainer biasing members 978 bias the retainer plates 976 out of the retainer chambers 974.

The retention structure 972 further defines two cavities 980 extending into the retainer chambers 974. The retainer plates 976 define two notches 982. The retainer plates 976 have a block biasing member 984 disposed in the two notches 982 and mounted to the retainer plates 976. The retainer plates 976 have a block 986 mounted to the block biasing members 984.

As the retainer plates 976 are installed into the retainer chambers 974, the two block biasing members 984 are compressed and the two blocks 986 are disposed into the two notches 982. As the two blocks 986 of the retainer plates 976 are aligned with the two cavities 980 of the retention structures 972, the two blocks 986 are biased by the two block biasing members 984 into the two cavities 980. The movement of the retainer plates 976 in the retention structure 972 is limited to the movement of the two blocks 986 in the two cavities 980.

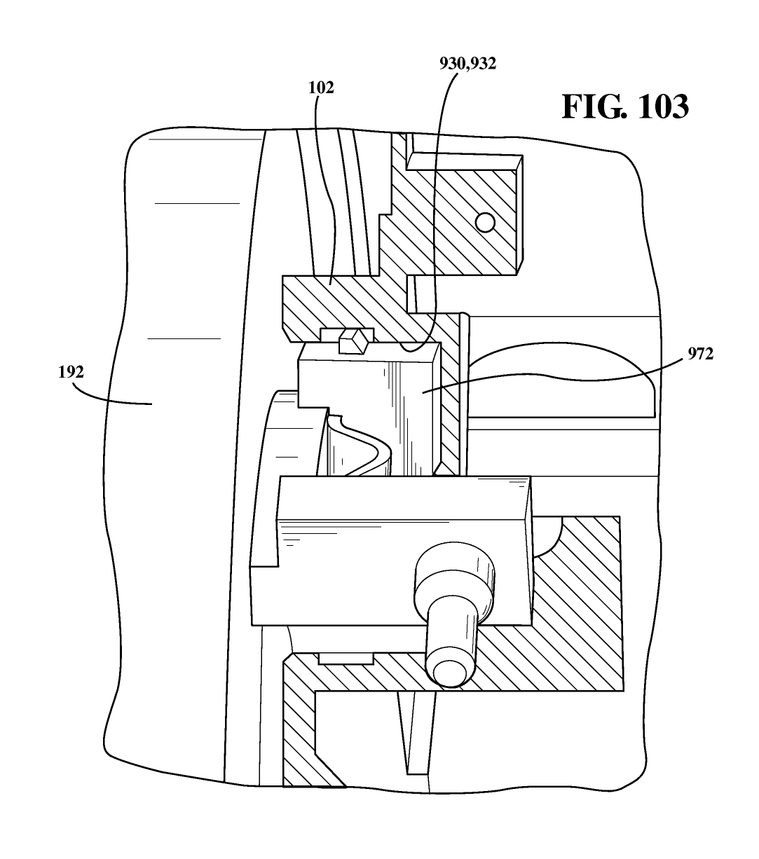

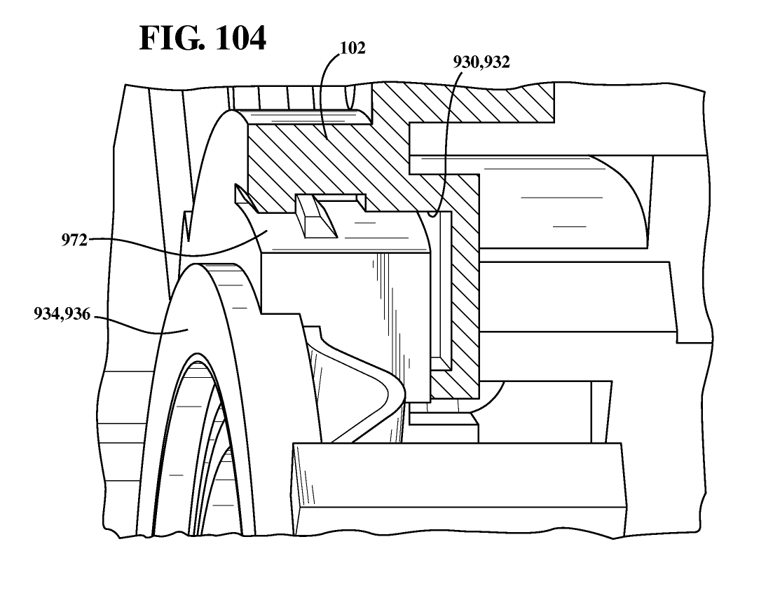

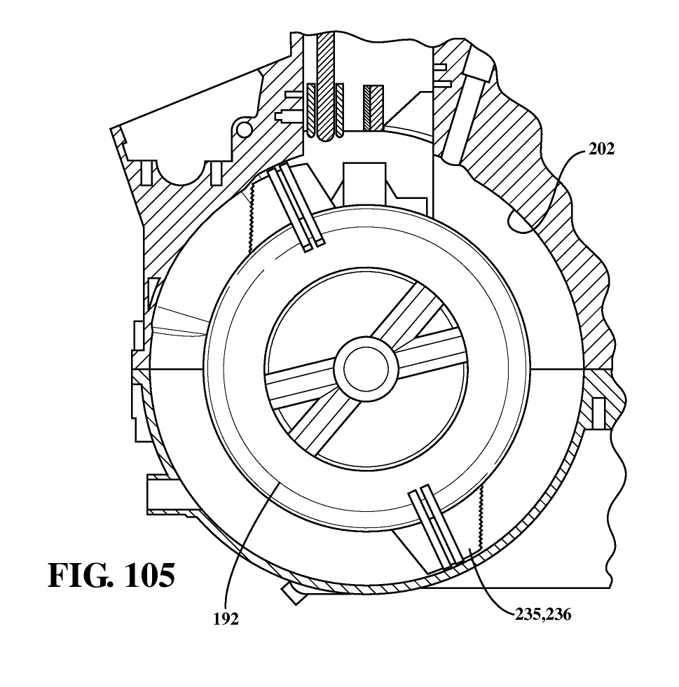

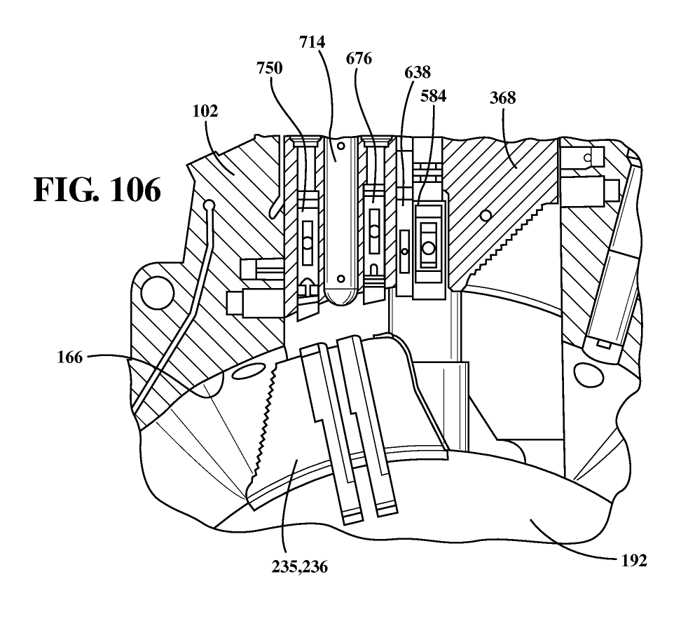

As best shown in FIGS. 103-104, the housing 102 defines a set of slots extending into the inner seal chambers 930 and the outer seal chambers 932. As the inner seals and the outer seals are installed, the retainer biasing members 978s are compressed and the retainer plates 976s move completely into the retention structure 972. As the retainer plates 976s are aligned with the slots of the housing 102, the retainer plates 976s move into the slots. The retainer biasing members 978s bias the retainer plates 976s into the slots and retain the inner seals and the outer seals within the inner seal chambers 930 and the outer seal chambers 932. The retention structures 972 of the inner lubricant seals 934 and the outer lubricant seals 936 are disposed in corresponding slots to net locate the orientation of the respective seals and prevent the inner lubricant seals 934 and the outer lubricant seals 936 from rotating within the lubricant seal channels.

As best shown in FIGS. 5-6 and 81, the housing 102 defines a first lubricant path 988 on the first housing surface 154 and a second lubricant path (not shown) on the second housing surface 160. The lubricant paths 988 are symmetric and oppose each other. The lubricant paths 988 are defined between the inner seal chambers 930 and the outer seal chambers 932. The lubricant paths 988 lubricate the gap between the rotor 192 and the housing wall 166. The inner lubricant seals 934 and the outer lubricant seals 936 are disposed within the inner seal chambers 930 and the outer seal chambers 932. The inner lubricant seals 934 and the outer lubricant seals 936 abut the primary rotor surface 194 and the second rotor surface. The inner lubricant seals 934 and the outer lubricant seals 936 prevent lubricant from by-passing the rotor 192 and entering the crank chamber 198 of the rotor 192 and/or onto the rotor surface 200 of the rotor 192.

As best show in FIG. 8, the area between the rotor surface 200 of the rotor 192 and the housing wall 166 of the housing 102 defines a working chamber 202. Turning to FIGS. 4 and 8, the area between the combustion surface 242 of the first thruster 235, the housing wall 166, the rotor surface 200, and the combustion cavity 508 of the vane 368 defines a combustion chamber 990. Turning to FIG. 107, the area between the exhaust surface 244 of the first thruster 235 and combustion surface 242 of the second thruster 236 defines a first exhaust chamber 902. The area between the exhaust surface 176 of the second thruster 236 and the exhaust surface 509 of the vane 368 defines a second exhaust chamber 904.

The rotational engine assembly 100 has a compression cycle during operation. The crankshaft 104 facilitates rotation of the main gear 110 during the compression cycle. The crankshaft 104 will facilitate rotation of the main gear 110. The main gear 110 will facilitate rotation of the compressor gear 114 and the camshaft gear. The compressor gear 114 will facilitate rotation of the compressor crankshaft 112. The compressor crankshaft 112 will facilitate movement of the compressor piston 120 in the compressor cylinder 124 between the top end 126 and the bottom end 128 of the compressor cylinder 124. As the compressor piston 120 moves from the top end 126 to the bottom end 128 of the compressor cylinder 124, the compressor inlet 130 is opened and air is drawn into the compressor cylinder 124. As the compressor piston 120 moves from the bottom end 128 to the top end 126 of the compressor cylinder 124, the compressor inlet 130 is closed and the air is compressed within the compressor cylinder 124 and transfer channel 134.

The rotational engine assembly 100 further includes a power cycle. The vane 368 is in the lowered position near the end of the compression cycle as the compressor piston 120 approaches the top end 126 of the compression cylinder 124. The pad surfaces 482 of the vane 368 are abutting vane surfaces 860 of the rotor seals 232. The vane compression seals 376 are abutting the rotor surface 200 of the rotor 192 to seal along the combustion chamber 900. The rotor sealing surfaces 583 of the two rotor seals 232 abut the rotor 192 to seal along the combustion chamber 900. The thruster compression seal 268 of the first thruster 235 abut the housing wall 166 to seal along the combustion chamber 900. As the combustion chamber 900 is sealed, the transfer valve 138 is lifted and lowered from its closed position and the compressed air flows through the transfer valve 138 and the injector 142 sprays fuel into the compressed air to create a fuel/air mixture. The fuel/air mixture enters the combustion chamber 900 and is further mixed by the turbulence created over the step profiles of the combustion surface 242 of the first thruster 235 and the step surface of the vane 368. As the transfer valve 138 reaches the closed position, the ignition source ignites the fuel/air mixture in the combustion chamber 900 to begin the power cycle. The expanding combustion gases react against the vane 368 which is in lowered position to push against the combustion surface 242 of the first thruster 235 and rotate the rotor 192 and the crankshaft 104 about the central axis A1 in a clockwise direction when viewing from the front of the rotational engine assembly engine 100. As the power cycle is occurring in the rotor interior 164, the compressor piston 120 is moving the compressor cylinder 124 downward to conduct the next intake cycle simultaneously.

At the end of the power cycle, the lock solenoid 546 facilitates movement of the solenoid valve 548 out of the valve port 544. The hydraulic fluid flows freely out of piston chamber 526 and the secondary cavity 550 to allow the vane 368 to move in the vane chamber 354. The camshaft gear facilitates rotation of the camshaft 116 and the lobe 496. The lobe 496 facilitates movement of the camshaft lifter 488. The camshaft lifter 488 facilitates pivoting of the rocker arm 498. As the rocker arm 498 pivots, the rocker arm 498 facilitates movement of the vane guide arms 486 and vane 368 in the vane chamber 354 from the lowered position to the raised position.

The second thruster 236 rotates under the vane 368 as the vane 368 is raised and lowered. The movement of the vane 368 is timed such that the vane 368 moves relative to the angled exhaust surface 244 of the second thruster 236. The vane 368 moves relative to the second thruster 236 to maintain a small gap between the second thruster 236 and the vane 368. As the second thruster 236 passes under the vane 368, the vane 368 begins to move within the vane chamber 354 towards the lowered position. As the vane 368 reaches the lowered position, the lock solenoid 546 facilitates the solenoid valve 548 into the valve port 544. The hydraulic fluid is retained in the piston chamber 526 retaining the vane 368 against the two rotor seals 232 to form the combustion chamber 900 between the second thruster 236 and the vane 368. As the combustion chamber 900 is sealed again, the transfer valve 138 opens and the compressed air flows through the transfer valve 138 and the injector 142 sprays fuel into the compressed air to create a fuel/air mixture. The fuel/air mixture enters the combustion chamber 900 and is further mixed by the turbulence created over the step profiles of the combustion surface 242 of the second thruster 236 and the step surface 504 of the vane 368. For a spark ignition application, to begin the power cycle, the transfer valve 138 reaches closed position and the ignition source ignites the fuel/air mixture in the combustion chamber. For a Diesel application, the injection of fuel is retimed to be performed after the transfer valve 138 is closed to ignite the compressed air charge residing in the combustion chamber 900. The expanding combustion gases react against the step surface 504 of vane 386 and push against combustion surface 242 of the second thruster 236 and facilitate rotation of the rotor 192 and the crankshaft 104 about the central axis A1.

As the rotor 192 is rotating, the intake process repeats again. The exhaust gases from the first combustion between the exhaust surface 244 of the second thruster 236 and the exhaust surface 509 of the vane 368 are expelled from the first exhaust chamber 902 through the outlet 188 as the first thruster 235 rotates towards the vane 368. The movement of the vane 368 is timed such that the vane 368 moves relative to the angled exhaust surface 244 of the first thruster 235. The vane 368 moves relative to the first thruster 235 to maintain a small gap between the first thrusters 235 and the vane 368. This minimizes the amount exhaust gas entering the combustion chamber. This is called the exhaust cycle and the same process applies to the first thruster.

As the rotor 192 is rotating, the compression cycle will continue to repeat simultaneously as the combustion cycle and exhaust cycle are occurring. The camshaft gear of the camshaft 116 and the compressor gear 114 of the compressor crankshaft 112 have a gear ratio of two revolutions to one revolution of the main gear 110 to allow for two intake and compression cycles per a single revolution of the rotor 192. The rotational engine assembly 100 has two combustion cycles and two exhaust cycles per a single revolution of the rotor 192. There is one power cycle and one exhaust cycle for each thruster per a single revolution of the rotor 192. This only describes the operation of one rotor 192 and rotor interior 164. The rotational engine can have a plurality of rotors 192 and rotor interiors 164 operating at the same time.

A metal mesh pad is used throughout the rotational engine assembly 100 on many components. The intended material to be used for the metal mesh pad is stainless steel; however, it is to be appreciated that the metal mesh pads maybe any suitable material. A foil layer is used with the metal mesh pad throughout the rotational engine assembly 100 on may components. The foil layer maybe of any suitable material.

The present invention has been described in an illustrative manner, and it is to be understood that the terminology which has been used in intended to be in the nature of words of description rather than of limitation. Obviously, many modifications and variations of the present invention are possible in light of the above teachings. The inventions may be practiced otherwise than as specifically described within the scope of the appended claims.

What is claimed is:

1. A rotational engine for converting energy in fuel into movement, said rotational engine comprising:
a housing including a housing wall defining a rotor interior and said housing defining an inlet in fluid communication with said rotor interior, an outlet in fluid communication with said rotor interior spaced from said inlet, and a vane cavity extending into said rotor interior between said inlet and said outlet;
a vane movably mounted to said housing to selectively move into and out of said vane cavity;
at least one vane valve movably mounted to said vane for dispensing a lubricant;
a crankshaft disposed in said housing and extending through said rotor interior with said crankshaft defining a central axis;
a rotor radially fixed to said crankshaft in said rotor interior and having a rotor surface with said rotor and said crankshaft being rotatable as a unit about said central axis and said rotor defining a working chamber in said rotor interior between said rotor surface and said housing wall;
at least one thruster extending from said rotor transverse to said central axis with said thruster dividing said working chamber;
a thruster valve movably mounted to said thruster for dispensing a lubricant;
a compressor in fluid communication with said inlet for supplying compressed air to be mixed with the fuel;
an ignition source mounted to said housing and having access to said working chamber for igniting the fuel; and
a rotor seal mounted to said housing for receiving the dispensed lubricant from said at least one vane valve and said thruster valve, said rotor seal having a pad structure disposed in said vane cavity with said pad structure abutting said rotor, said vane, and said housing to prevent rotation of said rotor seal in said housing and to provide a seal between said rotor, said at least one thruster, said vane, and said housing.

2. A rotational engine as set forth in claim 1 wherein said rotor seal has an upper seal portion movably mounted to said housing and a lower seal portion movably mounted to said housing and interfacing with said upper seal portion, said upper seal portion and said lower seal portion configured to move relative to each other to abut said rotor and to provide continuous sealing between said housing wall and said rotor.

3. A rotational engine as set forth in claim 2 wherein said one of said upper seal portion and said lower seal portion includes a protrusion and the other of said upper seal portion defines a cutout with said protrusion movably disposed in said cutout for allowing expansion and contraction of said rotor seal and to provide continuous sealing between said rotor seal, said rotor, and said thruster.

4. A rotational engine as set forth in claim 3, where in said rotor seal has a mesh pad mounted between said cutout and said protrusion with said mesh paid being compressed to provide continuous sealing between said rotor seal, said rotor, and said housing wall.

5. A rotational engine as set forth in claim 2 wherein said lower seal portion has a joint protrusion defining a locating hole and said upper seal portion has a second protrusion and a joint rod extending from said second protrusion with said joint rod disposed in said locating hole to adjoin said upper seal protrusion and said lower seal protrusion.

6. A rotational engine as set forth in claim 1 wherein said housing includes a plurality of lock dampers abutting said rotor seal to bias and retain said rotor seal in constant contact against said rotor as said rotor seal deteriorates.

7. A rotational engine as set forth in claim 1 wherein said rotor seal includes a frame disposed around said pad structure having a metal mesh pad and an outer foil layer mounted to said frame and abutting said housing, and said pad structure to provide continuous and simultaneous sealing.

8. A rotational engine as set forth in claim 1 wherein said housing defines a rotor seal lubricant channel with said rotor seal mounted in said housing and abutting said rotor seal lubricant channel to lubricate said rotor seal in said housing.

9. A rotational engine as set forth in claim 8 wherein said rotor seal includes an inner surface and a metal mesh pad mounted to said inner surface to abut said housing and bias said rotor seal against said lubricant groove to provide continuous sealing between said rotor seal and said housing.

10. A rotational engine as set forth in claim 1 wherein said housing includes a guide pin, guide pin bolt, and said rotor seal defines a hole with said guide pin bolt extending transversely through said guide pin and disposed in said hole to position said rotor seal in said housing and retain said rotor seal in said housing for a continuous seal between said pad structure of said rotor seal and said housing while allowing said rotor seal to move towards said rotor seal as rotor seal deteriorates.

11. A rotational engine as set forth in claim 1 wherein said housing has a rail structure disposed in said vane cavity and defining a lubricant supply groove interfacing with said pad structure of said rotor seal for lubricating said interface between said pad structure and said rail structure and enable said rotor seal to move toward said rotor as said rotor seal deteriorates.

12. A rotational engine as set forth in claim 1 wherein said rotor seals define a rotor drain channel in fluid communication with said vane, said rotor surface, and said housing for facilitating lubricant flow from said rotor surface to said housing.

13. A rotational engine as set forth in claim 1 further including an outer lubricant seal having an upper seal portion mounted to said housing and a lower seal portion mounted to said housing and interfacing with said upper seal portion, with said upper seal portion and said lower seal portion configured to move relative to each other to abut said rotor and seal said housing wall and said rotor.

14. A rotational engine as set forth in claim 13 wherein said housing defines a retention cavity and said outer lubricant seal includes a retention structure defining a retainer chamber and having a retainer plate disposed in said retainer chamber and movably mounted to said retention structure such that said retainer plate is disposed in said retention cavity as said inner seal is disposed in said housing to retain said outer lubricant seal in said housing and prevent rotation of said outer lubricant seal in said housing.

15. A rotational engine as set forth in claim 1 wherein said housing defines a piston chamber with a second end and a second cavity spaced from said piston chamber, said housing further defines a plurality of perforations between said piston chamber and said secondary cavity with said piston chamber in fluid communication with said secondary cavity for facilitating hydraulic fluid flow between said piston chamber and said secondary cavity.

16. A rotational engine as set forth in claim 15 wherein said vane includes a vane piston and said housing defines fewer perforations between said second end of said piston chamber and said second cavity to increase resistance of hydraulic fluid flow between said piston chamber and said secondary cavity and dampen motion of said vane piston and said vane as said vane piston approaches said second end of piston chamber and said vane approaches said rotor to enable a quick seal between said vane and said rotor seal and to minimize impact stress of said rotor seal as said vane comes into contact said rotor seal.

17. A rotational engine for converting energy in fuel into movement, said rotational engine comprising:
a housing including a housing wall defining a rotor interior and said housing defining an inlet in fluid communication with said rotor interior, an outlet in fluid communication with said rotor interior spaced from said inlet, and a vane cavity extending into said rotor interior between said inlet and said outlet;
a vane movably mounted to said housing to selectively move into and out of said vane cavity;
a crankshaft disposed in said housing and extending through said rotor interior with said crankshaft defining a central axis;
a rotor radially fixed to said crankshaft in said rotor interior and having a rotor surface with said rotor and said crankshaft being rotatable as a unit about said central axis and said rotor defining a working chamber in said rotor interior between said rotor surface and said housing wall;
at least one thruster extending from said rotor transverse to said central axis with said thruster dividing said working chamber;
a compressor in fluid communication with said inlet for supplying compressed air to be mixed with the fuel;
an ignition source mounted to said housing and having access to said working chamber for igniting the fuel; and
at least one vane valve movably mounted to said vane to selectively move between an open position abutting said rotor surface for lubricating said rotor surface and a closed position spaced from said rotor surface.

18. A rotational engine as set forth in claim 17 wherein said vane defines a vane channel and said vane valve defines a corresponding valve conduit with said vane channel and said valve conduit capable of aligning such that said vane channel and said valve conduit are in fluid communication as said vane valve is in said closed position for facilitating fluid flow between said vane and said vane valve.

19. A rotational engine as set forth in claim 18 wherein said vane defines a pocket and said vane valve extends through said pocket with said valve conduit and said pocket capable of aligning such that said valve conduit and said pocket are in fluid communication as said vane valve is in said closed position for dispensing a defined quantity of lubricant between said pocket and said vane conduit and said pocket is in fluid communication with said rotor surface as said vane valve is in said open position for dispensing a defined quantity of lubricant from said pocket to said rotor surface.

20. A rotational engine as set forth in claim 18 wherein said vane includes at least one regulator mounted to said vane and in fluid communication with said vane channel for facilitating fluid flow between said housing and said vane.

21. A rotational engine as set forth in claim 17 wherein said vane includes a vane lubricant seal having a primary seal portion and a secondary seal portion defining an overlapping interface with a gap in between said primary seal portion and said secondary seal portion with said overlap interface defining corresponding interlocking features enabling said primary seal portion and said secondary seal portion move as a unit in a vertical direction and move separately in a horizontal direction.

22. A rotational engine as set forth in claim 21 wherein said vane lubricant seal includes a plurality of metal mesh pads and said primary and secondary seal portions have a plurality of exterior surfaces with said a plurality of metal mesh pads mounted to said overlap interface and said plurality of exterior surfaces of said primary and secondary seal portions such that metal mesh pads are compressed when said vane lubricant seal is mounted to said vane to form a continuous seal between the said vane, said rotor, and said primary and secondary seal portions of vane lubricant seal.

23. A rotational engine as set forth in claim 21 wherein said primary seal portion and said secondary seal portion of said vane lubricant seal define a plurality of grooves in fluid communication with said vane for facilitating lubricant flow between said vane and said vane lubricant seal to lubricate movement of the said vane lubricant seal relative to said vane, and for facilitating lubricant flow in said overlapping interface between said primary and secondary seal portions of said vane lubricant seal, such than lubricant flow forms a continuous seal between said vane, said primary and secondary seal portions of said vane lubricant seal, and said rotor.

24. A rotational engine as set forth in claim 17 wherein said vane defines a plurality of pockets relative to said rotor surface and said vane further defines a plurality of drain grooves in fluid communication with said pockets, with said plurality of pockets collecting lubricant from said rotor surface as said rotor rotates relative to said vane and said drain grooves remove lubricant from said pockets and said vane.

25. A rotational engine as set forth in claim 17 wherein said vane including a vane compression seal having a primary seal portion movably and a secondary seal portion defining an overlapping interface with a gap between said primary and secondary seal portions with said overlapping interface defining corresponding interlocking features of said primary seal portion and said secondary seal portion enabling said primary seal portion and said secondary seal portion to move as a unit in a vertical direction and move separately in a horizontal direction.

26. A rotational engine as set forth in claim 25 wherein said vane compression seal includes a plurality of metal mesh pads and said primary and secondary seal portions have a plurality of exterior surfaces with said a plurality of metal mesh pads mounted to said overlap interface and said plurality of exterior surfaces of said primary and secondary seal portions such that metal mesh pads are compressed when said vane compression seal is mounted to said vane to form a continuous seal between the said vane, said rotor, and said primary and secondary seal portions of said vane compression seal.

27. A rotational engine as set forth in claim 25 wherein said primary seal portion and said secondary seal portion define a plurality of grooves in fluid communication with said vane for facilitating lubricant flow between said vane and said vane compression seal to lubricate movement of the said vane compression seal relative to said vane and for facilitating lubricant flow in said overlapping interface between said primary seal portion and secondary seal portion such that lubricant flow forms a continuous seal between said vane, said primary and secondary seal portions of said vane compression seal, and said rotor.

28. A rotational engine as set forth in claim 25 wherein said vane compression seal includes a trailing seal mounted adjacent to said vane compression seal to abut said rotor with said trailing seal and said primary and secondary portions of said vane compression seal divide said working chamber to form a continuous seal between said vane and said rotor.

29. A rotational engine as set forth in claim 17 wherein said vane includes a plurality of seals having a primary seal portion and a second seal portion, said vane further includes a primary damper mounted to said vane and abutting said primary seal portion to bias said primary seal portion away from said vane to abut said rotor and dampen movement of said primary seal portion toward said vane, and a secondary damper mounted to said vane and abutting said secondary seal portion to bias said secondary seal portion away from said vane to abut said rotor and dampen movement of said secondary seal portion toward said vane to provide continuous sealing between said rotor and said vane.

30. A rotational engine as set forth in claim 29 wherein said plurality of seals is further defined as a vane compression seal for preventing by-pass of combustion gases, a vane lubricant seal for preventing by-pass of lubricant, and a vane exhaust seal for preventing by-pass of exhaust gases.

31. A rotational engine as set forth in claim 17 wherein said vane includes a plurality of seals and defines a plurality of retention cavities, and said plurality of seals include a biasing member and a retention plate with said retention plates mounted to said biasing members such that said biasing members bias said retention plates into said retention cavities to retain said plurality of seals in said vane.

32. A rotational engine as set forth in claim 31 wherein said plurality of seals is further defined as a vane compression seal for preventing by-pass of combustion gases, a vane lubricant seal for preventing by-pass of lubricant, and a vane exhaust seal for preventing by-pass of exhaust gases.

33. A rotational engine as set forth in claim 17 further including a vane chamber compression seal mounted to said housing including a plurality of seal components having overlapping and interlocking structures with said seal components configured to move relative to each other and abut said vane and with a mesh pad mounted in said overlapping structures to form a continuous seal between said vane, said vane chamber compression seal, and said housing.

34. A rotational engine for converting energy in fuel into movement, said rotational engine comprising:
a housing including a housing wall defining a rotor interior and said housing defining an inlet in fluid communication with said rotor interior, an outlet in fluid communication with said rotor interior spaced from said inlet, and a vane cavity extending into said rotor interior between said inlet and said outlet;
a vane movably mounted to said housing to selectively move into and out of said vane cavity;
a crankshaft disposed in said housing and extending through said rotor interior with said crankshaft defining a central axis;
a rotor radially fixed to said crankshaft in said rotor interior and having a rotor surface with said rotor and said crankshaft being rotatable as a unit about said central axis and said rotor defining a working chamber in said rotor interior between said rotor surface and said housing wall;
at least one thruster extending from said rotor transverse to said central axis with said thruster dividing said working chamber;
a compressor in fluid communication with said inlet for supplying compressed air to be mixed with the fuel;
an ignition source mounted to said housing and having access to said working chamber for igniting the fuel; and
a thruster valve movably mounted to said thruster to selectively move between a first position abutting said housing wall for lubricating said thruster and a second position spaced from said housing wall

35. A rotational engine as set forth in claim 34 further including a thruster lubricant seal having a first seal portion movably mounted to said thruster and a second seal portion movably mounted to said thruster and interfacing with said first seal portion, with said first seal portion and said second seal portion configured to move relative to each other to abut said housing wall to provide continuous sealing between said thruster and said housing wall and divide said working chamber.

36. A rotational engine as set forth in claim 35 wherein said thruster, said thruster lubricant seal, and said housing define a plurality of thruster lubricant grooves for facilitating lubricant flow between said thruster, said thruster lubricant seal, and said rotor to lubricate movement of the said thruster lubricant seal, said thruster, and said rotor.

37. A rotational engine as set forth in claim 36 wherein said thruster defines rod cavity and corresponding valve passageways in fluid communication with said plurality of thruster lubricant grooves with fluid passing from said rod cavity through said valve passageway and into said plurality of thruster lubricant grooves when said thruster valve is in said first position abutting said housing wall.

38. A rotational engine as set forth in claim 37 wherein said rod cavity and corresponding valve passageways are no longer in fluid communication with said plurality of thruster lubricant grooves when said thruster valve is in said second position spaced from said housing wall.

39. A rotational engine as set forth in claim 35 wherein said first and second seal portions define an overlap interface with a gap between said first and second seal portions and said first and second seal portions further define corresponding interlocking features with said interlocking features enabling said first seal portion and said second seal portion to move toward and away from said housing wall as a unit in a vertical direction and move toward and away from said housing wall separately in a horizontal direction.

40. A rotational engine as set forth in claim 39 wherein said thruster lubricant seal includes a plurality of metal mesh pads and said first and second seal portions have a plurality of exterior surfaces with said a plurality of metal mesh pads mounted to said overlap interface and said plurality of exterior surfaces of said first and second seal portions such that metal mesh pads are compressed when said thruster lubricant seal is mounted to said thruster to form a continuous seal between the said thruster, said rotor, and said first and second seal portions of thruster lubricant seal.

41. A rotational engine as set forth in claim 35 wherein said thruster defines a limiting protrusion and said thruster lubricant seal defines a protrusion slot with said limiting protrusion movably disposed in said protrusion slot to limit movement of said thruster lubricant seal in said thruster.

42. A rotational engine as set forth in claim 35 wherein said rotor includes a first damper mounted to said thruster and abutting said first seal portion to dampen movement of said first seal portion toward said thruster and a second damper mounted to said thruster and abutting said second seal portion to dampen movement of said second seal portion toward said thruster to provide continuous sealing between said thruster and said housing wall.

43. A rotational engine as set forth in claim 35 wherein said rotor further includes;
a plurality of horizontal biasing members mounted to said thruster, and
a plurality of ball structures mounted between said first and second seal portions and said plurality of horizontal biasing members with said plurality of ball structures maintaining constant contact with said a plurality of horizontal biasing members and said first and second seal portions as said first and second seal portions move.

44. A rotational engine as set forth in claim 35 wherein said housing further includes;
a lubricant wipe surface defining a first depression extending into said rotor interior,
an exhaust surface defining a second depression extending into said rotor interior, and
a combustion surface defining a third depression extending into said rotor interior with said thruster valve in said second position cutting off lubricant supply to said thruster with thruster valve spaced from lubricant wipe surface, exhaust surface, and combustion surface, and with said thruster lubricant seal abutting said a lubricant wipe surface as said thruster rotates along said a lubricant wipe surface through said first depression to remove lubricant from said thruster and said thruster lubricant seal is spaced from said exhaust surface and said combustion surface to prevent lubricant from accumulating on said exhaust surface and said combustion surface.

45. A rotational engine as set forth in claim 36 wherein said thruster lubricant seal defines a plurality of lubricant drain channels and includes a lubricant surface with said plurality of lubricant drain channels extending through said lubricant surface to drain lubricant from said thruster lubricant groove as said rotor rotates along said housing wall.

46. A rotational engine as set forth in claim 34 wherein said thruster defines a rod cavity and a corresponding valve passageway with fluid passing from said rod cavity through said valve passageway when said thruster valve is in the first position.

47. A rotational engine as set forth in claim 46 wherein said thruster has a valve rod extending into said rod cavity and a valve biasing member disposed around said valve rod abutting said thruster valve with said thruster valve being resiliently moveable in said thruster.

48. A rotational engine as set forth in claim 34 wherein said thruster and said housing at least partially define a plurality of thruster lubricant grooves for facilitating lubricant flow between said thruster and said rotor to lubricate movement of said thruster and said rotor.

49. A rotational engine as set forth in claim 34 further including a thruster compression seal having a first seal portion movably mounted to said thruster and a second seal portion movably mounted to said thruster and interfacing with said first seal portion, with said first seal portion and said second seal portion configured to move relative to each other to abut said housing wall to provide continuous sealing between said thruster and said housing wall and divide said working chamber.

50. A rotational engine as set forth in claim 35 wherein said thruster lubricant seal defines a plurality of lubricant supply pathways in fluid communication with said thruster for facilitating lubricant flow between said thruster and said thruster lubricant seal to lubricate movement of said thruster lubricant seal relative to said thruster.

51. A rotational engine for converting energy in fuel into movement, said rotational engine comprising:
a housing including a housing wall defining a rotor interior and said housing defining an inlet in fluid communication with said rotor interior, an outlet in fluid communication with said rotor interior spaced from said inlet, and a vane cavity extending into said rotor interior between said inlet and said outlet;
a vane movably mounted to said housing to selectively move into and out of said vane cavity;
a crankshaft disposed in said housing and extending through said rotor interior with said crankshaft defining a central axis;
a rotor radially fixed to said crankshaft in said rotor interior and having a rotor surface with said rotor and said crankshaft being rotatable as a unit about said central axis and said rotor defining a working chamber in said rotor interior between said rotor surface and said housing wall;
a rotor seal mounted to said housing;
at least one thruster extending from said rotor transverse to said central axis with said thruster dividing said working chamber;
a compressor in fluid communication with said inlet for supplying compressed air to be mixed with the fuel;
an ignition source mounted to said housing and having access to said working chamber for igniting the fuel; and
a hydraulic lock at least partially mounted to said housing and including a piston chamber and a piston with said piston disposed in said piston chamber and movable between a locked position with said vane retained in said vane cavity relative to said rotor abutting said rotor seal and an unlocked position with said vane movable into and out of said vane cavity.

52. A rotational engine as set forth in claim 51 wherein said housing includes a lock solenoid with a solenoid valve movably mounted to said lock solenoid and disposed in said piston chamber with said lock solenoid facilitating movement of said solenoid valve to facilitate hydraulic fluid flow into and out of said piston chamber for retaining said piston and said vane in said locked position.

53. A rotational engine as set forth in claim 51 wherein said piston chamber has a second end and said housing defines a second cavity spaced relative to said piston chamber, and said housing further defines a plurality of perforations between said piston chamber and said secondary cavity such that said piston chamber is in fluid communication with said secondary cavity for facilitating hydraulic fluid flow between said piston chamber and said secondary cavity.

54. A rotational engine as set forth in claim 53 wherein said housing defines fewer perforations between said second end of said piston chamber and said second cavity to increase resistance of hydraulic fluid flow between said piston chamber and said secondary cavity and dampen motion of said vane piston and said vane as said vane piston approaches said second end of piston chamber and said vane approaches said rotor to enable a quick seal between said vane and said rotor seal and to minimize impact stress of said rotor seal as said vane comes into contact said rotor seal.
